(19) United States
(12) Patent Application Publication
(10) Pub. No.: US 2022/0028002 A1
(43) Pub. Date: Jan. 27, 2022

(54) MECHANISM FOR STABILITY WITHIN AUTOMATIC RESERVE MANAGEMENT ARTIFICIAL INTELLIGENCE

(71) Applicant: Gregor Ko{hacek over (z)}elj, Planina pri Sevnici (SI)

(72) Inventor: Gregor Ko{hacek over (z)}elj, Planina pri Sevnici (SI)

(21) Appl. No.: 17/383,907

(22) Filed: Jul. 23, 2021

Related U.S. Application Data
(60) Provisional application No. 63/056,312, filed on Jul. 24, 2020.

(51) Int. Cl. G06Q 40/06; G06F 9/451

(52) U.S. Cl. CPC G06Q 40/06; G06F 9/451

(57) ABSTRACT

A computer implemented method for stabilizing automatic reserve management includes receiving, via a Horizon user interface communicatively coupled to a networked user device comprising a processor device, a plurality of user inputs representative of factors affecting a unit of value. It can further include generating a graph of value, obtaining a balanced Strategy, and generating, based on the user inputs and user selection, a Perspective including at least one Strategy.

### RELATED APPLICATION INFORMATION

This application claims priority to U.S. Provisional Application No. 63/056,312, filed on Jul. 24, 2020, which is incorporated herein by reference in its entirety.

### BACKGROUND

The present invention generally relates to an artificial intelligence system, and more particularly to systems and methods for stabilizing tokenized assets through an artificial intelligence system.

### SUMMARY

In accordance with an embodiment of the present invention, a system and method for the tokenization and control of value preservation of through a mechanism for stability within an artificial intelligence system. In particular, embodiments of the present invention facilitate mitigation and management of loss for stable portfolios and tokenized assets.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a chart of a scenario, in accordance with an embodiment of the present invention;

FIGS. 2-12 are diagrams of a user interface, in accordance with an embodiment of the present invention;

FIG. 13, is a block diagram of a Strategy, in accordance with an embodiment of the present invention;

FIGS. 14-16 are diagrams of a user interface, in accordance with an embodiment of the present invention;

FIGS. 17-92 are block diagrams of Strategies and Perspectives, in accordance with embodiments of the present invention;

FIG. 93 is a schematic diagram of a system, in a accordance with an embodiment of the present invention; and

FIG. 94 is a block diagram of a computing system, in accordance with an embodiment of the present invention.

### DESCRIPTION

In this document and in the accompanying drawings, reference is made to particular features of various embodiments of the invention. It is to be understood that the disclosure of the various versions of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

Mechanism for Stability within ARM AI is solving the problem of value preservation in the financial industry. Value preservation is challenged by inflation and or negative interest rates. Inflation is one of the biggest problems worldwide, which destroys an enormous amount of wealth each year. Inflation causes money to lose purchasing power. Consequently, people and entities cannot buy the same amount of products or services in a year, two years or five years in the future because the inflation causes the prices of the products and services to increase. Same amount of money therefore buys less in the future than it can now. Negative interest rates are a phenomenon, which poses a similar challenge to the purchasing power as does inflation.

Mechanism for Stability within the ARM AI was designed to objectively target value preservation and mitigate inflation risks, as well as risk from negative interest rates, so that the assets held by a person or an entity would experience a lower rate of degradation of purchasing power overtime when using the Mechanism, or would reduce and sometimes neutralize the influence of negative factors, which cause the loss of purchasing power overtime when using the Mechanism.

The embodiments described herein may be employed by financial institutions, investors, portfolio managers, consumers, which want to use stable payment instrument, merchants, analysts, financial regulators, market traders and speculators, decentralized financial networks, and decentralized ledger technology consensus protocols.

The invented mechanism takes market prices as the input. Market prices are fed from API into the System. Prices are usually obtained in a live format from an exchange, bank or a broker. Mechanism for Stability consists of geometric matrices of market instruments. Geometric matrices give to the System the capability to process information with high efficiency, precision and also increased predictability and reliability.

Geometric matrices of market instruments are configured using the “Horizon” control. For X8 Mechanism for Stability there are 672 individual elements that make up the geometric matrix. Geometric matrix can be seen as a multi-dimensional geometric vector. X-n shapes can have different number of geometric angles.

Multi-dimensional geometric vector output of the geometric matrix is an input to the Integral Perspective and then the Superposition Perspective. These two elements are capable of observing the tendencies of the geometric matrix and its dynamics (volume, direction of expansion or contraction, pulsation, rates of change, polarization, relative velocity and absolute velocity relative to the target (target is target point of stability).

“Horizons control is applied in the construction of the Integral Perspective and the Superposition Perspective. Integral Perspective provides to the Superposition Perspective the view of the geometric matrix in relative velocity terms and in terms of number of steps when measuring distances from the target.

Superposition Perspective is an AI mechanism. This AI mechanism has the purpose to resolve the dilemma of reaching the target goal in fewer steps than otherwise attainable through linear and other methods. Superposition Perspective is geometry agnostic. Superposition can switch or morph between different geometries of the geometric matrix respective to its prevailing position from the target point and respective to the velocity and distance from the target point measured in number of steps (geometric steps or geometric increments).

In the environment where the instability is accentuated and increased volatility is emphasized, the Superposition Perspective will maintain a better optimal risk reward ratio when the System is near or on the target, but still volatile.

This exemplary embodiment of the system connects to different brokers and exchanges using FIX Protocol. The system can include approximately 40 computer servers (a computer server cluster), which processes information in real time and produces output. This output can be and is used when establishing stable portfolios with banks, brokers and exchanges.

The embodiment of the invention uses a computer cluster for interaction with the “Horizons” control and the computer cluster. The client uses the “Horizons” control to configure his or her settings for a particular purpose, usually a stable portfolio or a stable tokenized asset.

The client or the user should preferably know how to configure the geometric matrix of market instruments. The client or the user should preferably know how to configure ARM Artificial Intelligence elements through the “Horizon” control. ARM AI—Manual document provides the instructions and explanations. The signal travels from the “Horizons” control into the computer cluster through FIX Protocol API. Computer cluster resolves the locations of CPU and RAM processing within the cluster (virtualized sandbox).

Individual CPU and RAM set receive instructions for execution and load the “Horizons” control profile for processing and interaction with market prices. Market price input triggers the calculations of the Mechanism for Stability and ARM AI.

Mechanism for Stability and the ARM AI react with placement of orders in the market and establish the positions for the stable portfolio on an account held with a bank, broker or exchange. Signal travels from the System to the banks, brokers or exchanges through FIX Protocol connections established between the System and the said entities.

The client or user can start, pause, stop the System. The client or user can also amend configurations settings of the system through the “Horizons” control. The client or user can independently monitor the performance of the System through the GUI of his or her bank, broker or exchange of choice. The preferred approach to operate the system is by understanding Black-Scholes of Binomial optionality models, because this gives a perspective on risk management within the investment industry to the user. User is encouraged to know how to click through 672 elements of the geometric matrix in the Mechanism for Stability, using the “Horizons” control. A user can configure Integral Perspective and Superposition Perspective using the “Horizons” control. A user should preferably be knowledgeable in risk management and risk portfolio management. A user should preferably be aware of concepts of financial risk. A user should preferably be aware of concepts of signal waveforms. A user should preferably be knowledgeable in quantum mechanics and probabilistic approaches to calculus. A user should preferably be proficient in Pythagorean mathematics at least on the fundamental level.

The remainder of this document provides the description of the background from the scientific fields, the guidelines and the instructions for the use of the “Horizons” control, the Mechanism for Stability and the ARM AI.

ARM AI is capable of creating X8 and other X structures, and tokenize them, where the basket itself is fully dynamic and automated. A partial resemblance to the capabilities of the System, including the combination of “Horizons” control, Mechanism for Stability and the ARM AI are various optionality models. I have been working as a licensed financial professional in financial institutions, where I have learned about Black Scholes model and Binomial optionality model. Options are considered as derivative OTC instruments in the financial industry. There are different kinds of options, like call option, put option, vanilla options, KO options, one touch options, two touch options, Binary options, and other options. A vanilla call option would give to the holder an exposure to the market price upside movement above a certain price level threshold. For this upside potential the holder does not need to deposit the full nominal amount of the value of the option, but only needs to pay a premium. When onboarding such a call option instrument, the holder is exposed to a certain risk curve, which is implicitly unpredictable, but embedded in such option instrument.

“Horizons control also produces profiles, which are risk profiles. The risk profiles from the “Horizons” control can resemble those of OTC option instruments, however, the “Horizons” control allows almost any risk profile to be set by the user and for this the user does not need to enter into any OTC instrument transaction. The System does the execution of the setting for the user and the user is not in any bilateral or other contractual agreements in terms of financial instruments. Most obviously the difference can be described by an example, where the user wishes to expose himself to a certain type of financial risk. In the case, when the user would choose an option instrument, the user would need to pay trading fees, transaction costs and possibly a premium to obtain an option instrument like a vanilla call option for example. If the user would suddenly change his or her mind, then the user would need to reverse the transaction and again pain fees. In the case of the “Horizons” control, the user can set the maximum risk limits and parameters, yet, the user does not need to pay costs (premiums) to expose himself or herself to a certain financial risk type. The user can also change his or her mind and stop or reverse his or her tendency, which does not mean that the user will pay any transaction fees or costs for this action in the System. The user exposes himself or herself to the type of financial risk of his or her choice, but the System allows this to be done without entering into OTC derivatives or options transactions and is purely executed on spot and physical markets. The exposure to the risk profiles exists in realms of algorithms and AI (including the Mechanism for Stability), which execute the activity tailored to the user and as prescribed by him or her. This also means that the capabilities of the System versus the OTC derivatives option segment is very much different in the sense that the user in the System can chose practically almost any setting, which is custom made for him or her, by him or her, a start contrast to the narrowed down list of most popular strikes, maturities and derivative instrument types offered in the OTC market.

A preferred result of the various embodiments of the invention is a portfolio with a lower variance of its NAV (net asset value), also called lower volatility. This reduction in the volatility happens through specific risk mitigation methods. In the case of the System this reduction in the volatility is achieved through a deterministic AI type. Deterministic AI type produces results which are explainable and predictable, unlike the non-deterministic AI type, which can produce different results from seemingly identical or very similar input. Predictability of the reduction of volatility is a key component and characteristic of the System. Risk mitigation in numbers is described herein below.

The result goes further than the reduction of the volatility or variance of the NAV. ARM AI system was designed to target value preservation. The result of the System therefore is the preservation of value through time. When the System is used, the value of the assets today will buy a similar amount of goods and services today as it will in the future. This is not to say that the inflation is neutralized, however the result is that the System fights inflation and can reduce the negative effects it has on the real purchasing power.

The latter is an important element in the tokenization of value preservation (not just stability). Stability itself does not equal value preservation (because of the inflation effect). When the System is used and its product is tokenized, this results in the tokenization of the value preservation.

Without the System the stability could be targeted with various different methods with different effects, however, this would not include the value preservation effect, which the System was designed for.

The various embodiments of the ARM AI include the Mechanism for Stability component and the AI component. Both components are in the current ARM AI configuration deterministic models. This is preferred, because financial risks need to be transparent and known in advance as much as possible when considering the construction of products like stable payment instruments (users rely on the stability of the payment instrument when pricing other goods and services).

Nonetheless, non-deterministic versions of the Mechanism for Stability and the AI are possible, planned and in development. Non-deterministic versions can be used in other applications where the control over risk is not as highly critical as in the case of stable payment instruments, where the stability is paramount, but also the transparency of risks and the ability to explain past and future actions of the AI. In the future, updated embodiments of the possible versions mentioned above are planned to be submitted, which would be non-deterministic versions of the geometric matrix and the AI. Non-deterministic systems are more difficult to implement because their behavior is less predictable or may be completely unpredictable even for very similar or identical input.

ARM AI Is a mechanism for evaluating the stability of an investment portfolio and a mechanism for asserting the control over investment risks in such a portfolio.

In the field of AI there are categories of the type of AI. Most basically different AI technologies can be separated to two main areas, deterministic and non-deterministic. Non-deterministic AI technologies produce results that are impossible or at least very difficult to explain. Non-deterministic AI may produce different results from seemingly very similar or even similarly identical input. The conclusion from this is, that action taken by non-deterministic AI can be quite unpredictable in terms of forecasting and in terms of backward reconstructions.

On the other hand, deterministic AI produces results, which are quite explainable, if not completely known up front for a range of scenarios. Deterministic AI will respond to the similar scenarios mostly very similarly and will respond to an identical scenario identically.

ARM AI falls under the deterministic Artificial Intelligence type category.

The system collects price information from the market in order to create a mark-to-market evaluation of an investment portfolio.

The system uses a concept of portfolio risk management to calculate risk profile and allows postulating of a specific risk profile for any given instrument in the portfolio. Through processing of the information, the system converts the calculations of the risk in the portfolio into market action, specifically this means the placement of orders to buy and sell market instruments. The system performs this function automatically.

ARM AI is a set of rules, which a computer program executes. Nevertheless, not every set of rules can be called Artificial Intelligence or AI.

First, AI is supposed to resemble the type of intelligence of a human person. This means that it is required to perform complex tasks and make decisions based on sometimes small differences and nuances between the different input data, which cannot be described with one fixed rule.

Second, even many fixed rules do not automatically constitute Artificial Intelligence. A set of rules can be called Artificial Intelligence if such a set of rules is able to find different optimal paths toward a target result and then chooses the most optimal and shortest path. In the case of ARM this target result is the stability of an investment portfolio—the target.

ARM AI is capable of meeting both described criteria. By the criterion of complexity and precision it is capable of significantly outperforming a human person in the same task. By its ability to find different optimal paths toward the target result, ARM AI can find a path toward portfolio stability, which is not superficially obvious or sometimes even cannot be observable in real-time by a trained professional due to continuous fluidity of the financial markets.

The ARM AI is also provided with a unique control designed to select different configurations of the ARM AI, to set maximum risks for any given marker instrument, and to set target performance profiles of the investment policy. Last but not least, the control comes with a start, pause, stop control.

This control is named “Horizons”. “Horizons” Algorithm Trade control is part of the system disclosed herein.

The name “Horizons” was chosen because of two principles. One principle is that Horus is the root of hours and is present in various linguistical origins of the word, which translates into an English word, “official”. Horizontal also carries a meaning of something being flat and evenly distributed. Since nothing is completely horizontal in nature, the author tried to account for the curvature that happens behind the alleged flat horizon, which is something that an observer cannot see from his, her or its particular viewpoint. This curvature constitutes different types of portfolio risk profiles, which the Horizons control allows to be set by the input from a user.

Stable coins in a sense are tokenized versions of stable investment portfolios. The performance curve of an investment portfolio backing the stable coin aims to be flat, or technically horizontal in the visual sense.

Every investment portfolio is exposed to certain risks in the market, therefore the aim of the system for stable coins is to have a good overview, prediction and control over such risks that induce fluctuations in the value of the investment portfolio backing such coins.

By understanding the risk trajectory and by having control over the inclination of the investment performance curve, these risks can be mitigated in various ways and kept under control.

Why Does the Need for AI Exist when Constructing a Stable Portfolio?

Stability of an investment portfolio in many circumstances may be equal to a stable value. However, in an environment where inflation is present or in an environment where interest rates on financial assets are different from zero such an assumption no longer holds true.

Inflation is a complex problem, which affects value preservation and has consequences in how investors view value preservation. Furthermore, interest rates in the financial environment are constantly changing. These two factors require continuous reevaluations and are intensive from the point of view of processing of the information. This is a job an AI can perform well and with less energy resources.

Why Does ARM AI Have to be Deterministic—a Deterministic AI?

Not every investment portfolio needs to be operated by a deterministic concept. Especially if an investment portfolio is aiming at increased returns on investment and if such a portfolio has an investment policy, which is tolerating increased above average risk and speculative market action to achieve the target investment goals, the need for a deterministic approach is not mandatory.

In the case of stable coins though, the performance needs to be stable and any risk inherent in the investment portfolio must be well known in advance. Furthermore, even if the risks of the investment portfolio are known up front, stable coins require an additional level of risk control, since they are deemed as payment instruments, something every user relies on when setting prices for goods and services in the open market.

A deterministic system carries one advantage. It has a known point of default and it has one fastest path from the opening status to the terminal default status. There isn't any other path from the opening point to the terminal default status point than the worst-case scenario path if these concepts are considered from the deterministic viewpoint. This means that worst-case scenarios can be well understood and known up front before the commencement of the investment policy execution, a key point for instruments like stable coins, which act as payment instruments. With simple words this can be explained that an investor would want a consistent outcome, and not want a variable outcome.

Mechanism for Stability—Within ARM AI

The author states that the mechanism for stability does not by itself constitute AI.

There are several layers of the mechanism for stability within the ARM AI, which culminate in steps to the level, which acts and performs as an AI. This document considers a specific mechanism for stability as the Mechanism for Stability of this document.

The first fundamental step revolves around risk-adjusted returns. Risk-adjusted returns concept within the ARM AI is based on Pythagorean geometric principles. It borrows from the axiom of mathematics that the sum of all angles in a triangle always amounts to 180 degrees.

The second fundamental step revolves around geometric commutation and geometric associative property. If factors are triangles, the order of how the multiplication function is performed does not affect the result of the multiplication function. The roles of two or more triangles can be interchanged without the effect on the aggregate result. In the simplest of terms this means that 1×2=2×1 where all similar analogies hold true regardless of the number of factors taking part in the equation.

The third fundamental step borrows from the properties of derivative and integral calculus. In the simplest words, derivative calculus observes the inclination of the tangent in respect to the curve which, from an investment portfolio point of view, constitutes the current inclination of the performance curve. Complementally, integral calculus observes the surface under the performance curve of the investment portfolio to account for cumulative historic risks recorded during travel through time of the investment policy execution.

The fourth fundamental step of the Mechanism for Stability takes into account the properties of factorial mathematical principles. In terms of combinations between many different geometric triangles, there can be a specific number of scenarios of how triangles can be assembled from the perspective of mathematical associativity and therefore a specific number of scenarios of how geometric forms can describe relationships between a known number of different market instruments.

The fifth fundamental step of the Mechanism for Stability is based on principles of quantum mechanics. Quantum mechanics postulates a term of the superposition. In quantum mechanical terms there is more than one path toward the superposition of more than one particle, but only one path is the shortest path, which is also the most probable path particles will take toward a superposition state in the theory of quantum mechanics.

The sixth fundamental step of the Mechanism for Stability respects the teachings from informational science, which states that data and information are different concepts. In informational science it is

preferred that information takes as little space (memory) as possible, without losing the full definition and precision of the information. The better the solution, the higher the ratio between information byte value and the data byte value will be.

The seventh fundamental step of the Mechanism for Stability takes its legacy from the theory of chaos, which states that things in general terms are and will remain unpredictable. This concept by itself is not very obvious when observing one isolated element or a particle, but it has great power when more than one element interacts with other elements, leading to all sorts of seemingly random scenarios, including the reverse scenario.

The eighth fundamental principle of the Mechanism for Stability rests on Bell's theorem of quantum mechanics. Quantum mechanics has some strange properties in terms of explanations of how localities or non-localities of particles affect the predictions about their behavior and the expectations about the results of particle physics experiments. In certain respects, local variables behave differently if they are put into the context of non-locality and seen as a whole from that point of view. This theorem describes the differences between the aggregate behaviors and performances of elements of the investment portfolio when they are located with one broker vs. if they are located in segregated environments with several different brokers. In this sense, and only from this point of view, the sum of equal parts does not equal the sum of the same parts observed from the viewpoint of non-locality.

The ninth fundamental step of the Mechanism for Stability establishes a quantum superposition over all 8 fundamental steps leading to the ninth step. This ninth step makes the ARM system capable of finding efficient solutions from a complex array of possibilities, which are all made out of fundamental building blocks. Not only is ARM AI capable of outperforming a trained human professional in terms of speed, but it is also capable of finding and accounting for the differences in the nuances that build up from under the surface during the formation of the continually changing status, which we observe in the financial markets every day.

Value at Risk vs. Capital at Risk Concept

In terms of risk of the investment portfolio the calculation of the level of risk heavily depends on the methodology that establishes the final result output, which we expect to give us a sense of the level of risk. Different methodologies will produce different results for the same phenomenon.

Generally speaking, Value at Risk (VaR) as generally used in the financial industry uses a probability function to describe or tell us what is the level of risk, assuming high probability of result is acceptable when considering the meaning of the output obtained by this methodology.

If dependence on the probabilistic nature of the output is not acceptable, then Value at Risk methodology can be seen as inaccurate and not entirely descriptive of the actual risk level, especially when viewed from the point of view of highly stressful scenarios in the financial markets.

Even if the Value at Risk methodology can be used in a conservative way in an attempt to minimize the effects of changing probabilities and in order to give stable and predictable results, the underlying risks can be more comprehensively described only through a Capital-at-Risk (CaR) methodology.

In simple terms, if an investor invests 1 unit of assets, then it is very highly probable that the investor cannot lose more than 1 unit of assets. Value at Risk would state 1 as a result of risk evaluation of such a scenario. Capital at Risk on the other hand, will account for the absolute loss that is possible, which can be more than 1, where how much this actually is, depends on the worst case of the risk profile deployed when executing investment policy.

The two mentioned methodologies are not superior to one another. They represent two different aspects of how we observe risks and also offer ways of how risk mitigation can be approached.

Advanced Mathematical Concepts

The ARM AI manual document continues with establishing of the awareness and the relevancy of mathematical concepts including Delta, Volatility, Relative Volatility, Volatility Differentials, Relative Volatility Differentials, Market Price spread, Spread between Relative Volatilities and their Differentials, Vectors, Price Risk, Spread Risk, Risk Vectors, Risk Horizons, Fractals, Scalars, Matrix Arrays, Price Scales Foundations, Factorial Risk expressions, VaR, CaR, and other related concepts pertinent to the Mechanism for Stability of the ARM AI. Document also describes how every component relates to the complete model.

Despite at times highly complex presentations of the nature of the ARM AI's mechanism for stability the document will offer a high-level explanation of the mechanics involved and attempt to relate to everyday observations in the financial market or even more generally and that can be more easily understood by professionals or non-professionals alike, which don't necessarily specialize in mathematics, finance and technology fields respectively.

By no means does this ARM AI manual document attempt to describe all phenomena observable in the financial markets. This document is not a comprehensive view of everything that can happen in the financial markets, nor does this document cover all methodologies that can be used in the financial markets to invoke principles, which ARM AI rests on (fundamental steps of the mechanism for stability). This ARM AI manual focuses on price risk which, in the case of X8 stable coins, means currency price risk. In addition to price risk this document covers spread risk, which can also relate to liquidity risk, plus ways of mitigation of these risks, which can all lead to balancing of other types of risks, like the interest rate risk, as an example. This document does not cover risk portfolio management of all of the different types of risk.

Foreign Exchange Markets vs. Other Markets

Addressing this relationship is relevant and discussed from the point of view of risk management, especially price risk management and spread risk management.

Price risks in equity markets for example cannot be managed by a deterministic AI, simply because there is no mathematical axiom in place that would imply with certainty the prevention of all of the components of a hypothetical equity portfolio simultaneously losing all of its value across the board, provided the ceteris paribus assumption in respect of spread risk is in place.

In simple words, this means that all equity components in a hypothetical equity portfolio can lose their entire value and no level of diversification can prevent that. This holds true for a portfolio with 10 equities or 500 equities. Total loss of value from 499 of the equities does not imply with any higher certainty that the 500th equity component of the portfolio also would not lose its entire value. Hence an equity portfolio's risk management cannot be said to be run with a deterministic AI principle, since AI level is not possible to establish in such a context due to lack of the possibility for a superposition principle. Risk portfolio management for an equity portfolio simply rests on an algorithm, or set of rules and formulas, which however cannot and do not constitute AI.

Foreign Exchange or FX market on the other hand works by a separate Price Scale Foundations principle, which connects every currency to every other currency, provided the portfolio of currencies is made out of all fully and 100% convertible currencies. This document does not have the intent to discuss equity swaps, but simply focuses on the nature of the FX market, which through FX pairs facilitates the buy and sell interface compatible with requirements for an AI.

In simple words, currency pairs can move up or down on the price scale, just like equity prices can. But in contrast to the equity prices, which can show all prices falling simultaneously with narrow market spreads, the FX pairs do not exhibit this same character, provided the ceteris paribus assumption for spread risk is in place. This mentioned ceteris paribus assumption can leave an open possibility that the bid prices for all of the FX pairs can fall simultaneously, but this again requires a selective ceteris paribus assumption for spread risk, where market spreads for certain FX pairs need to behave appropriately to provoke such a phenomenon.

FX market Price Scales Foundation creates a common cross-section with Equity market Price Scales Foundation only when the ceteris paribus assumption for market spread is completely abandoned and then further replaced with a market spread widening assumption of a proportion comparable to a force majeure event or a collapse of market structure in general and a consequent failure of market price mechanism with total malfunction of price discovery market mechanism, which is what the spread widening assumption must postulate to stand a chance to provoke a common cross-section between the Equity market Price Scales Foundation and Foreign Exchange market Price Scales Foundation.

Next, this document demonstrates the described characteristic of the FX market in a chart (continues on the next page).

FX pair instruments in this document are represented with expressions like CCY1CCY2. Currency pairs are generally written by concatenating the ISO currency codes (ISO 4217) of the base currency and the counter currency, and then separating the two codes with a slash, however this document omits the slash character in the currency pair descriptions with the purpose of easier readability in the context of the document.

The character of FX currency pairs and their price movements can be more easily understood through a specific graph chart, which shows a scenario of radical depreciation of all of the world's top 8 currencies in a hypothetical event, which could be described as a race to the bottom. In the example, all currency from CY1 to CCY8 are experiencing a simultaneous and large depreciation of 90% and more.

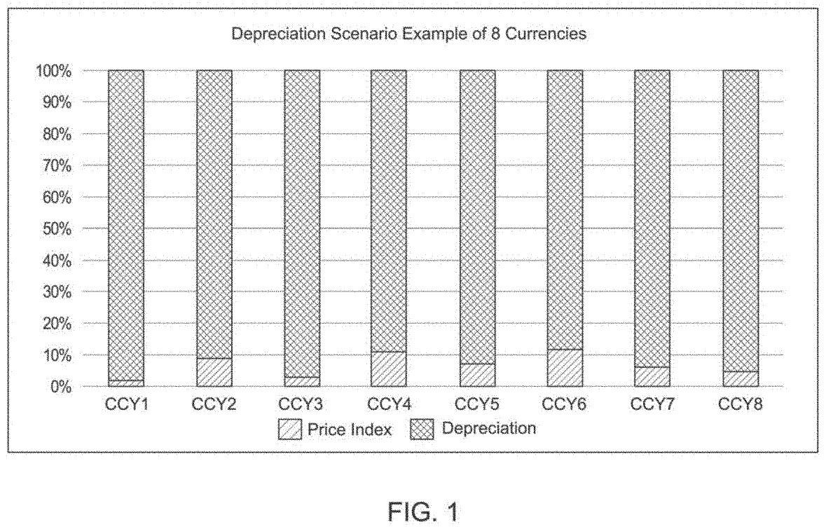

This is shown in FIG. 1.

*CCY1, CCY2, CCY3, CCY4, CCY5, CCY6, CCY7, CCY7 are all falling toward zero in the hypothetical scenario demonstrated in the chart. The chart clearly reveals that in the case where each value of every currency is nearing zero, certain FX pairs will appreciate and move higher due to relative differences between the currency depreciation rates. This holds true, provided that not all of the currencies move to zero with the same velocity at all points during travel and provided that not all of the currencies “touch zero” at the same time or all at once.

This scenario holds true on any scale or for any range of relative volatility differentials, provided that prices move outside of the initial market spread and provided that there is no permanent zero inflation and/or zero deflation scenario implied from present and throughout time into the future. The later excluded scenario describes one of the market structure's mathematical poles, which cannot be resolved by fractal mathematical methods.

The described characteristic of the Foreign Exchange market is one of the key elements for the establishment of the working Pythagorean principles of ARM AI, among other principles.

Risk Portfolio Management vs. Portfolio Risk Management

At the heart of Mechanism for Stability as described in this document is risk management. Generally, the public may refer to risk management in terms of having control over downside portfolio risks and consider this as portfolio risk management.

Portfolio risk management more specifically is oriented into the direction of arbitrary mechanisms that achieve circuit breaks or set downside limits for the performance of the portfolio in the rule set of an investment policy. In portfolio risk management the components of the investment portfolio are seen as cells, which hold upside potential that needs to be maximized, and this holds true for each of the cells or each of the elements of the portfolio.

In the context of the paragraph above, the portfolio risk management aims for the optimal scenario where all of the cells with potential, or where all of the elements of the portfolio, show maximum

upside movement in the resulting performance simultaneously. In such a scenario, portfolio risk management only tracks or follows the scenario with the optional possibility to exit at a target performance level and with an optional possibility to trail the circuit breaker point higher together with the increasing performance curve.

On the other hand, risk portfolio management approaches performance from a different angle by integrating a risk-adjusted returns concept into the core fabric of the process. In the domain of risk portfolio management, the cells with potential are not seen as investments that would be selected for the purpose of profit maximization individually. Instead of investments, they can be seen as risk allocations, each allocation with a risk profile, which assembles into an aggregate risk profile with a different behavior type than the individual risk profiles of respective individual cells or portfolio components.

In portfolio risk management the portfolio is made out of investments for profit maximization, in risk portfolio management the portfolio is made out of elements of risk for risk mitigation. ARM AI deploys its mechanism for stability on the foundations of risk portfolio management.

Algorithm, Strategy and Perspective

The document has established that an Algorithm is a set of rules, which does not necessarily by itself constitute an AI. The document extrapolates from this further, that a set of Algorithms does not necessarily constitute a Strategy.

A Strategy in the context of this document represents a bundled set of rules, which predictably create a working mechanism on a higher level, above that of the Algorithm level. A Strategy as defined in this document is made out of particularly assembled Algorithms. An individual Algorithm in this sense is not aiming to produce final results. On the contrary, the Algorithm works in conjunction with other Algorithms to construct a mechanism, which harmonizes them in the creation of a Strategy.

The harmonization should not occur by arbitrary chance, yet it shall be postulated by mathematical axioms and should be valid at all times, provided that the market does not inhabit one of the market's mathematical poles. This holds true for all transitions between the elements of the Algorithm, Strategy and further elements as described in this document.

Therefore, a Strategy is a set of Algorithms, which behave in a harmonized way by design, and create an observable and repeatable situation where the bundle of harmonized Algorithms can be seen at any moment as constituting one functioning whole without arbitrary uncertainty.

This document further postulates that the next level of the functioning mechanism, which is at a level higher than that of an Algorithm and that of a Strategy, is the level of the Perspective. The Perspective is assembled from Algorithms and Strategies by the same analogous principle where the bundle of harmonized Strategies can be seen at any moment as constituting one functioning whole without arbitrary uncertainty. In the ARM AI mechanism, the Strategies are assembled in this particular way to form a structure called a Perspective.

This document further postulates that a set of Strategies does not necessarily constitute a Perspective. Analog to the comparison between an Algorithm and a Strategy, a set of Strategies still does not necessarily constitute an AI. Further to this, a Strategy in this sense is not aiming to produce final results. A set of Strategies only constitutes a Perspective when a set of Strategies behaves in a harmonized way in relation to each other by design, and so they create an observable and repeatable situation where the bundle of harmonized Strategies can be seen at any point in time during market action travel as constituting one functioning whole without arbitrary uncertainty.

A Perspective in this document is also called a Strategy Pack. A Perspective will include or incorporate several Strategies simultaneously as described in the paragraphs above. A Perspective, which is made out of Strategies, which are made out of Algorithms, is the building block in the pre-assembly process of the ARM AI.

Aggregate Perspective

In the System the Aggregate Perspective is a cross-section of two factorial sets of Perspectives, where the cross-section of factorial sets represents the common denominator between the factorial set by the riskiest individual currency and the factorial set by the least risky currency at any given moment.

The two factorial sets are combined into one common denominator factorial set because of the need to make the process efficient, reduce energy consumption and computer resource utilization, while not resorting to any compromises in terms of introducing any additional arbitrary assumptions. All structures must be axiomatic.

Without the cross-section of the two factorial sets the assembly of the Aggregate Perspective would require a full random walk analysis over all possible scenarios within the quantum space of the world's top 8 fiat currencies, which in this era of technological development would be prohibitively expensive and would multiply the necessary resources needed to perform the calculation operation by a factor of magnitude, while producing only an incrementally improved precision of calculation output.

In the simplest of terms, Aggregate Perspective is a portfolio of Perspectives or a portfolio of Strategy Packs, yet analog to the relations between Algorithms, Strategies and Perspectives, a set of Perspectives does not necessarily constitute an Aggregate Perspective. Consequently, a set of Perspectives does by itself not constitute an AI.

A portfolio of Perspectives only constitutes an Aggregate Perspective when each Perspective is not necessarily aiming for profit maximization by itself, but is integrated into a bundle of Perspectives, which are harmonized by design and together act as a functioning whole, which can be observed at any given moment without any arbitrary uncertainty. In ARM AI this assembly of Perspectives abides to principles of risk portfolio management and risk adjusted returns.

Aggregate Perspective can also be seen as a very specifically assembled Group of Strategy Packs.

Integral Perspective

Due to the missing precision differential between the full random walk over the entire quantum space of the world's top 8 fiat currencies and the Aggregate Perspective of the system, the structure of the mechanism for stability makes one more step prior to establishing a superposition through in its final calculation.

It is stated that an Aggregate Perspective does not by itself necessarily constitute an AI. If an Aggregate Perspective would constitute an AI, the quantum space would only allow for one path from the current prevailing position of the System to the target goal, which would not have any perspective of view of dimension of itself, regardless of how many perspectives it would have (perspectives or Perspectives). By the same token, an increase in the number of Perspectives does not correlate with the level of intelligence or the level artificial intelligence of any system in any way.

The System applies derivative calculus on the geometric form of the Aggregate Perspective and establishes an Integral Perspective. An Integral Perspective is simply a set of Aggregate Perspective snapshots as observed and seen through development and passing of time relative to Absolute and Relative Risk Allocation Amount (VaR and CaR), where the Integral Perspective accounts for the velocity of movement away or toward the target goal, where the velocity can be absolute (absolute distance from the anchor or strike value) and relative (seen as measured by the Risk Vector input to the System). An Integral Perspective is also a change measurement of the Aggregate Perspective, absolutely as well as relatively.

An Integral Perspective is a vector with multi-dimensional geometric form and with a pointing direction in the multi-dimensional space of the world's top 8 fiat currencies.

When observed from the point of view of an individual currency backed stable coin of this document, the harmonization principle, which this document refers to several times, ends at this level. There aren't any harmonized sets of Integral Perspectives in the System if an individual currency backed stable coin is considered as the end result. Algorithms harmonize into Strategies, which harmonize into Perspectives, which harmonize into an Aggregate Perspective, yet from the point of view of an individual currency backed stable coins described in this document, the Integral perspective already represents the fluid development of the total event horizon surface of all of the world's top 8 fiat currencies in the context of the System.

Theoretically speaking, a harmonizing complementary to an Integral Perspective of the System is a scalar quantum space, which is not the subject of this document. Fractal quantum space and scalar quantum space are in a complementary relationship between one another, where scalar quantum space, contrary to a fractal quantum space, acts as inherently unpredictable and for this reason is not an integrated functional element in the system of ARM AI. In this view, the Integral Perspective of the System can be seen as a fractal quantum space domain, which ARM AI rests on.

In simpler terms, the Integral Perspective is seen as a stable construct with predetermined downside risk. An Integral Perspective does not constitute an AI. If there are different pathways on a geographic map that allow a traveler to move from location A to location B, then the speed, which such a traveler would travel with, would not in any way correlate to the level of intelligence of such a traveler.

Superposition (Superposition Perspective)—Innovative Step

The Superposition takes the analogy of the geographic map with different pathways from point A to point B and a traveler, which can travel with different velocities one step further. An Integral Perspective itself allowed for accounting of different velocities away and toward the direction of the target goal, as the Integral Perspective is also a vector.

But logical reasoning tells us that when something is nearing the target goal, the speed should not be very high or at least not in the extreme high-end part of the velocity spectrum. If velocity and distance from the target goal were not related, any approach could overshoot the target goal, leading to heightened volatility without any additional reward from it, leaving a stability result with a sub-par risk-reward ratio.

If the volatility of the performance is heightened near the point of the target goal, the relative volatility of the sum of Perspectives needs to be resolved further and the System just isn't focused on one single most optimal path toward the target goal (optimal stability) just yet. The Integral Perspective cannot help with this situation scenario, since an Integral Perspective by itself does not know which path to select, and only brings out the sharpness of the calculation of the relative velocity relative to the target goal.

The Superposition therefore emphasizes the states of Perspectives, which are close to the target goal or on it, by reducing the geometrically shaped velocity vector near the target goal, or sending the value of the vector of the Integral Perspective's position toward limit zero, where the limit is a mathematical function of an infinitesimally incremented approach toward a certain value—in this case zero velocity. The Superposition will keep the geometric shape of the vector, which is that of the Integral Perspective.

In other words, when a vehicle arrives at the final destination and slows down in the approach toward the target, when it is on the target the vehicle will align its shape and its form with the shape and form of the delegated slot for staying at rest.

In quantum terms, the vehicle never stops, since the velocity vector still has a geometric shape, of which velocity is only sent to the limit zero, but never reaches it in absolute terms. This phenomenon of a geometric shape, which has a velocity vector at a virtual rest is called a resonant frequency of a geometric shape. Such state of a mathematical geometric shape can only be forcefully broken at rest by a scalar frequency wave and therefore is as such seen within the fractal quantum space as stable.

The Superposition is still a Perspective as per this document. The difference between the Aggregate and Integral Perspective types and the Superposition Perspective type is that the Superposition Perspective type also exists in probabilistic space, while Aggregate and Integral Perspectives exist in Pythagorean space only.

Artificial Intelligence—Innovative Step

The Superposition will maintain the geometric shape of the Integral Perspective vector, but will account for relative velocities of the geometric shape and emphasize the states of the geometric shape, which are located on the target goal by reducing vector velocity.

Should the underlying velocity of the Integral Perspective be high, while on target, the reduction in the vector velocity by the Superposition will not resolve the path toward the target goal, but it will improve the risk reward of the result. If there is any overshooting of the target by the Integral Perspective, the Superposition will convert this oscillation into a competition between the opposing underlying forces building up from the Algorithm, Strategy, Perspective and Aggregate Perspective levels in such a way that it will gain performance each time the geometric shape of the Integral Perspective will change when crossing the target goal point.

As a result, the Superposition is able to select various changing shapes of the Integral Perspective to place a portfolio in a stable position from the perspective of time and from the perspective of risk and reward.

The Superposition by itself does not guarantee stability, but it is able to switch or transition between two or several different geometric shapes of the Integral Perspective based on pure relative alpha of the geometric shapes, which means that the Superposition will always prefer the path, which will be a more direct connection to the target goal and it (Superposition) will give less energy to geometric shapes, which are associated with higher costs or higher future risk to reach the target goal.

The Superposition selects the optimal path on probabilistic principles and is able to morph between underlying geometric shapes of the Perspectives to account for relative alpha ratios between these geometric shapes, which (geometric shapes and relative alpha ratios) exist on a real mathematical continuum, between different G Perspectives together creating the X Perspective respectively. G Perspective type and X Perspective type are explained in the next pages of this document.

The Superposition can therefore be considered as artificially intelligent. Not only is it capable of outperforming any human by speed and complexity of the processing of the described calculus, but it is also able to distinguish between higher future costs and lower future costs from the viewpoint of the reward it will get by opting for one of the scenarios.

In reality, the Superposition is not actually intelligent by itself, but it can only become intelligent if all of the building blocks bring the data from the levels of the Algorithms, Strategies, Perspectives, Aggregate Perspectives and Integral Perspective to the relative risk-reward decision level and do this by incremental compounding of information, which comes out of data. This allows the Superposition to discern the Perspectives positions in terms of risks and rewards relative to the target goal.

Information travels and is processed through the described assembly by the fundamental principle that the data is different than information and data creates information by being in-formation. Another way of viewing this is the data being in pro-per in-formation, which translates to being for and as assembled through shapes carrying meaning and purpose.

ARM AI and Bell's Theorem in Finance

The author states that Bell's theorem can find at least two supporting cases within finance and financial markets. One supporting case constitutes a partial proof of the said theorem, which involves the different states between the two polarized algorithms deployed on a single account structure, versus two polarized algorithms deployed on a dual account structure, invoking a relative volatility differential between P&L states of the two polarized algorithms once the price in the market moves beyond 33% in distance away from the strike price, something which cannot be invoked by deployment on a single account structure.

This mentioned principle is a basic principle of non-locality or an invocation of a so-called unknown variable, hiding in the construction of the values of numerical prices, when constructed off-site or non-locally. Unfortunately, the application of this partial proof of Bell's theorem in the financial market opens doors and possibilities for money laundering and is destructive to the nature of the market pricing mechanism, as it does not add to the liquidity of the market nor to the strength of the market structure in a meaningful way. From the mathematical perspective it represents one of the poles of the financial market structure.

On the other hand, the second case, which supports Bell's theorem in finance is an example adopted by ARM AI. The difference between the mentioned partial proof case and the full proof case adopted by ARM AI is that there isn't any construction of off-site non-local variables on the atomic level the integrity of the account structure is kept intact throughout.

The question is, why would anyone want to prove Bell's theorem in finance and it is a good question. Namely, a positive reading or a confirmation of the Bell's theorem implies that the sum of parts if assembled locally will be different than a sum of the same parts in the context of non-locality.

One answer to the question is that this can reduce the costs of transactions in the market. It can also be translated as an improvement in the risk-reward profile of the investment policy by an interesting margin.

The second answer though, is more about looking into the future, which is the future of decentralized finance. Invocation of this principle may prove to be fuel for affordable encryption, which does not need an extra budget or resources compared to what we like to see from centralized systems, which are fast and less expensive at the moment, but not decentralized.

This ARM AI manual's purpose is about giving enough explanation in order to understand the principle, which is embedded in the ARM AI and will not elaborate on the aspects of the said theorem itself and whether it is a potential driver of change in decentralized finance or not from the moment of the submission of this document and into the future.

ARM AI's proof of Bell's theorem can be found in the application of the cross-sections of the already discussed factorial sets of Perspectives. The document fill further elaborate how 7 Perspectives assemble into an Aggregate Perspective set. Each Perspective is made out of a cross section of two factorial sets, one factorial set by riskiest currency and another factorial set by least risky currency. There are 7 Perspectives in the factorial space of 8 currencies, where ARM AI allows each Perspective to inhabit a slot in the multi-broker backbone of the system. The default status of ARM AI is that all Perspectives are pointing to one account held with one Foreign Exchange broker.

The Bell's theorem can be partially invoked by pointing individual Perspectives to several different accounts of the same base currency with the same Foreign Exchange broker or a Bank. However, this does not benefit any party in the relationship as the additional benefits from such a setup are not evenly distributed in the relationship and are purely probabilistic.

The technique though has a high and very reasonable applicability in a case of decentralized reserves management, where accounts in an identical base currency are held with different Foreign Exchange brokers or Banks, that make up a group in the multi-broker or multi-bank execution architecture, which is also where the reserves are held in a decentralized way. In such case the benefits from the invocation of the Bell's theorem are evenly distributed across the network and its users and actually reduce the transaction costs without side effects and other burdens on the system.

The System—ARM AI—The Model

In the System, any dimension of price or market spread risk for instruments like FX and others asset classes can be strategized. The System executes Market Risk Position per Capital at Risk input and Risk Volatility choices by the administrator.

Risk Adjusted Returns

In the System FX price space can be strategized by concepts like triangularity. In a triangular structure net VaR per 3 components (1 risk unit each) in a standard configuration will yield 1.75 as a theoretical max hard VaR cap. The progression happens at the point of adding a third angle to the structure. For example, single EURUSD risk placed in the market will show maximum risk unit of 1, when adding USDJPY as a second component, total risk units will show 2. However, in a structured 3 components combination with EURJPY at mid deltas, as used in the standard view, the Value at Risk of the total triplet is reduced from 2 to 1.75 instead, not increased from 2 to 3 (because of extra check information source from the third triangular pair). Nominal potential rewards do increase from 2 to 3 however.

In progressions from triplets to sixes and further to complete integral multangular structures the risk adjustment is accentuated, placing more potential reward on top of effective risk, optimizing the efficiency of capital while mitigating risk, that does not carry marginal informational value by formation lock and overall portfolio hedge

The science behind this is about volatility differentials and relative risk casting.

Volatility Differentials

In simple terms this means that away from strike price the volatility of P&L changes even with linear positions. A school book example is two opposing positions on the same instrument placed on two different accounts will show volatility differential should the profits on the positive account be booked by the close side of the spread and reentered on the far end of the spread once more for composite net 0 position to be maintained on the two accounts as price moves. For linear scales the effect appears at 33% or more from strike, where such account duo shows net effect from this volatility differential and show total net new NAV positive potential despite 0 cumulative price risk at all prices.

In non-linear terms the curvature of risk space enables this effect to be targeted at distances less than 33% away from strike by virtue of relative risk casting. It transforms any part of linear scale into a medium for relative risk vector, aka risk casting. This is the facility through which the System enables the administrator to place absolute Capital at Risk engagement at relative risks of choice. In turn many different combinations for extracting relative risk volatility differential in capital markets are available in the System. Nonetheless, relative risk volatility extraction, although present it is only a side effect underpinning the main principle. In the Strategy the performance primarily has support in the relative spread volatility of an instrument, while composite Strategy also works by principles of differentials of volatility of the spreads between different instruments.

The Algorithm

In this ARM AI Manual document, the Algorithm will be the accepted terminology for a price risk profile of the 1st Horizon as per “Horizons” control.

The simplest form of the curve of a price risk profile is a performance curve of assets one would get if one would gradually and incrementally invest 100% of assets by exposing them to market volatility to a greater degree, the more that market prices would fall.

For example, one starts with 100 units of assets. None of these assets are invested at the beginning. For the sake of simplicity of the explanation the document will assume that the performance curve at the beginning for these assets starts from a flat starting position. Another assumption for this example case is that the investor (in this case the Algorithm) observes only one market instrument and starts investing the mentioned assets as market prices show depreciation.

In the example, as the market price of the hypothetical instrument falls by 0.5%, the Algorithm invests 0.5% of the assets allocated for risk taking and buys with this portion of its assets the market exposure in the hypothetical instrument.

As market prices decline further by another 1% for example, the Algorithm invests a further 1% of the assets allocated for risk taking and adds to the market exposure. When another X % decline in the market price of the hypothetical instrument occurs, the Algorithm invests further X % of the assets allocated for risk taking and increases market exposure.

If one would start this method on a hypothetical instrument when the starting price would be 100 and if one would continue by the same principle until the market price would touch 0, the performance curve of the assets allocated for risk taking within such an exemplified price range would look like the next shown example, which includes the “Horizons” control.

“Horizons” control (model of the control) represents one of the Innovative Steps.

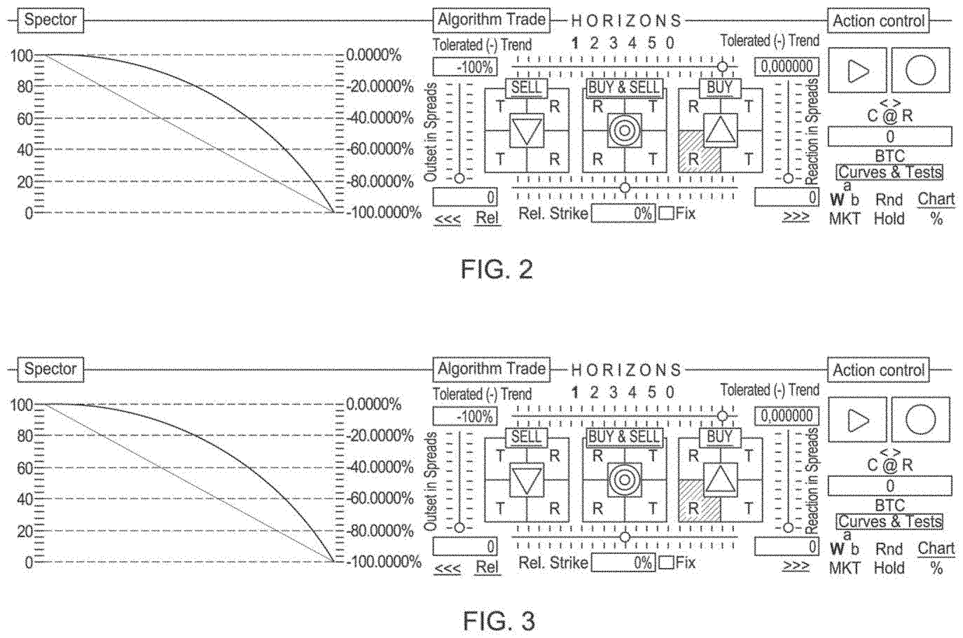

This is shown in FIG. 2.

In the System this represents only one possible example of the Price Risk Profile. It is also called the standard worst-case price risk profile. CaR of the standard worst-case risk profile equals 1 Unit.

Nevertheless, risk profiles and curves that represent them are a vector in the System. In other terms, the curve as exemplified would look or appear exactly the same and could extend between practically any two values (starting value and end value).

The System does not predetermine or limit the profile curve to be between an x value and 0 value. The curve of the price risk profile can be between x and −x for example, which can be between 100 and −100 respectively, or also between other values.

Since the risk profile curves in the System are vectors, the curve of the profile can also be between x and y, where y is an increment of x. This means that a curve with the same appearance can extend between price point 100 and price point 99 for example. From the System's point of view the range, which the profile covers, is called relative risk volatility and the amount which is allocated for risk taking within the said range is called the absolute risk amount.

Algorithm's Horizons—Innovative Step

Algorithm's Horizons come out from the ability of the Algorithm to observe its own performance or the input from other Algorithm's instances. When the performance of the worst-case risk scenario of the previous order's Algorithm Horizon is observed by the Algorithm itself, the resulting risk profile of the particular order will be adjusted like shown in the examples below for Horizons orders of the Algorithm from 1 to 5 respectively. Regardless of the order of the Algorithm's horizon, the CaR of the Algorithm equals 1 Unit.

Example: 1^{st} Horizon of Trend Price Risk Profile is shown in FIG. 3.

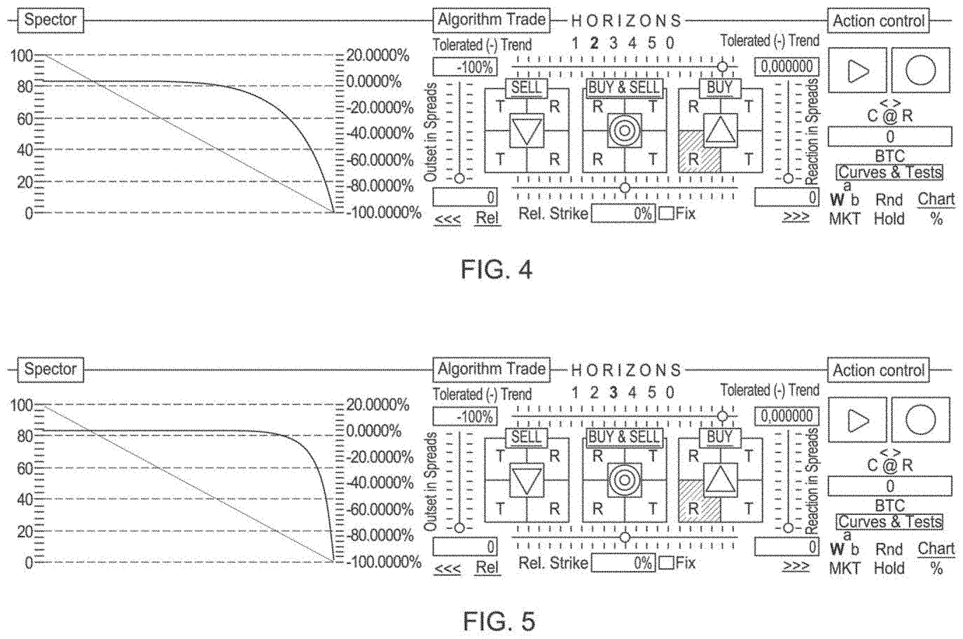

Example: 2^{nd} Horizon of Trend Price Risk Profile is shown in FIG. 4.

Example: 3^{rd} Horizon of Trend Price Risk Profile is shown in FIG. 5.

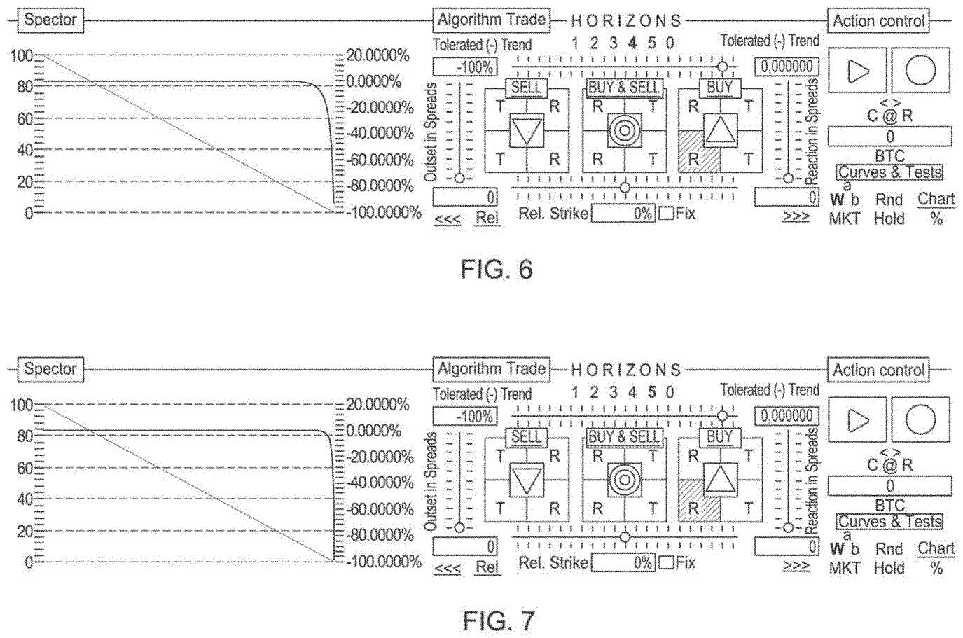

Example: 4^{th} Horizon of Trend Price Risk Profile is shown in FIG. 6.

Example: 5^{th} Horizon of Trend Price Risk Profile is shown in FIG. 7.

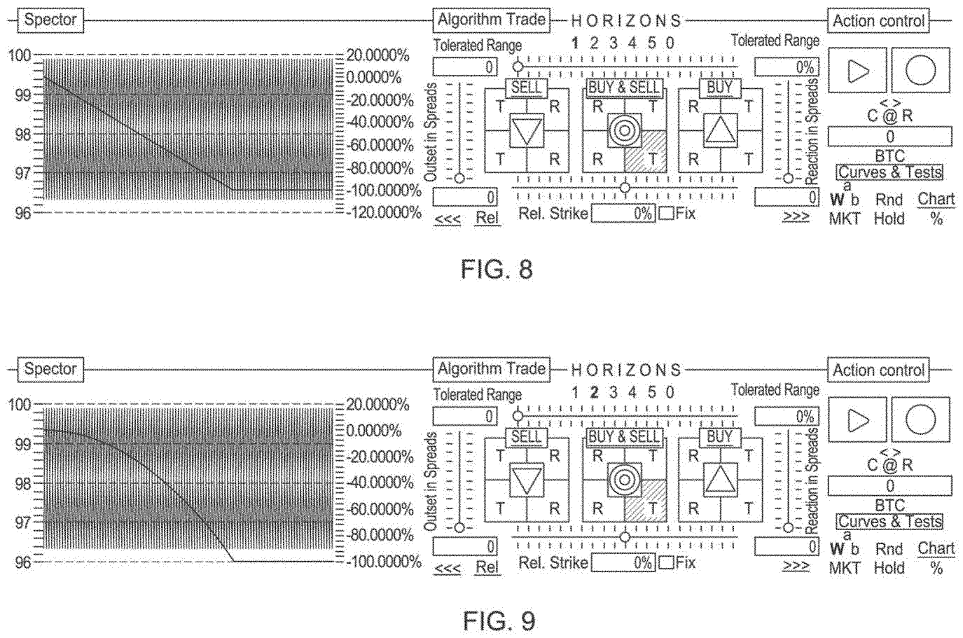

Example: 1^{st} Horizon of Range Price Risk Profile is shown in FIG. 8.

Example: 2^{nd} Horizon of Range Price Risk Profile is shown in FIG. 9.

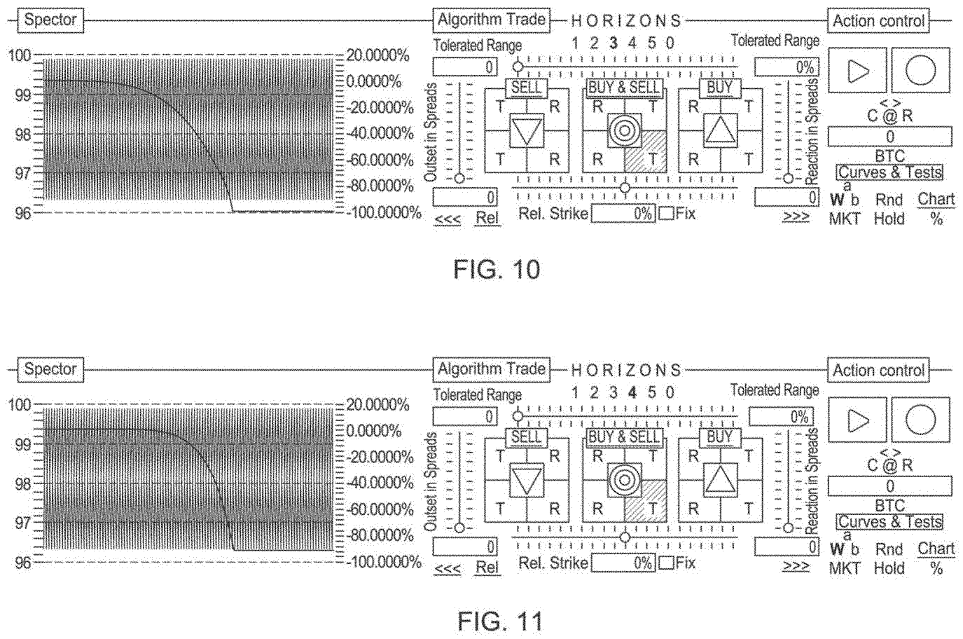

Example: 3^{rd} Horizon of Range Price Risk Profile is shown in FIG. 10.

Example: 4^{th} Horizon of Range Price Risk Profile is shown in FIG. 11.

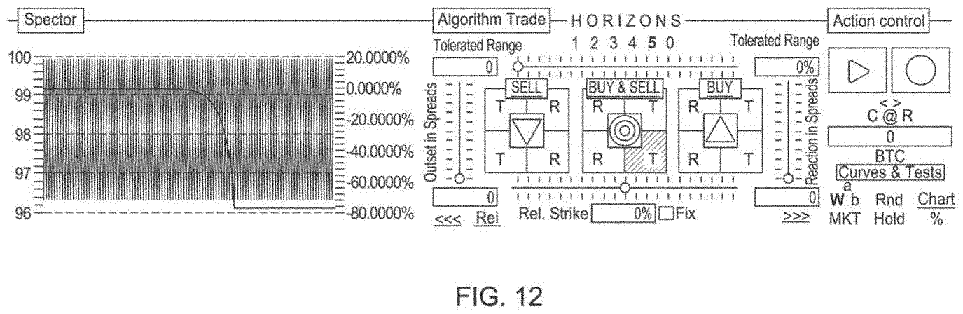

Example: 5^{th} Horizon of Range Price Risk Profile is shown in FIG. 12.

Strategy Assembly from Algorithms

While the Algorithm in the basic sense applies to an instrument, or a single instrument, the Algorithm in such basic form cannot create structure where more than one FX pair is a part of the assembly, at least not with one Algorithm configuration.

This document will focus on risk portfolio management. From its view the most obvious interesting case example is where Algorithms are applied in a triangular space or in a Pythagorean space.

The basic scenario is a structure made out of three Algorithms, which are applied on specific FX pairs in order to create a coherent triangular assembly for the purposes of describing interaction between 3 currencies together with and through their price risk profiles.

The document will also call such structures G structures. For example, if one would choose the world's top three currencies (USD, EUR and JPY), the Algorithms, which would interlink those three currencies from a price risk profile point of view, would create a G3 structure.

Analogous to the example of 3 currencies, called G3, the document will further develop the concept of G6 structures, which connect and link 6 currencies between themselves into one interacting mechanism.

Example: “G” type structure assembly (G3-3 currencies: USD, EUR, JPY)

1st Horizon triangular Strategy (G3):

FX Pairs: EURUSD; USDJPY; EURJPY

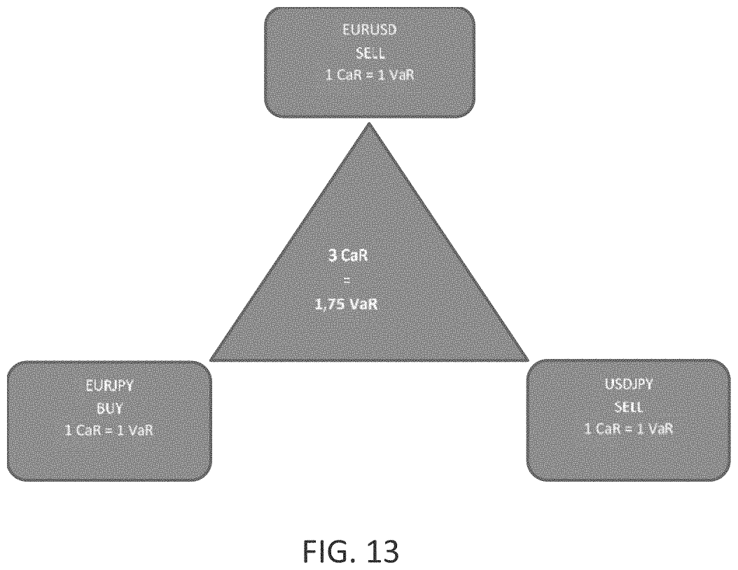

This is shown in FIG. 13.

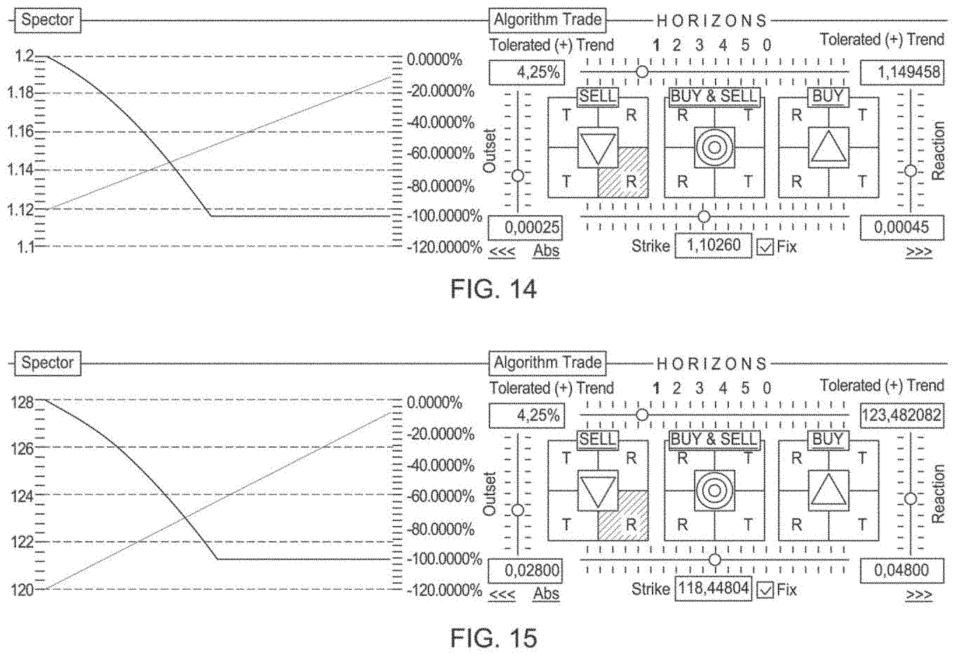

EURUSD is shown in FIG. 14.

USDJPY is shown in FIG. 15.

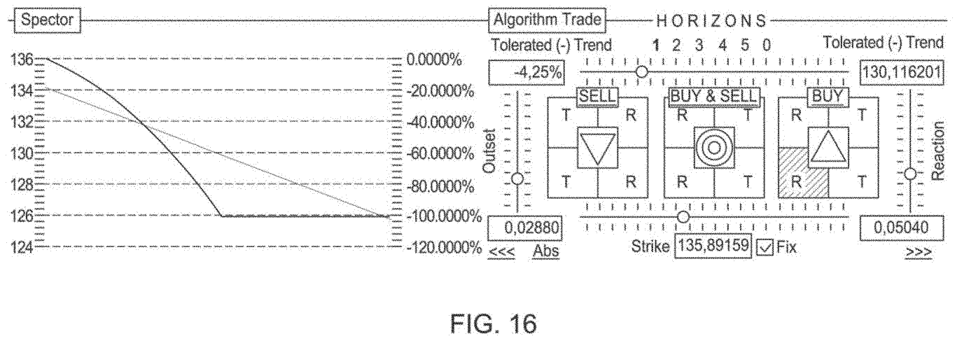

EURJPY is shown in FIG. 16.

Example shows the Horizons control set at 25% deltas for initial cross section of the Algorithm triplet in the Strategy. Consequently, the strike point is set at the middle of the selected tolerated price range.

Example: “G” type structure assembly (G6-6 CCYs: USD, EUR, JPY, GBP, AUD, CAD)

1st Horizon G type Perspective by FX Pair (G6): EURUSD; EURGBP; GBPUSD; USDJPY; AUDJPY; AUDUSD; EURJPY; EURCAD; CADJPY; GBPCAD; GBPAUD; AUDCAD

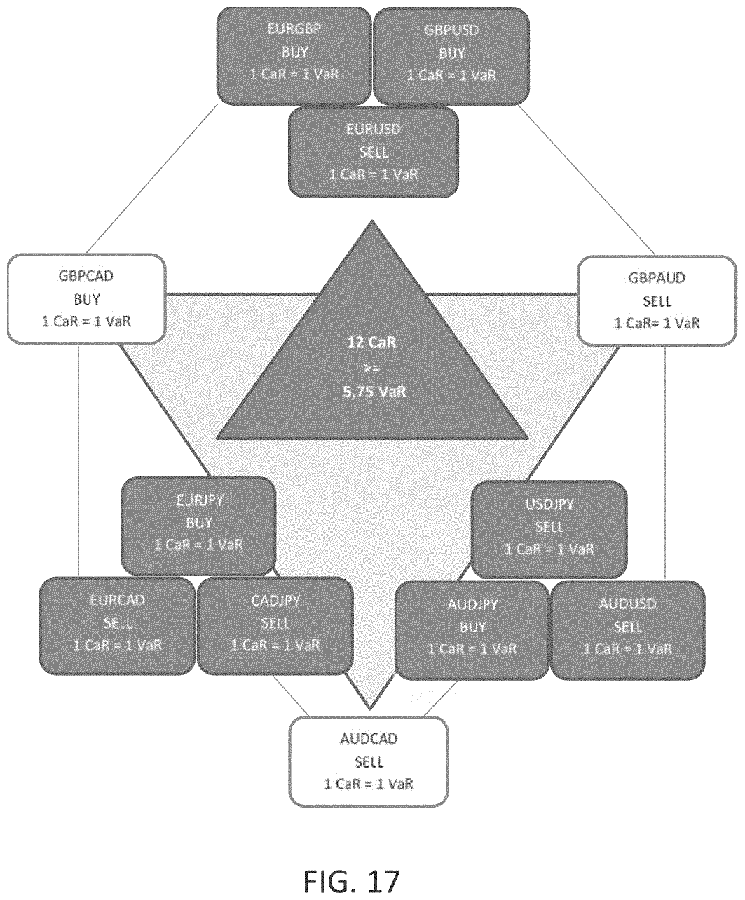

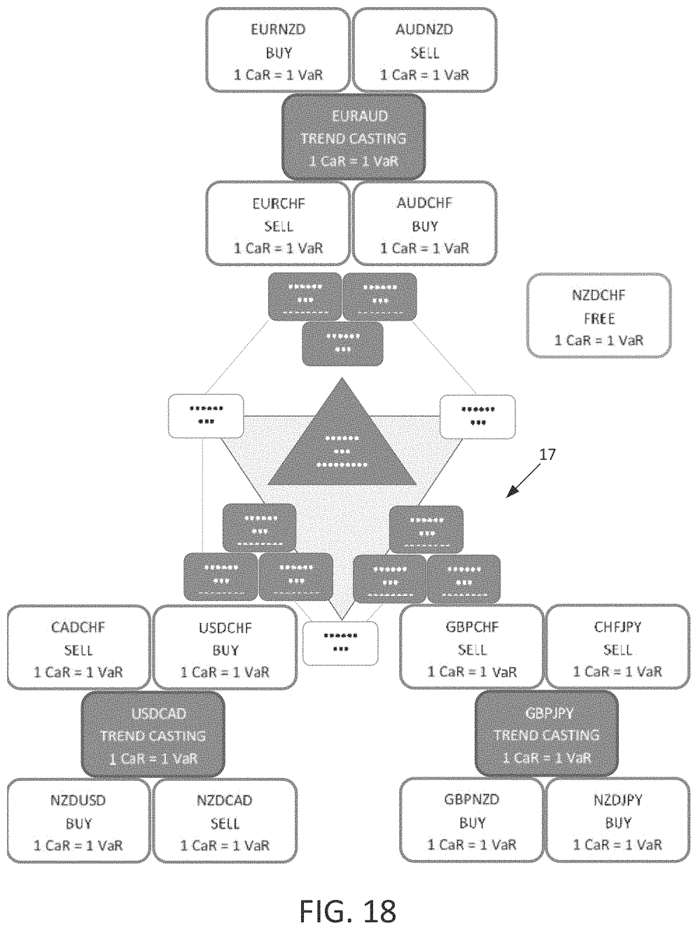

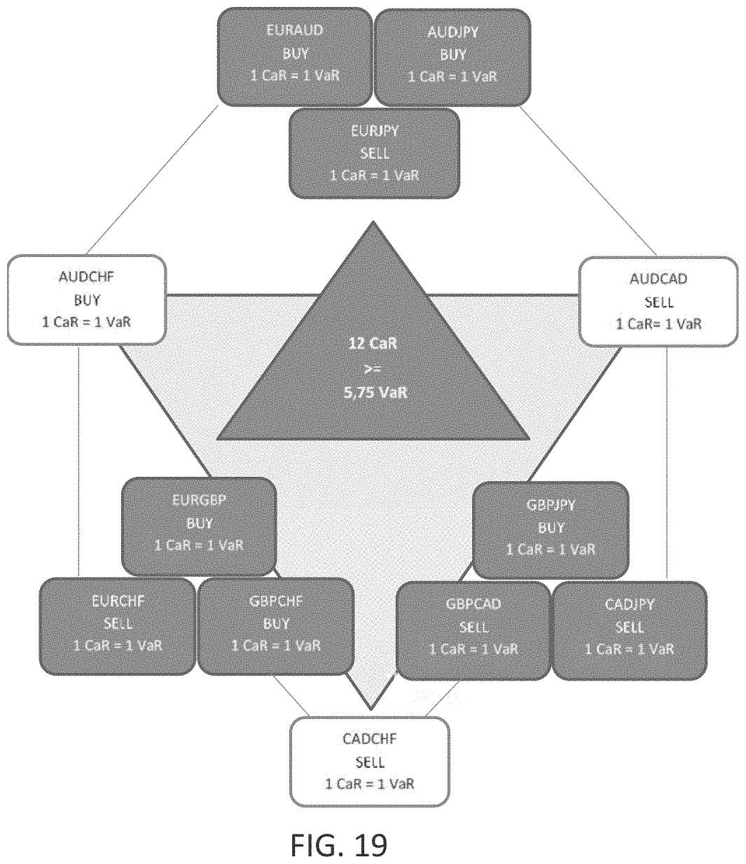

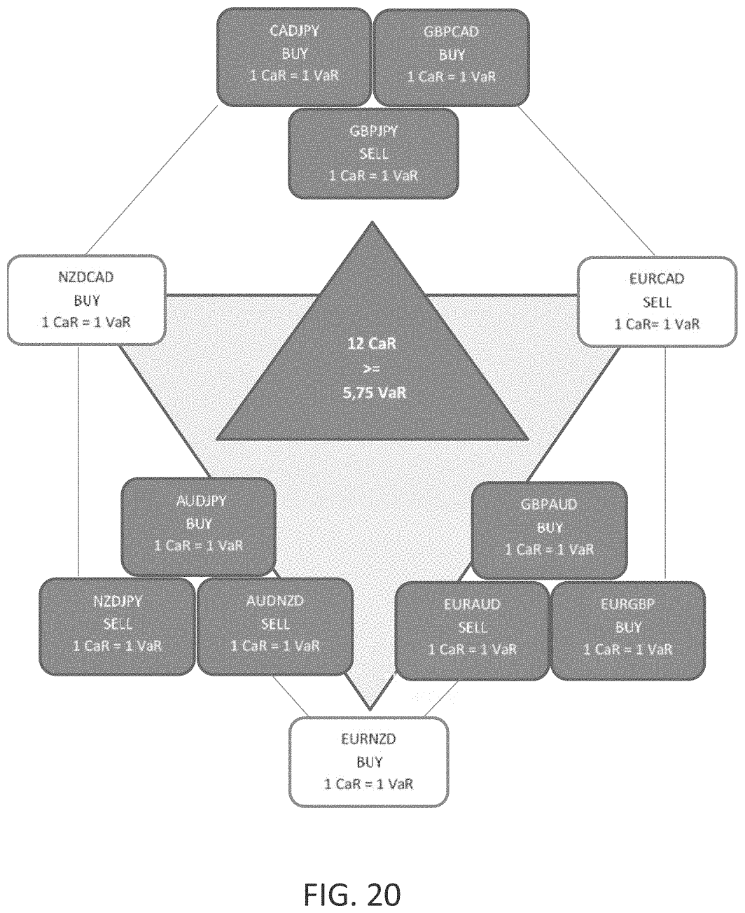

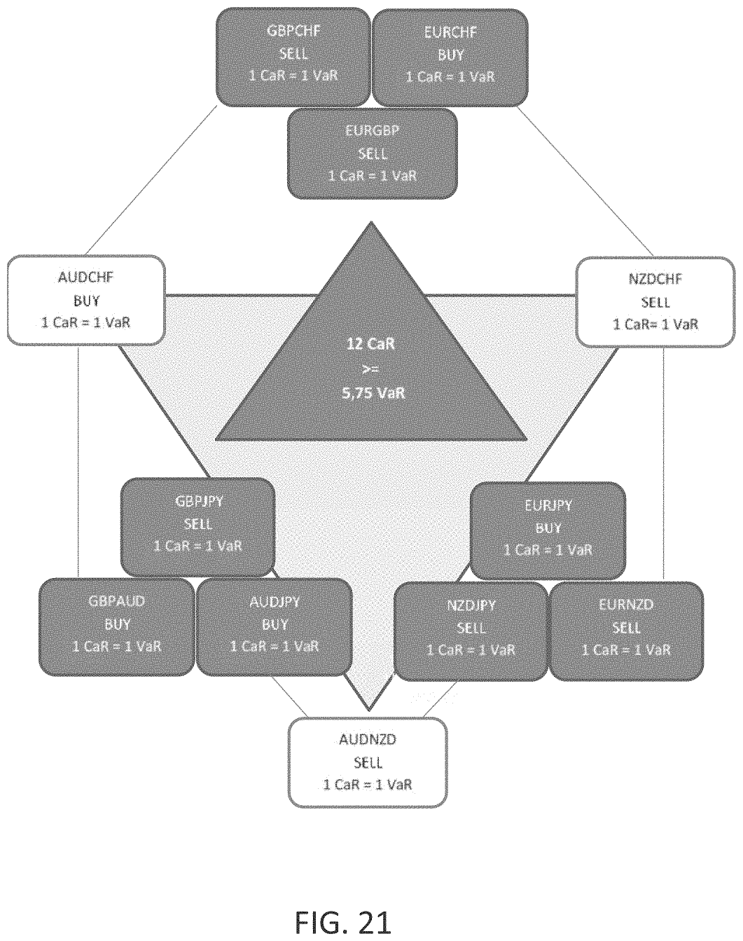

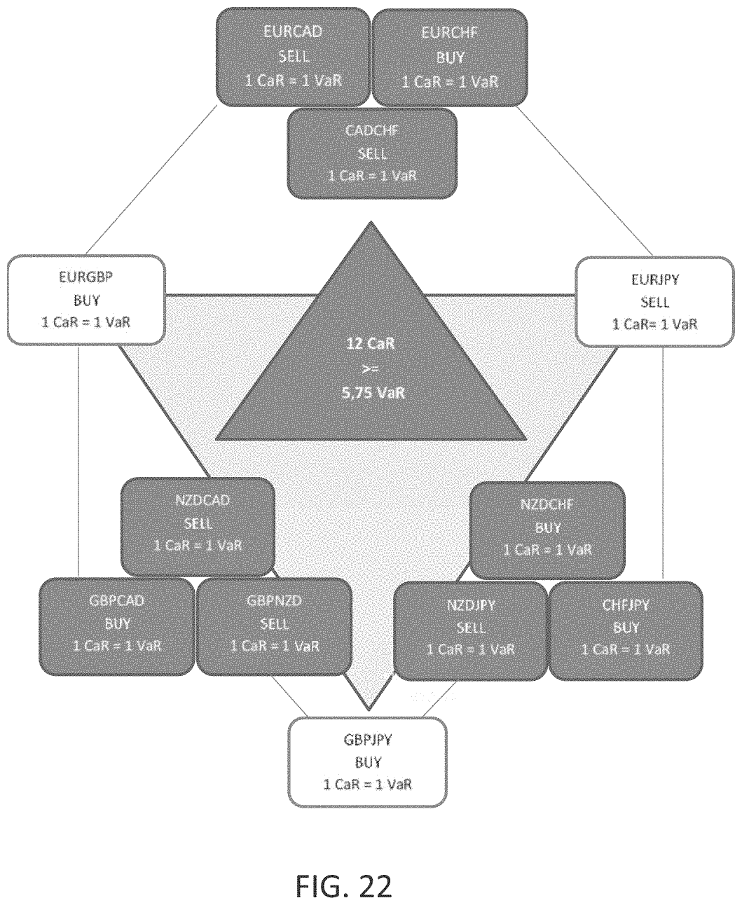

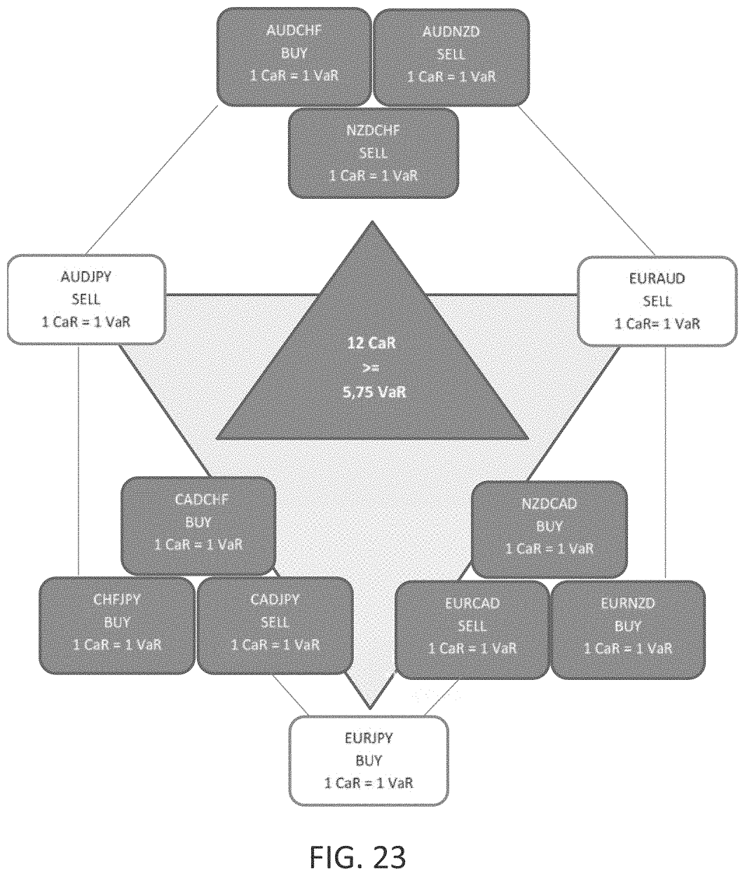

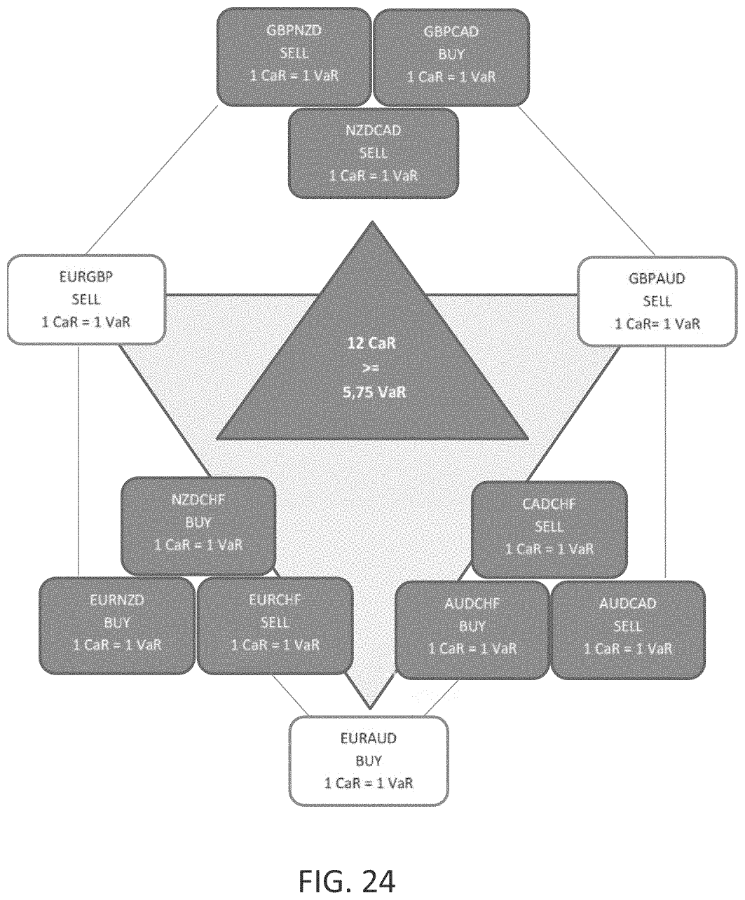

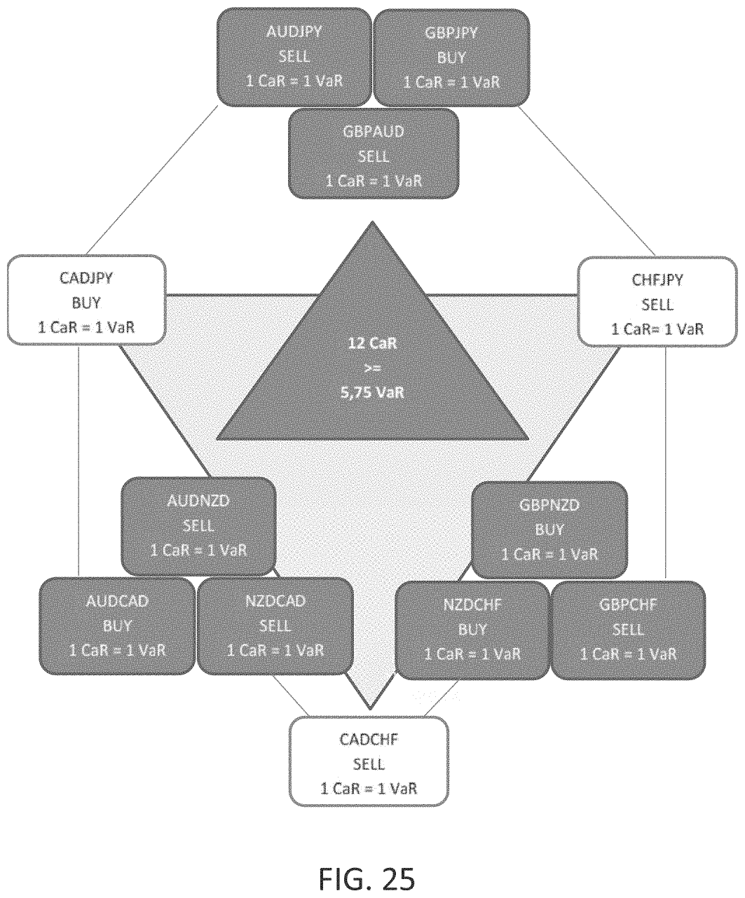

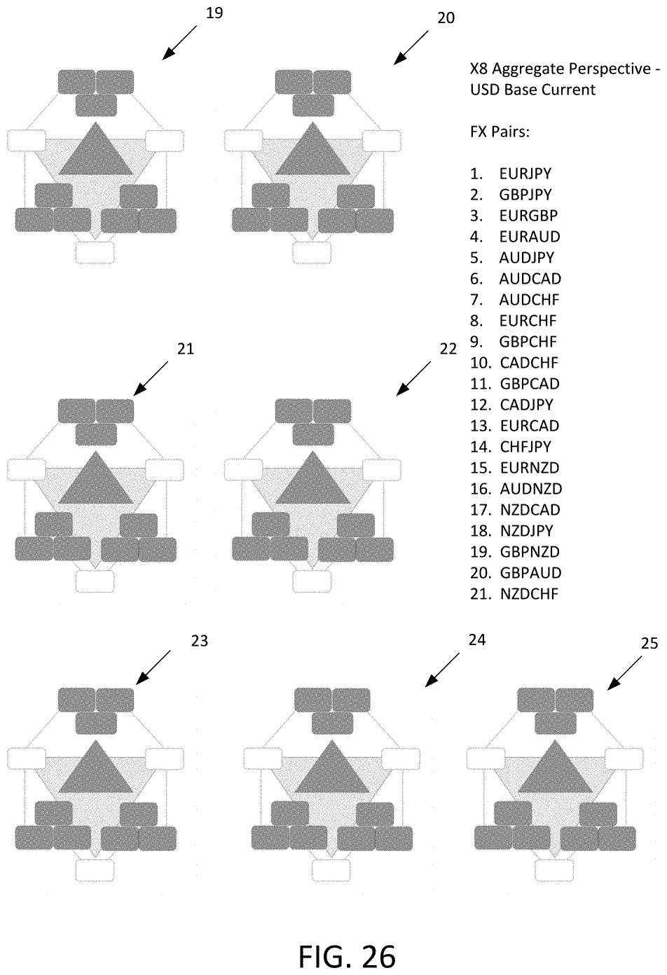

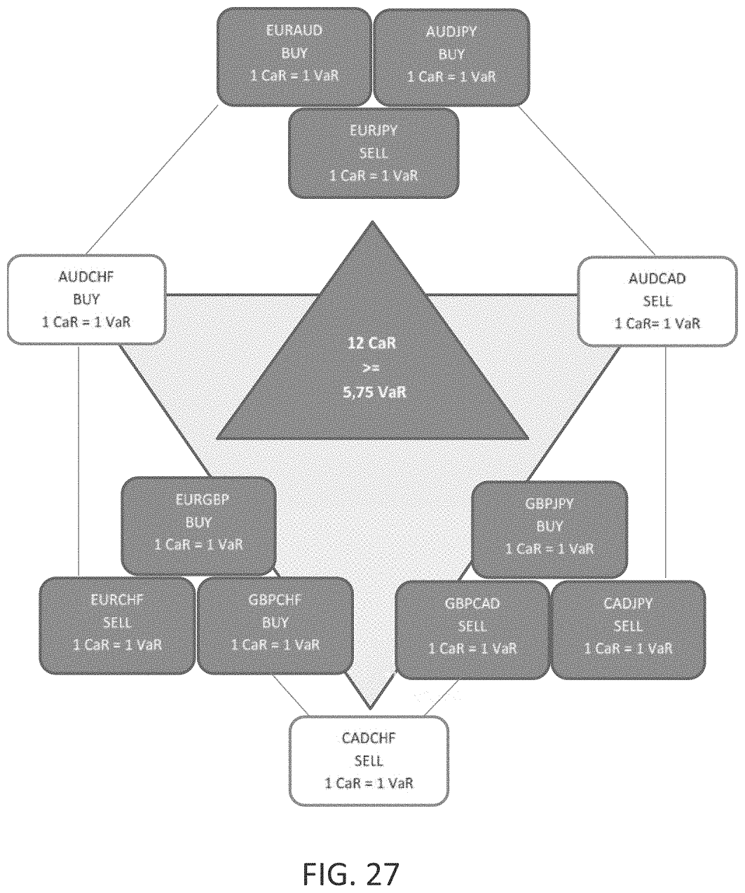

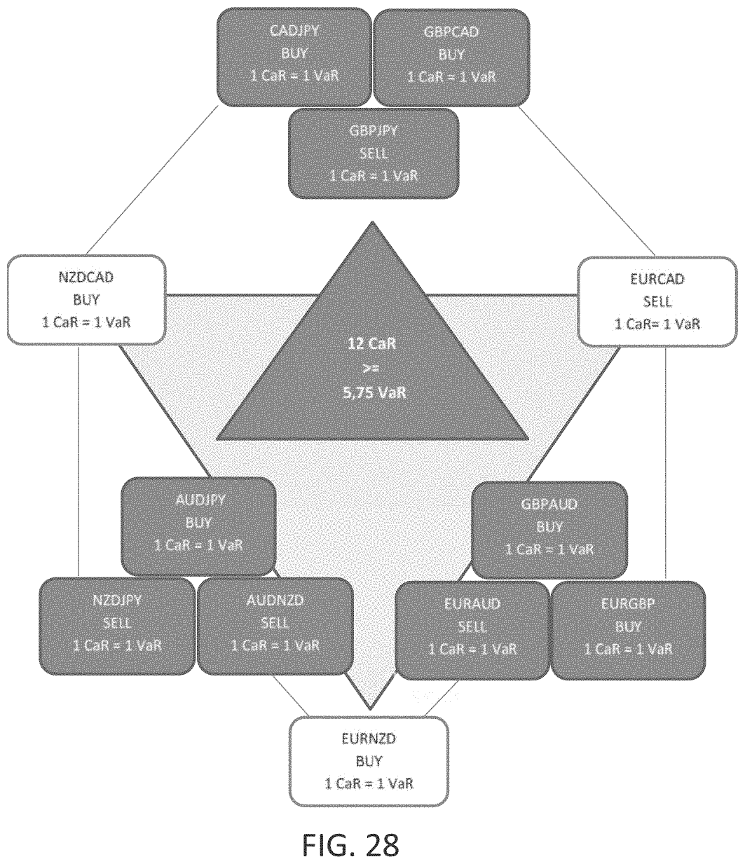

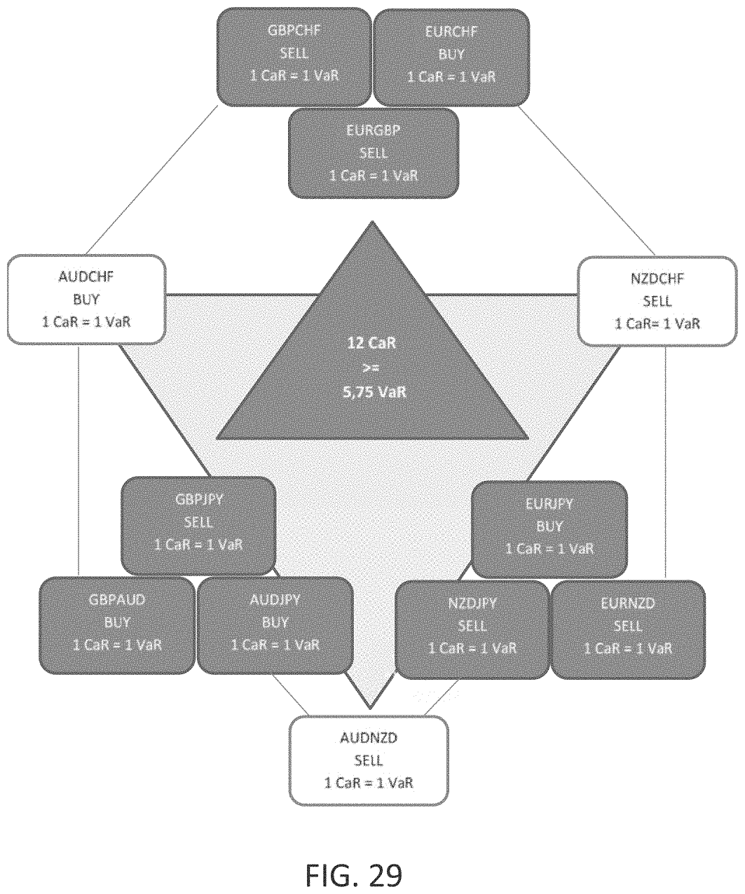

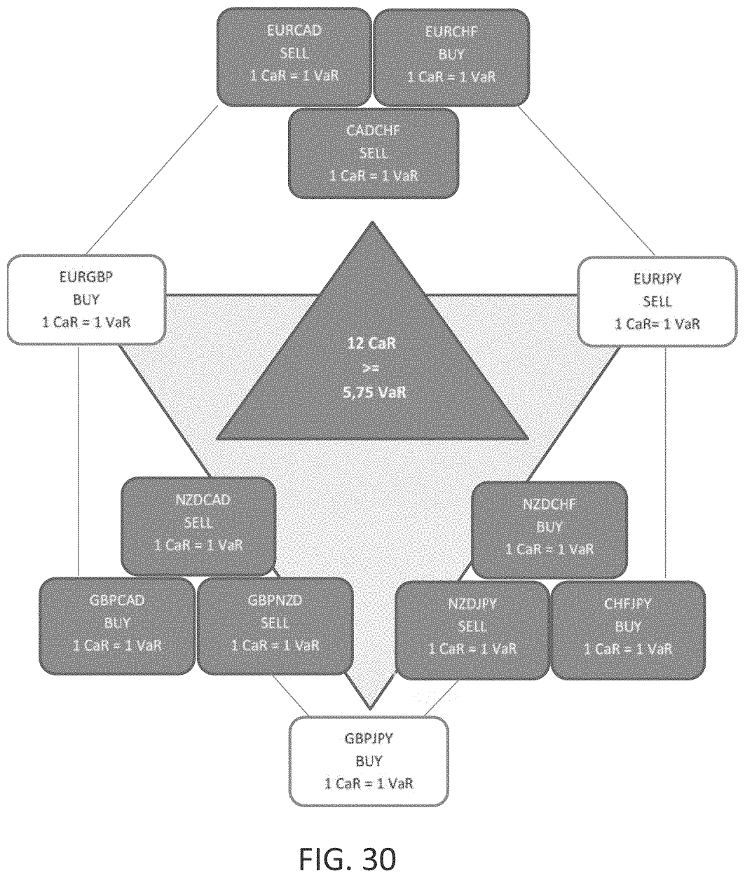

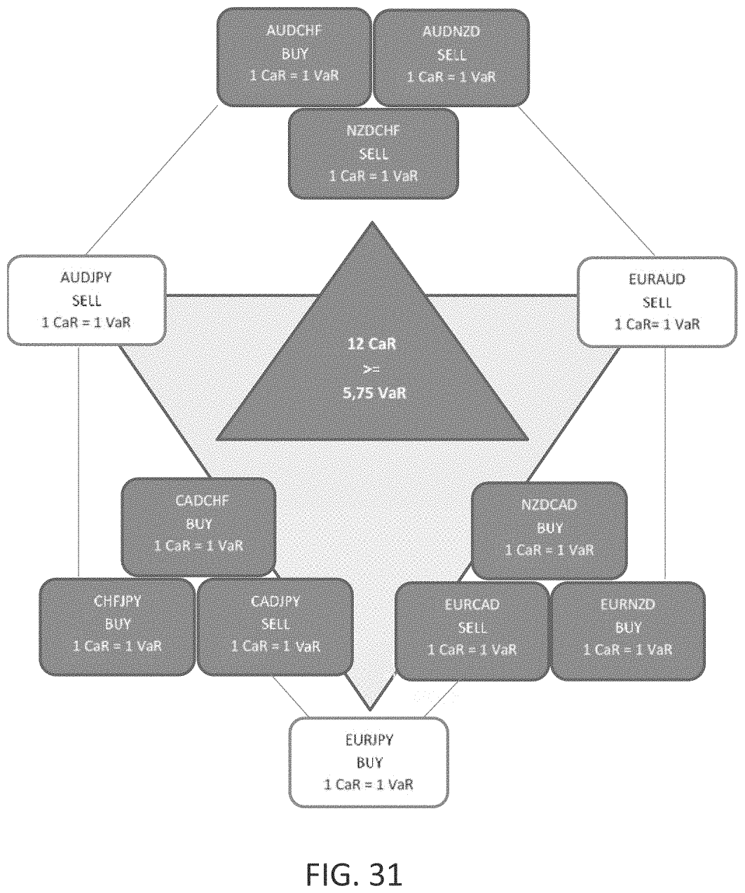

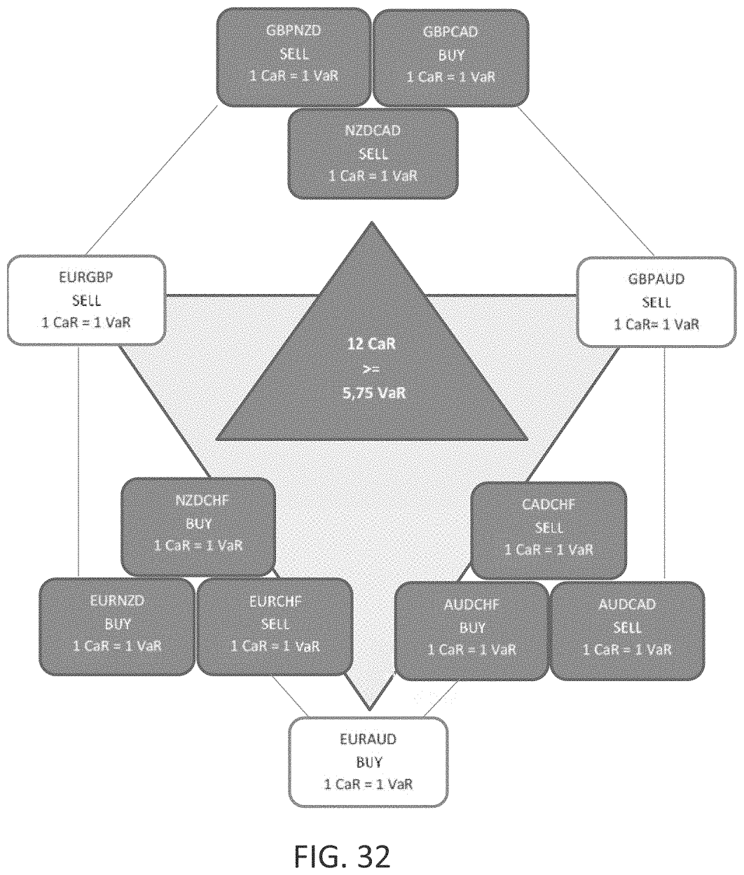

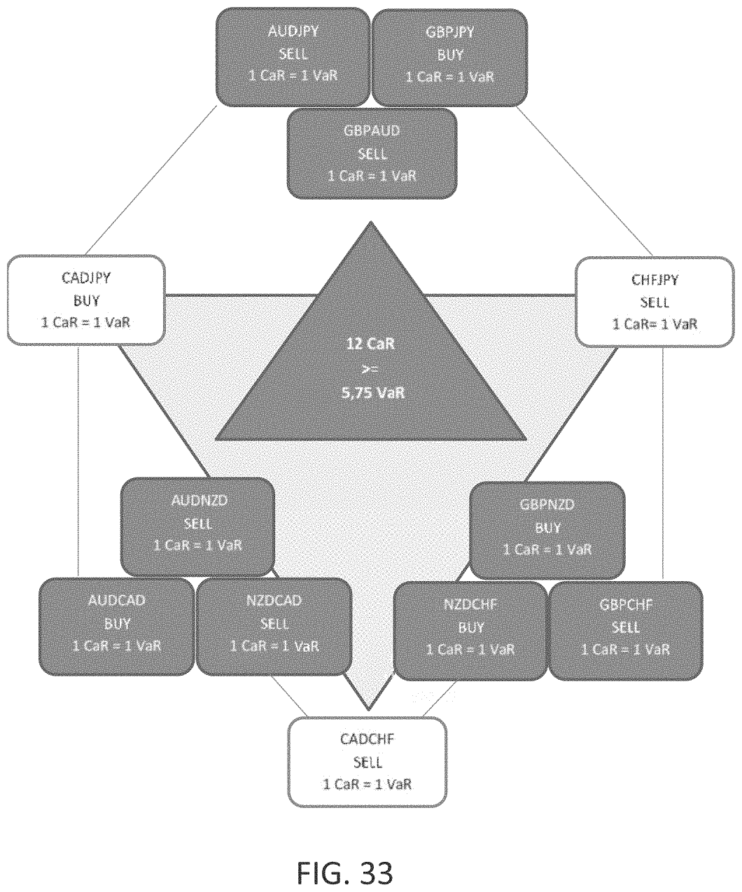

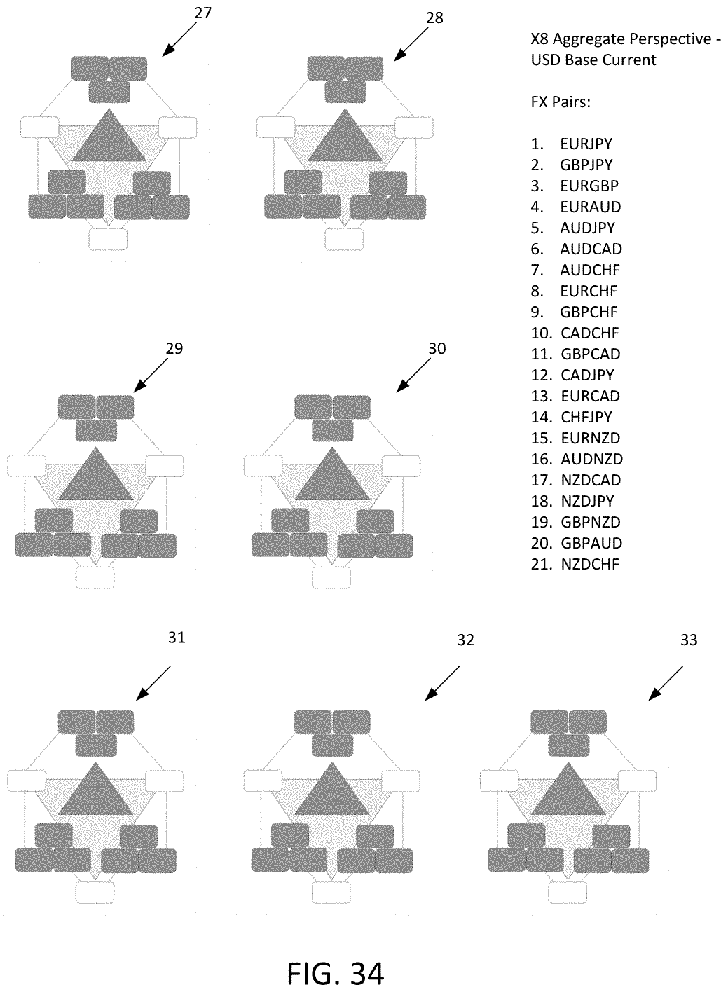

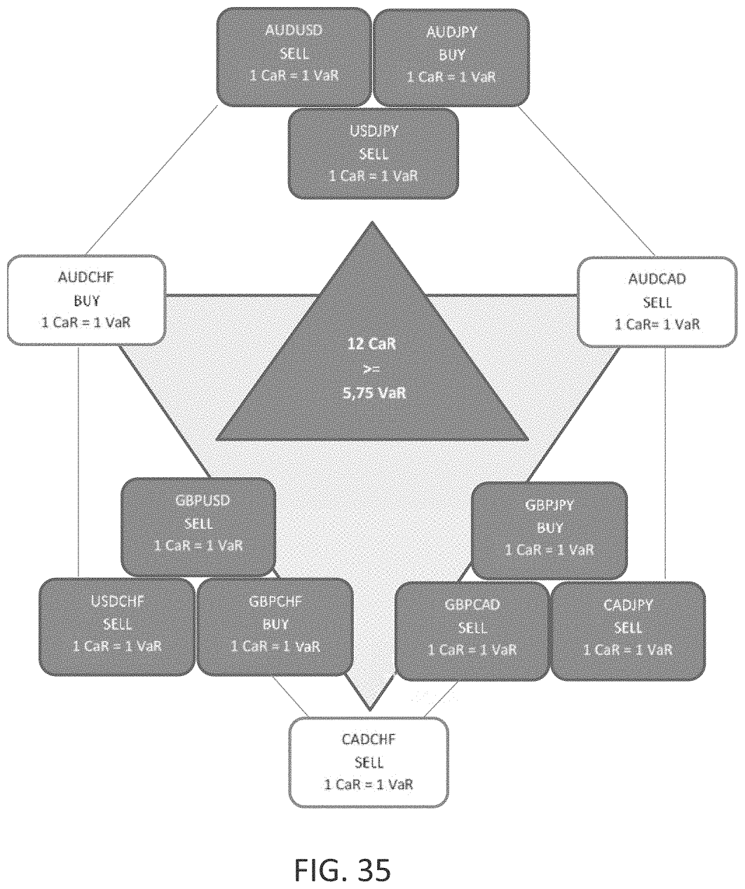

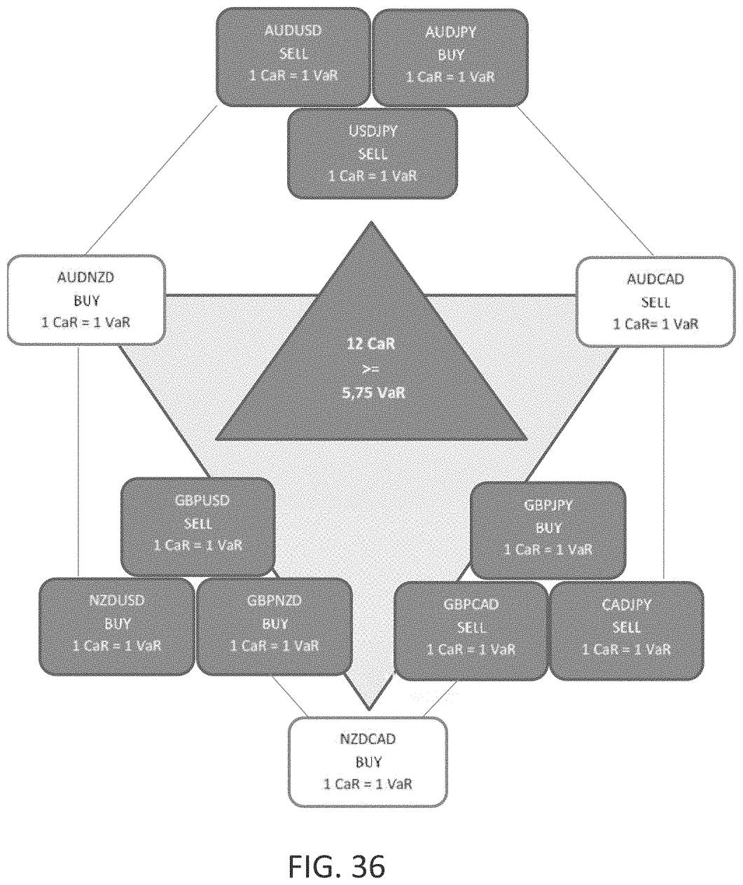

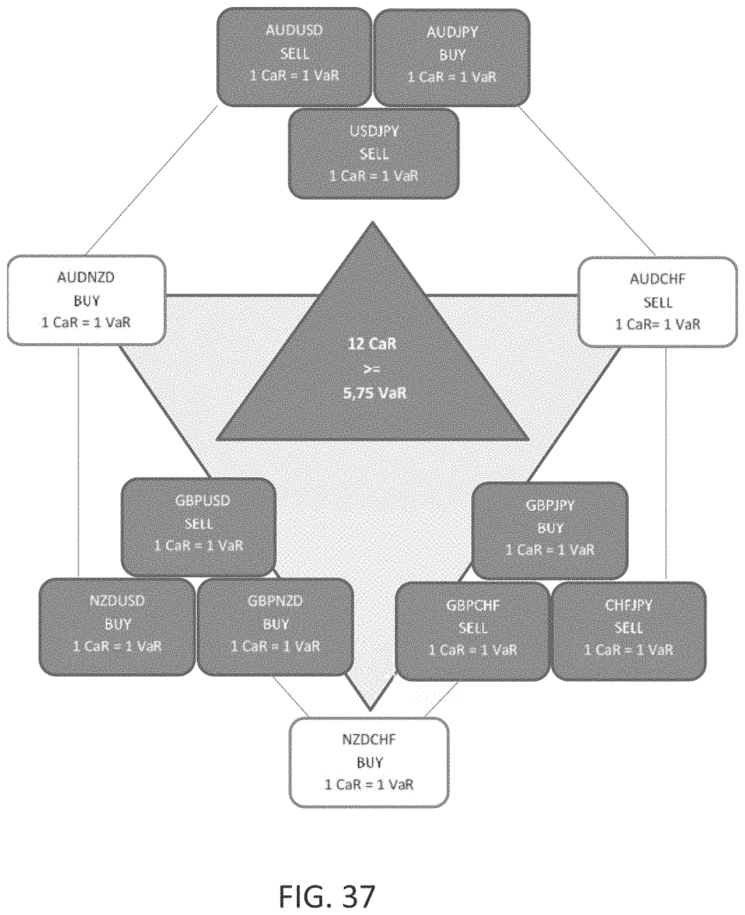

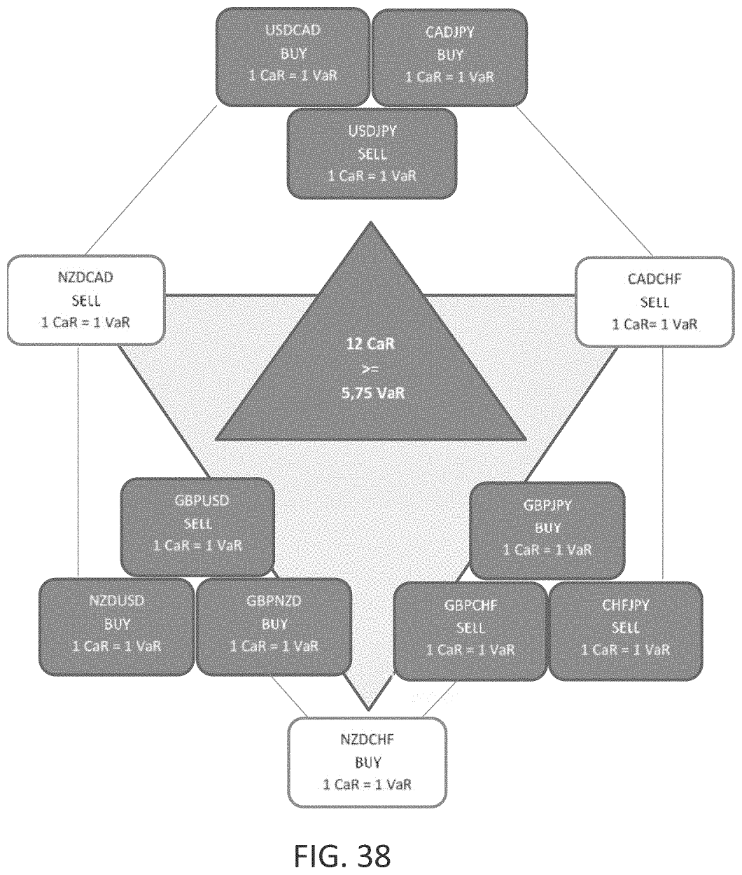

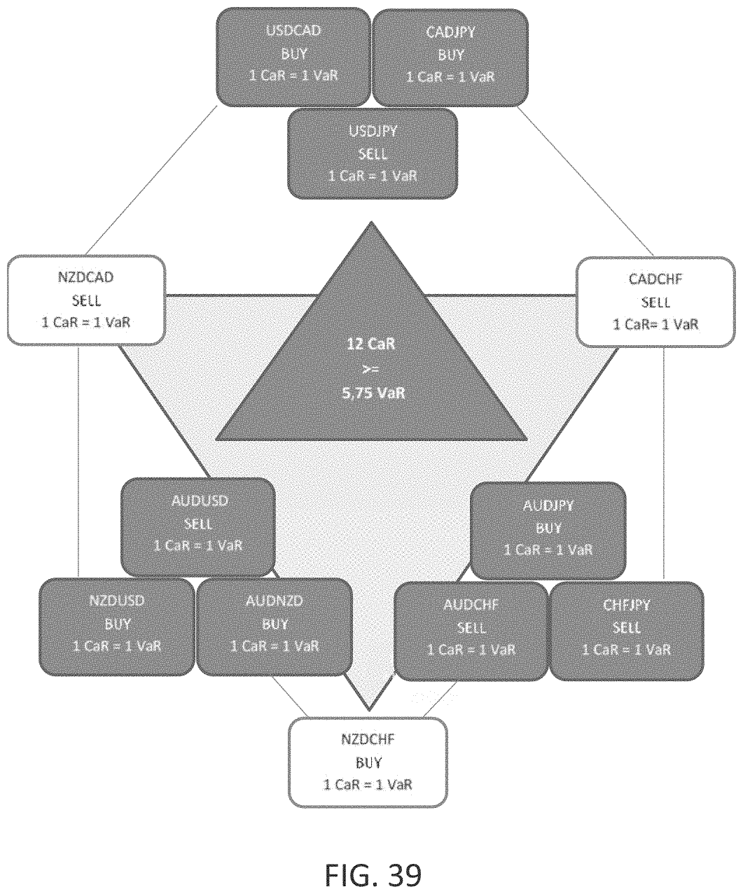

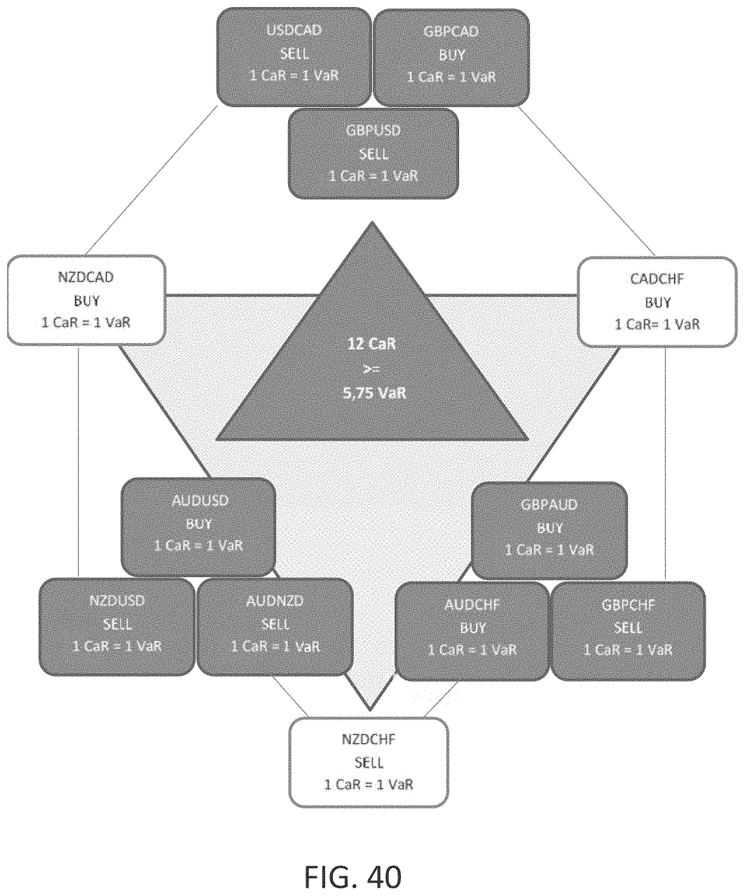

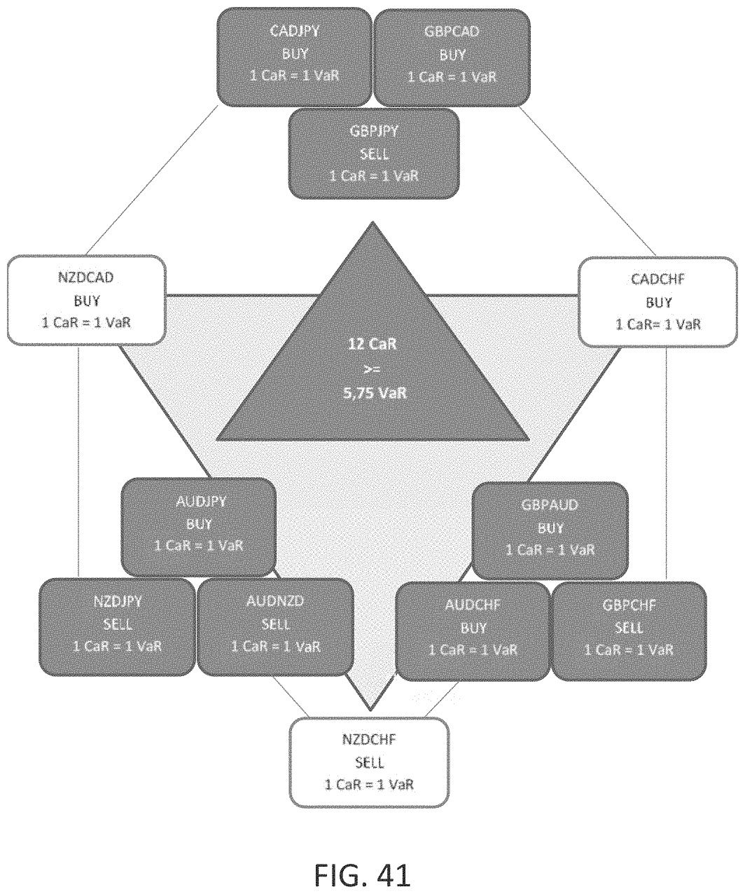

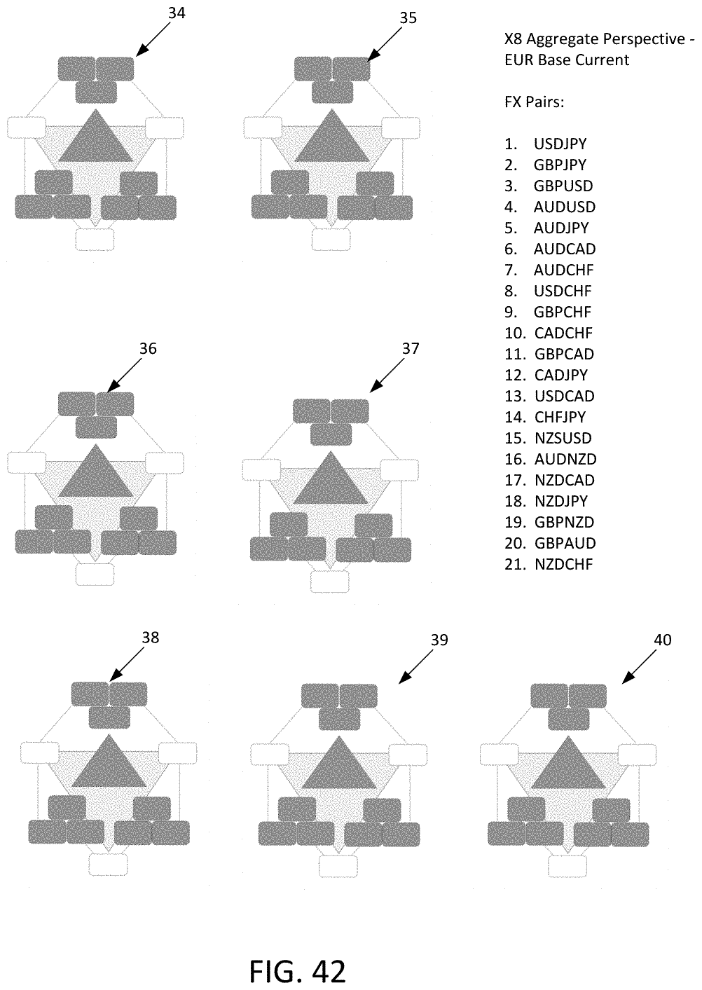

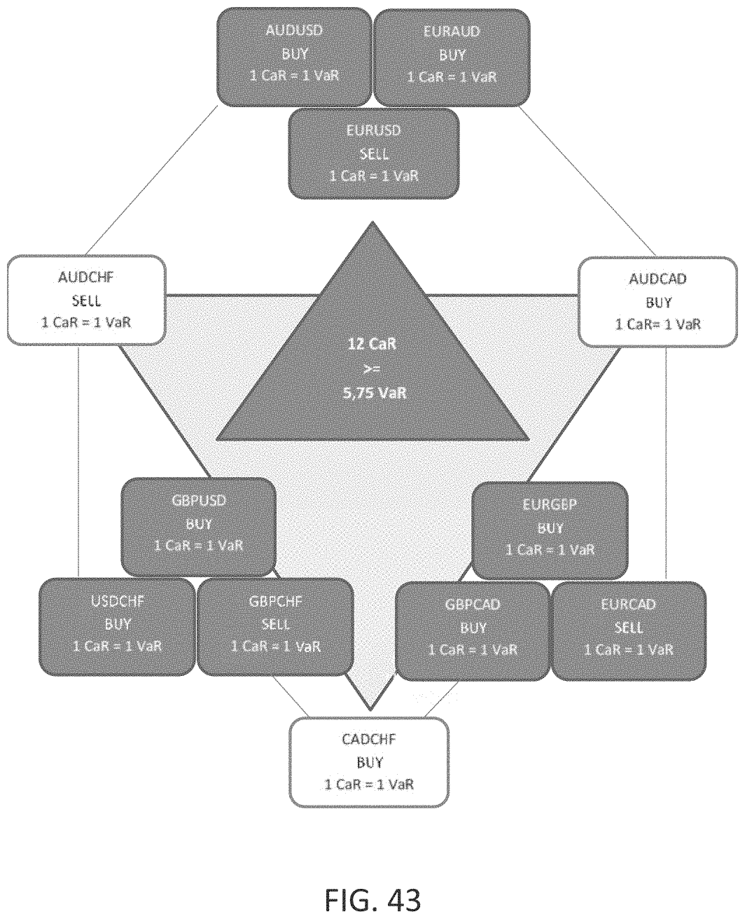

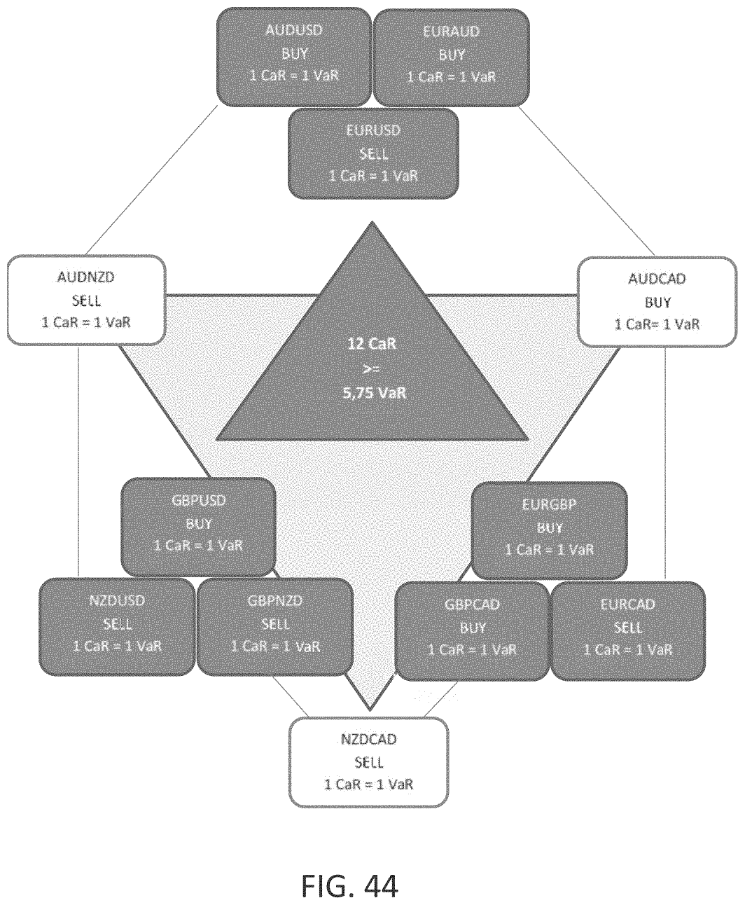

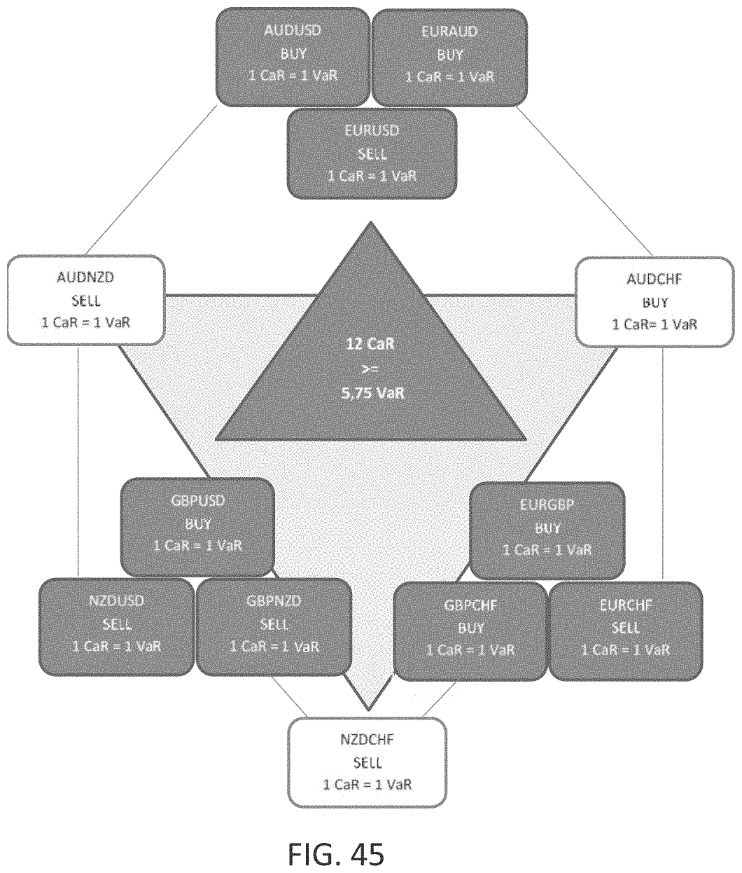

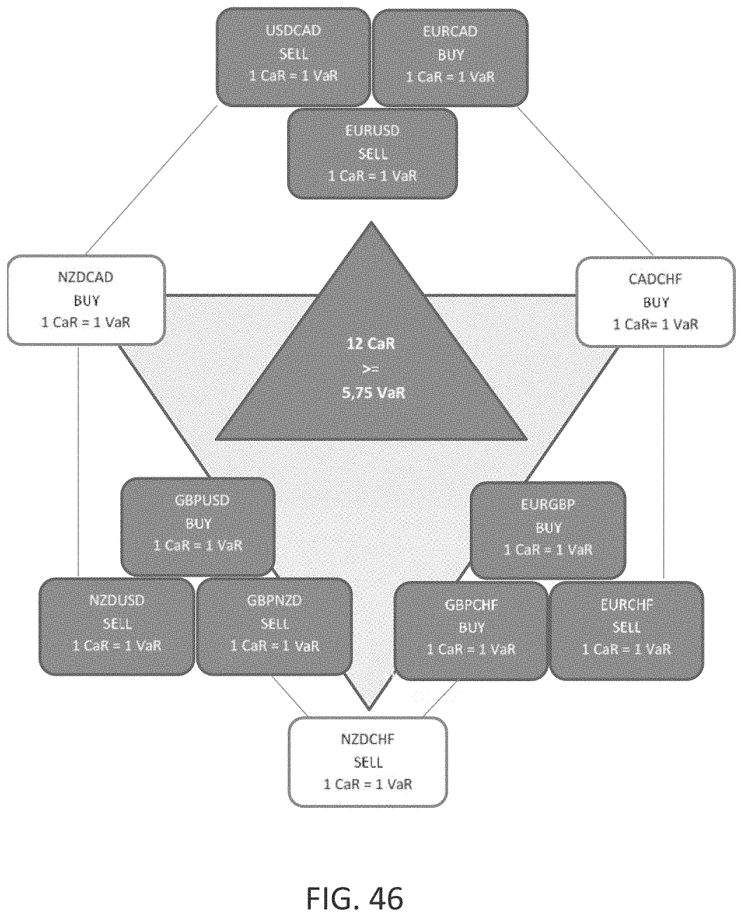

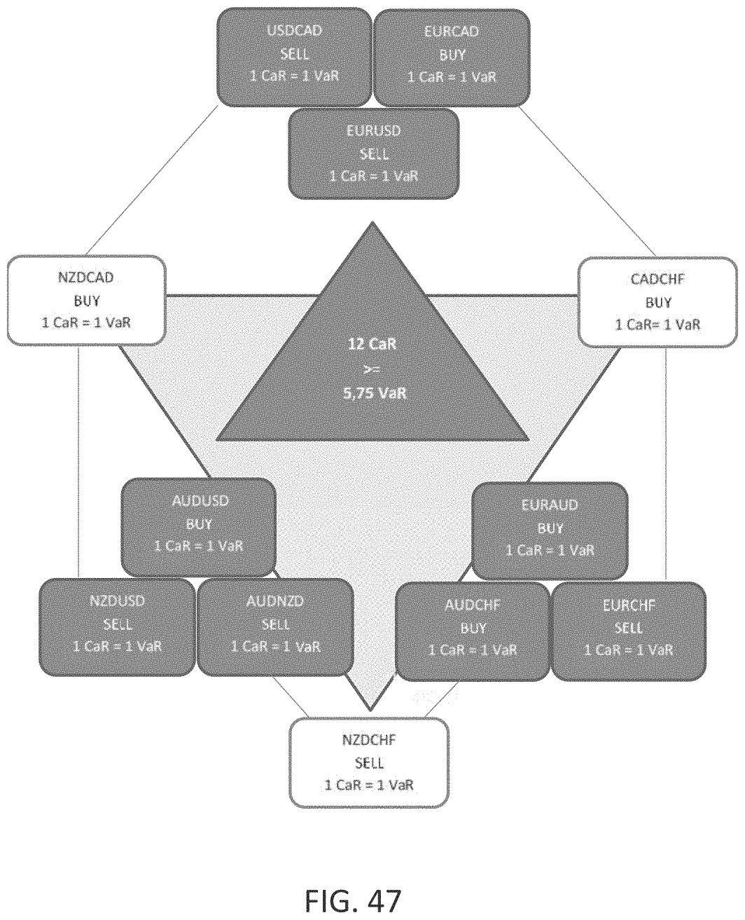

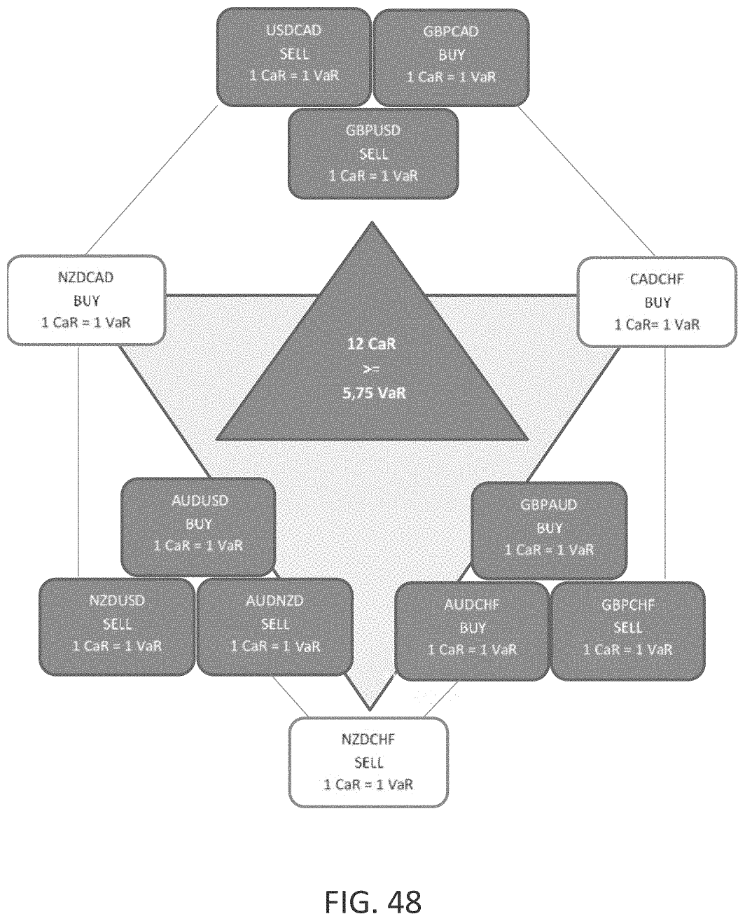

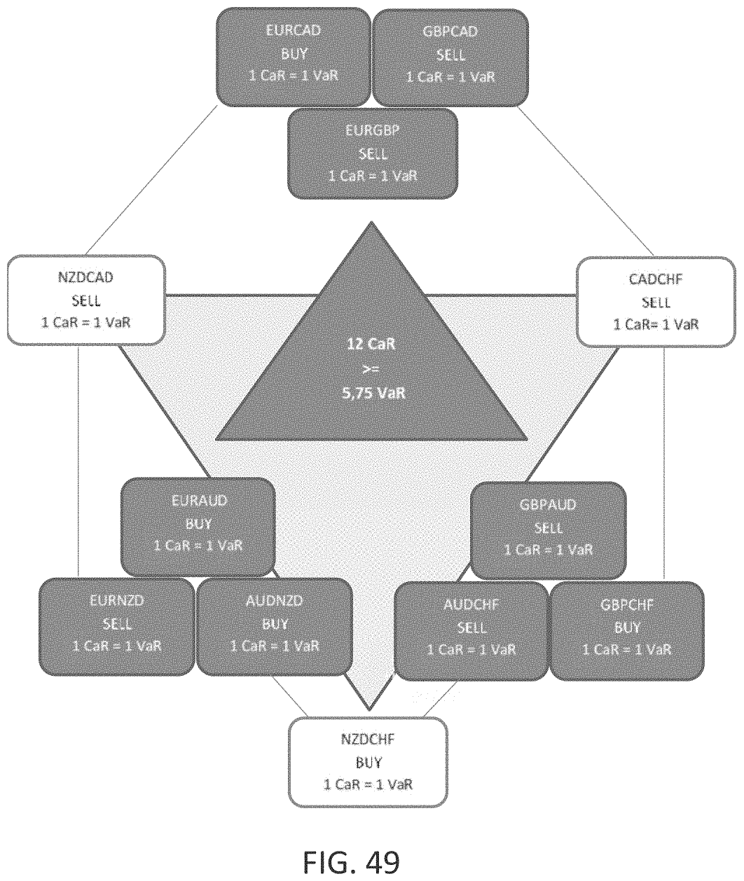

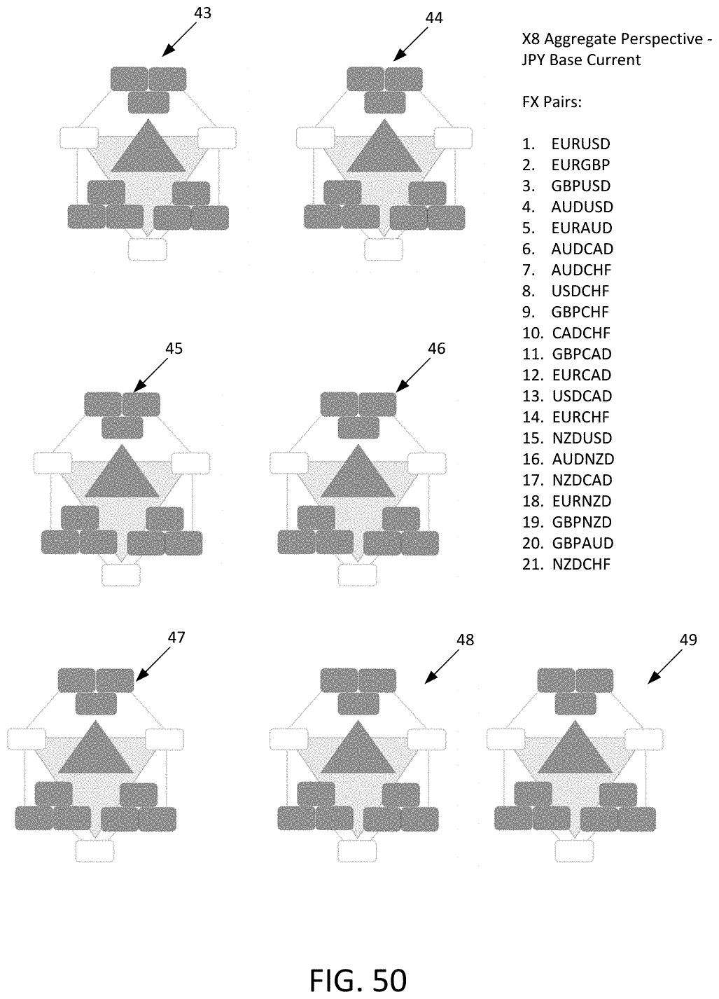

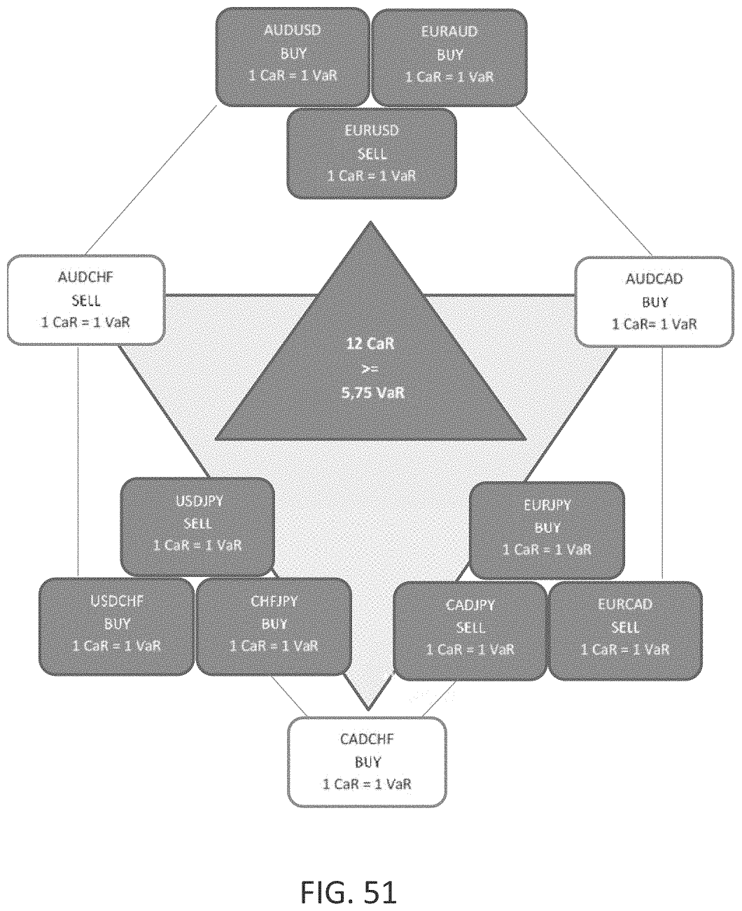

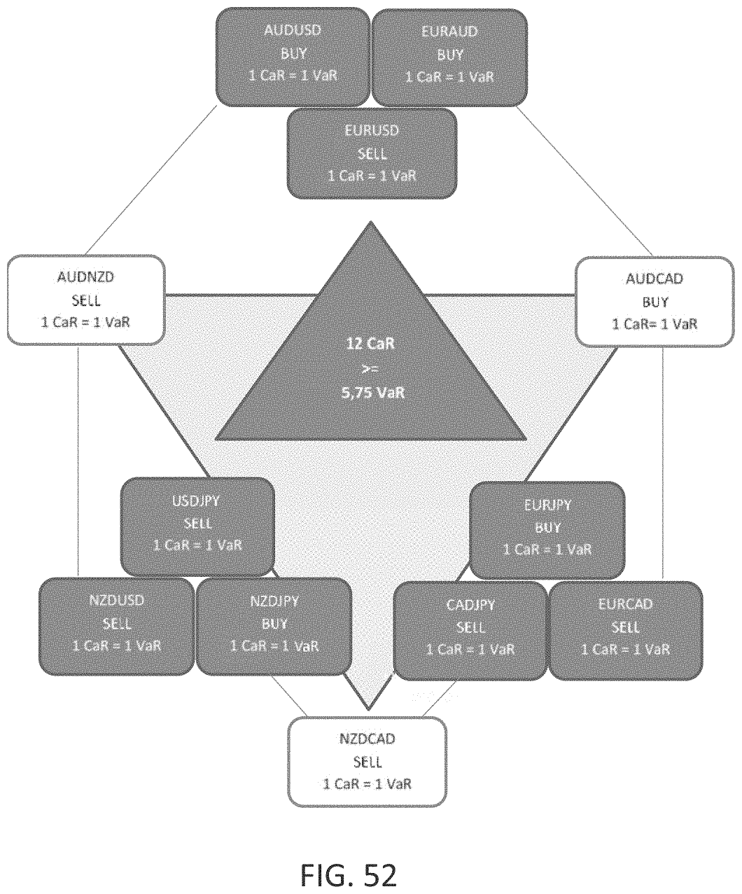

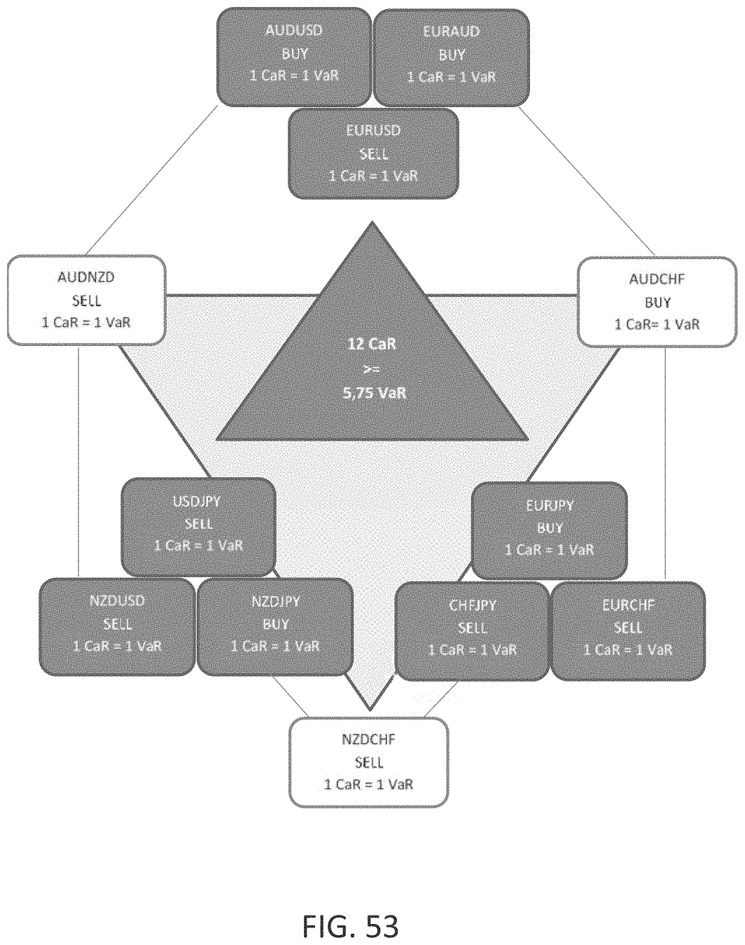

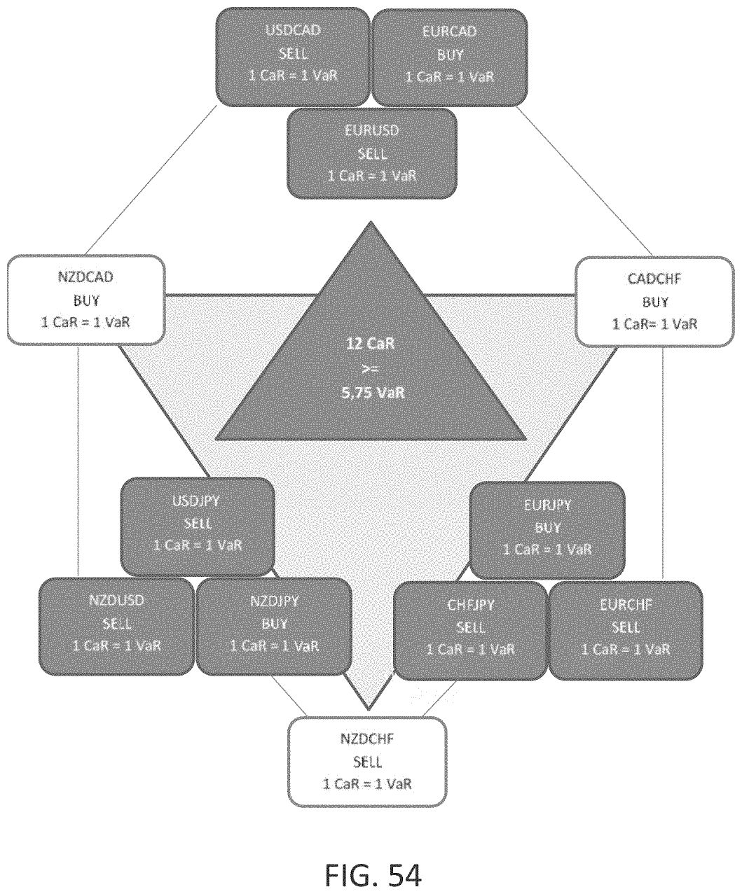

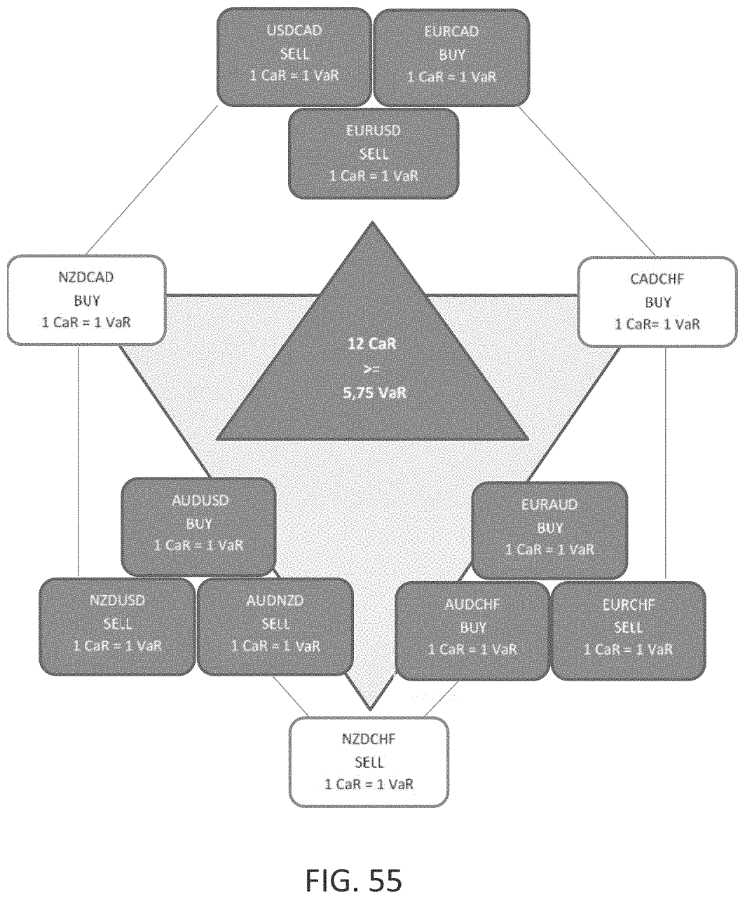

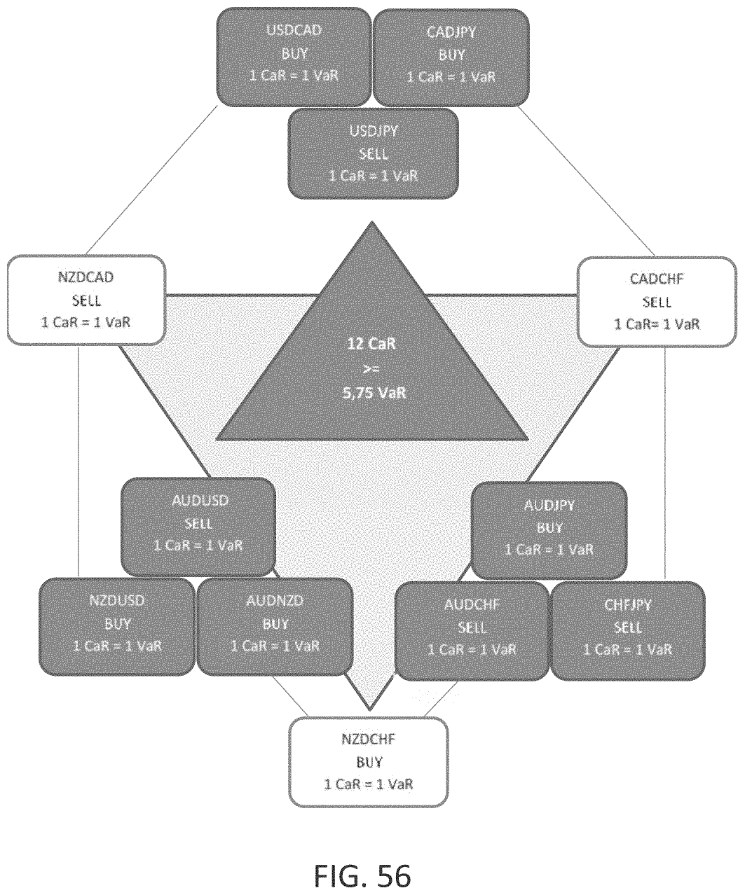

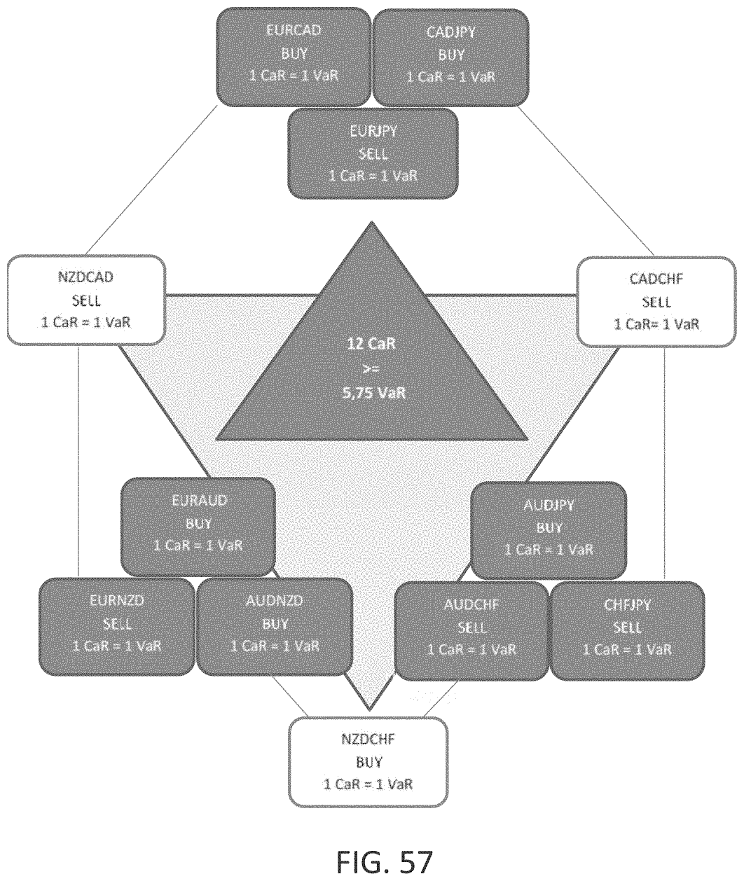

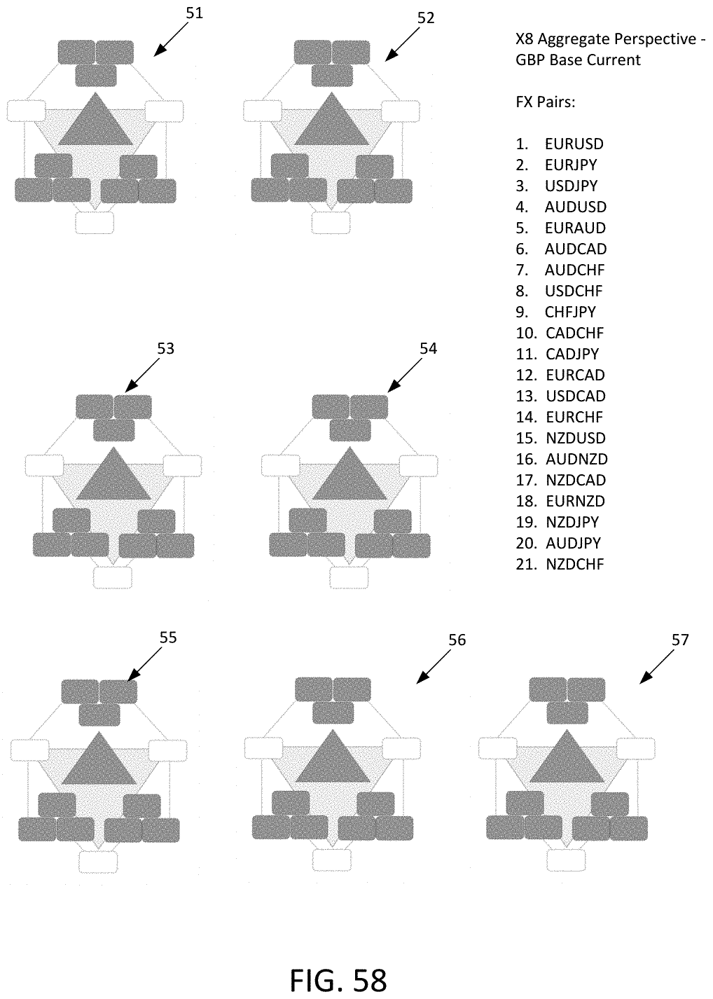

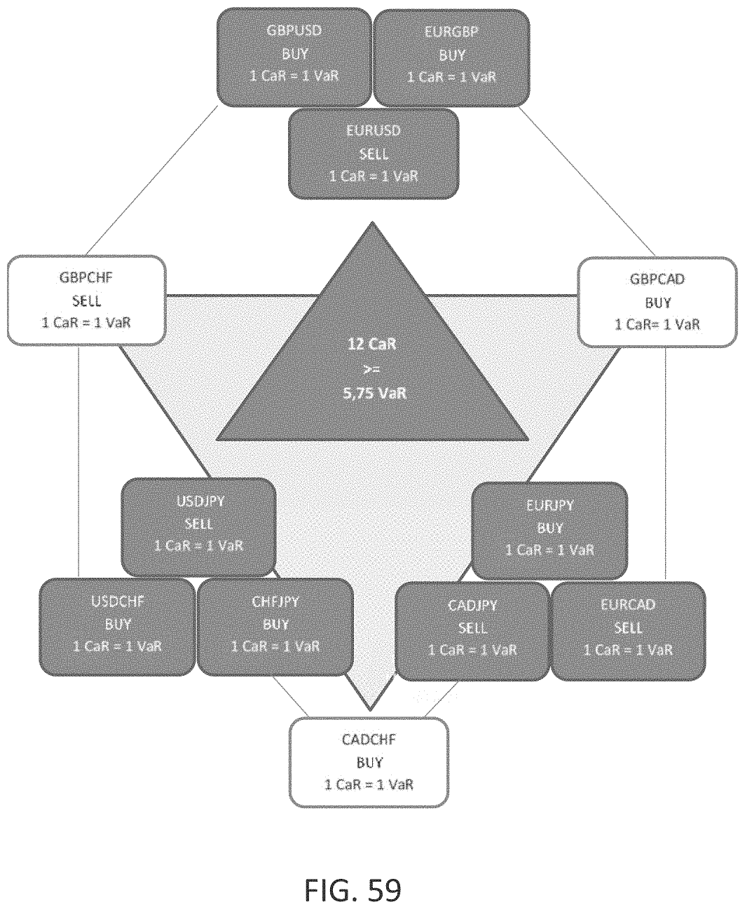

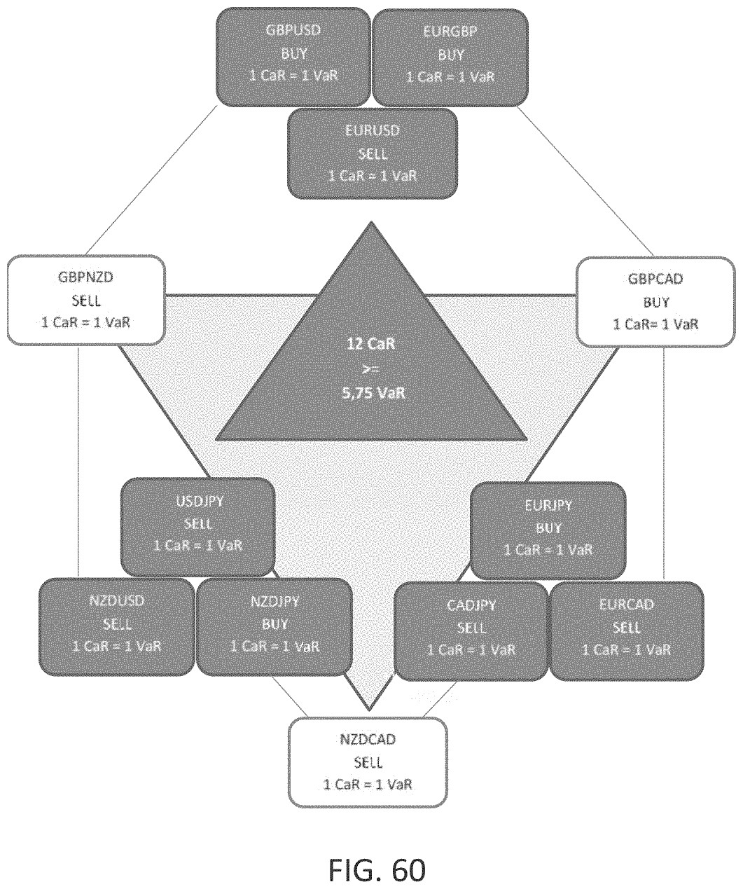

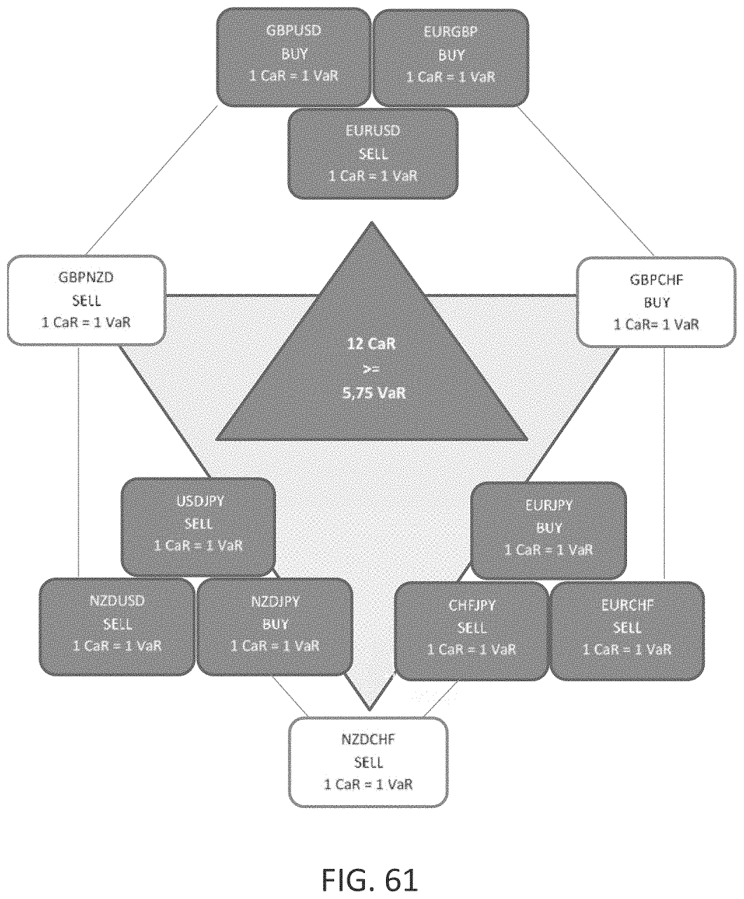

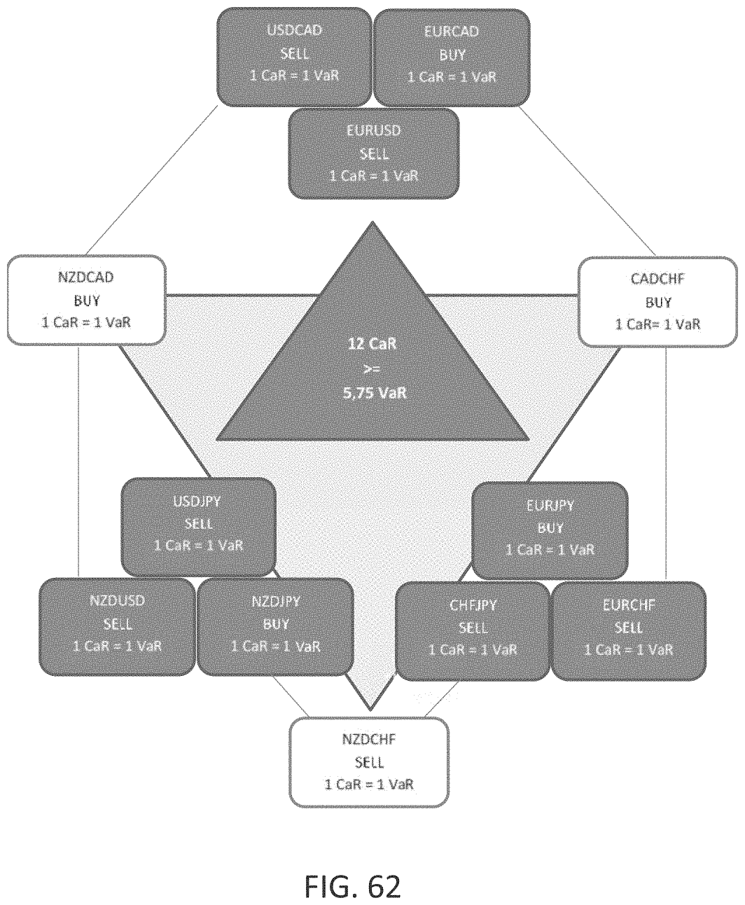

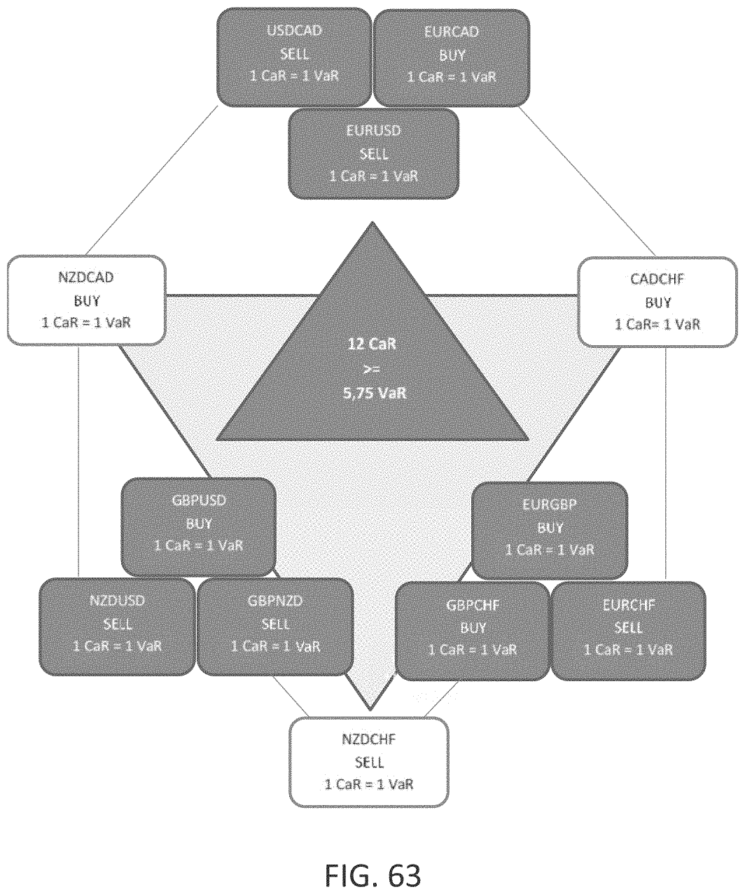

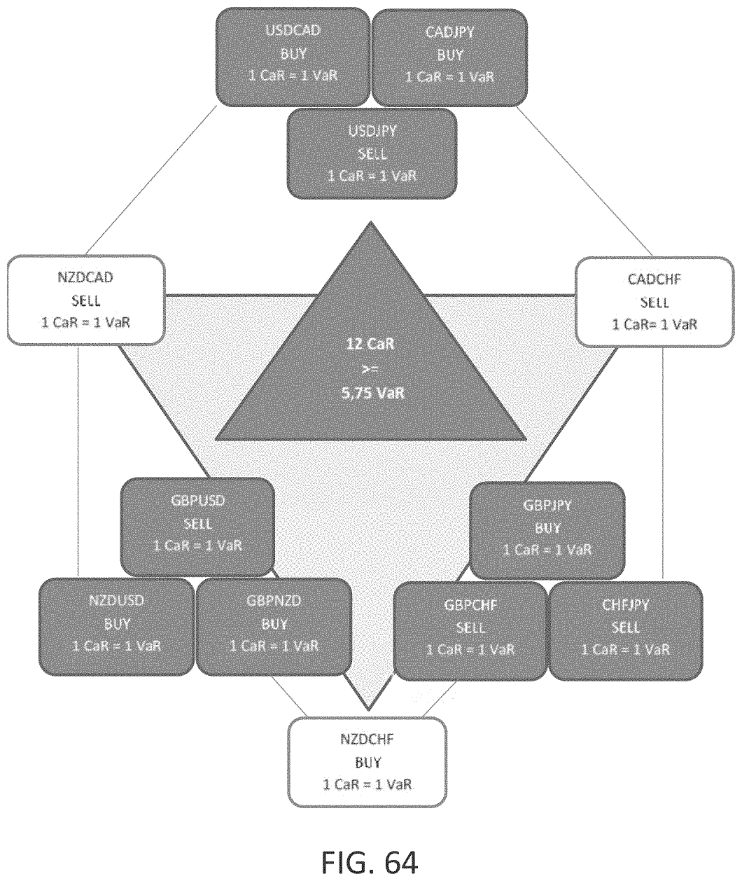

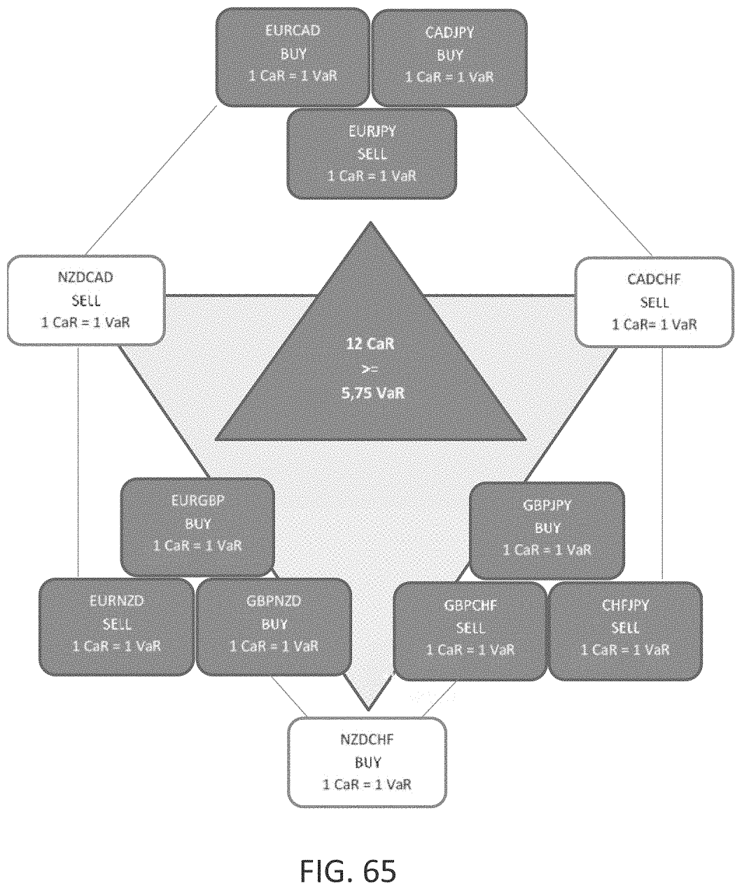

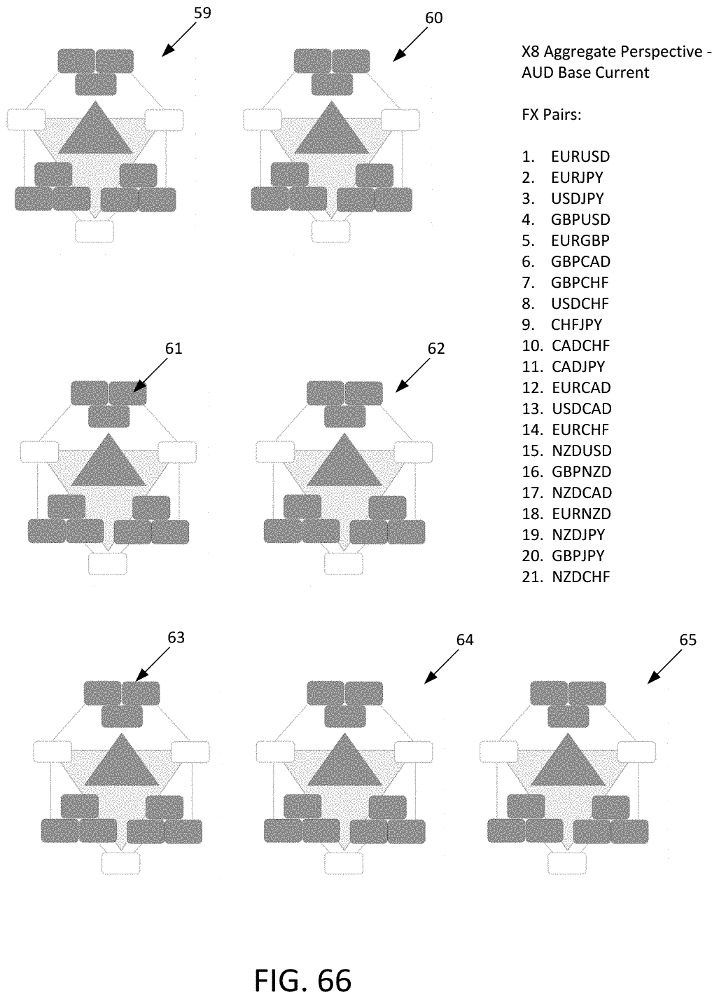

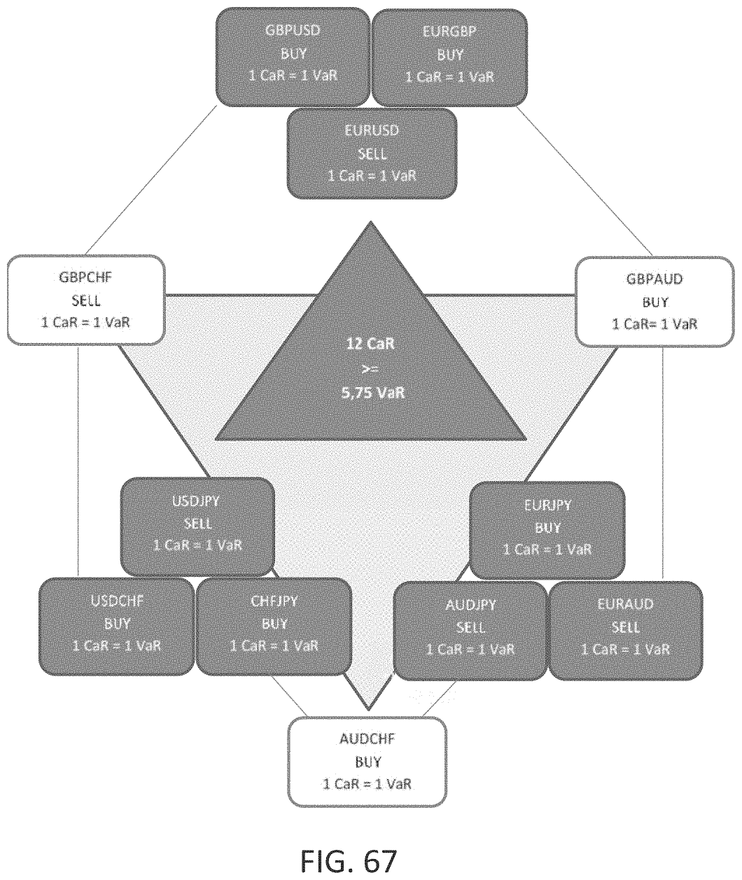

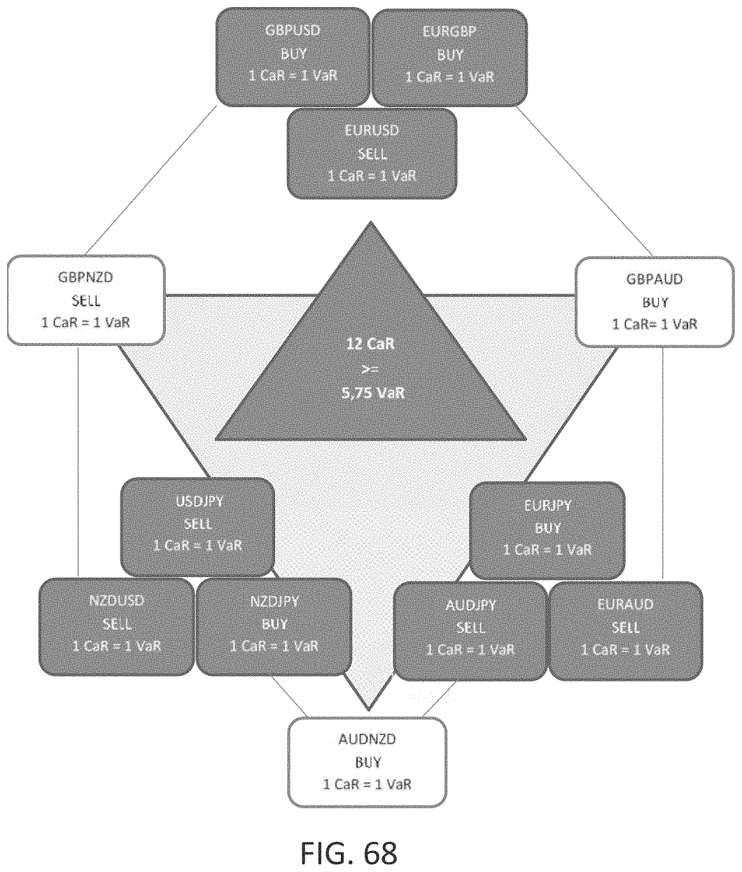

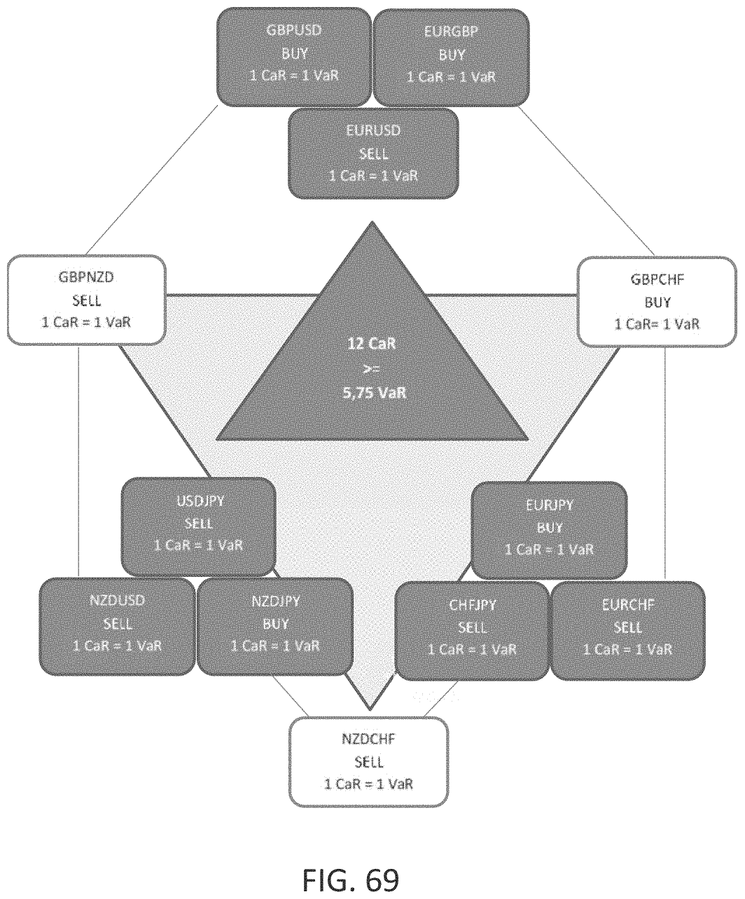

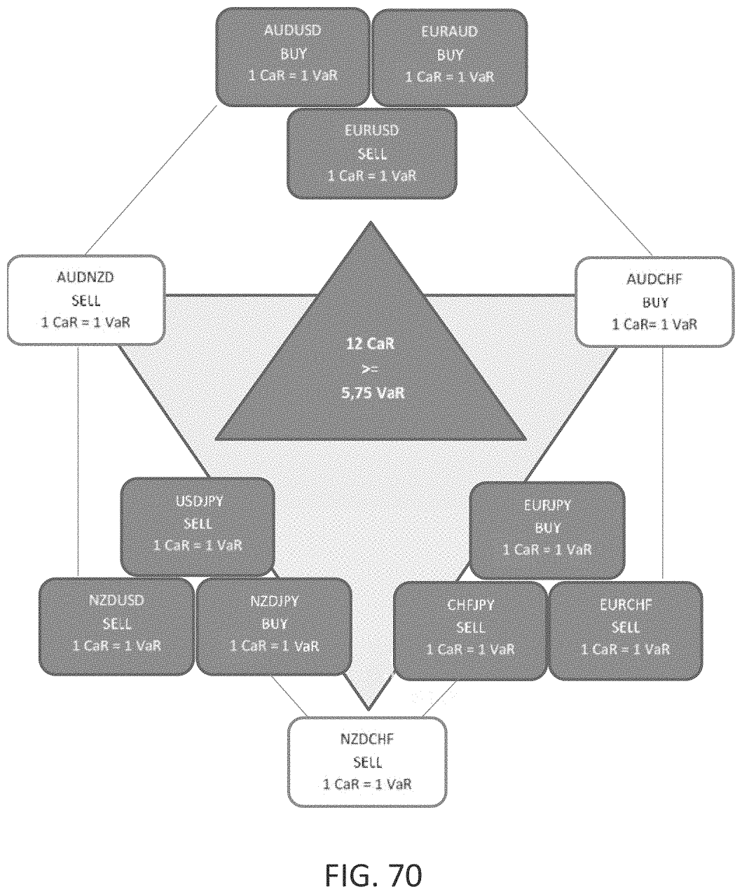

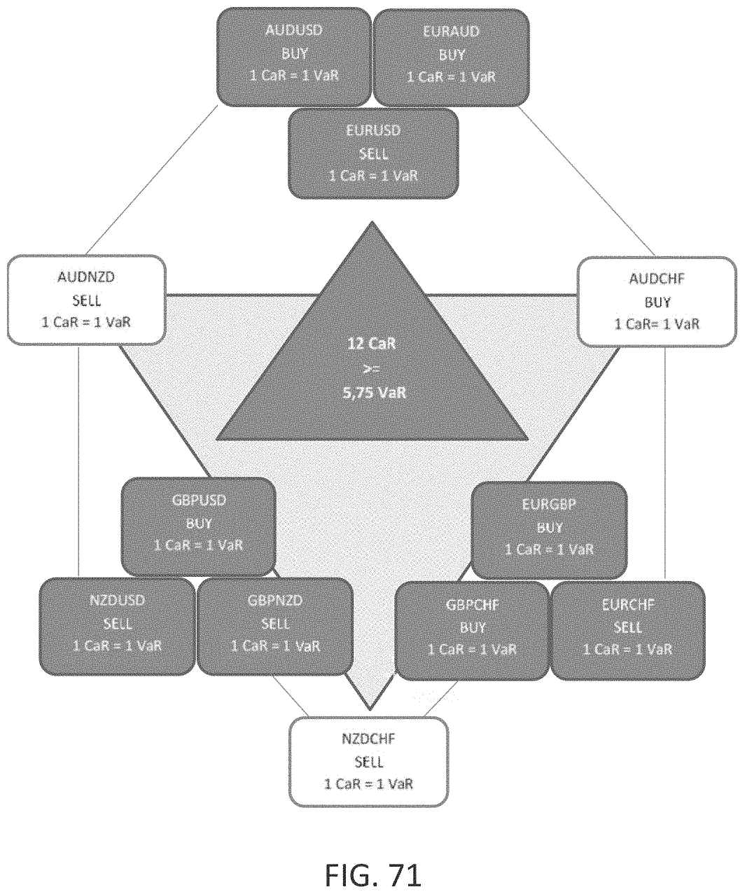

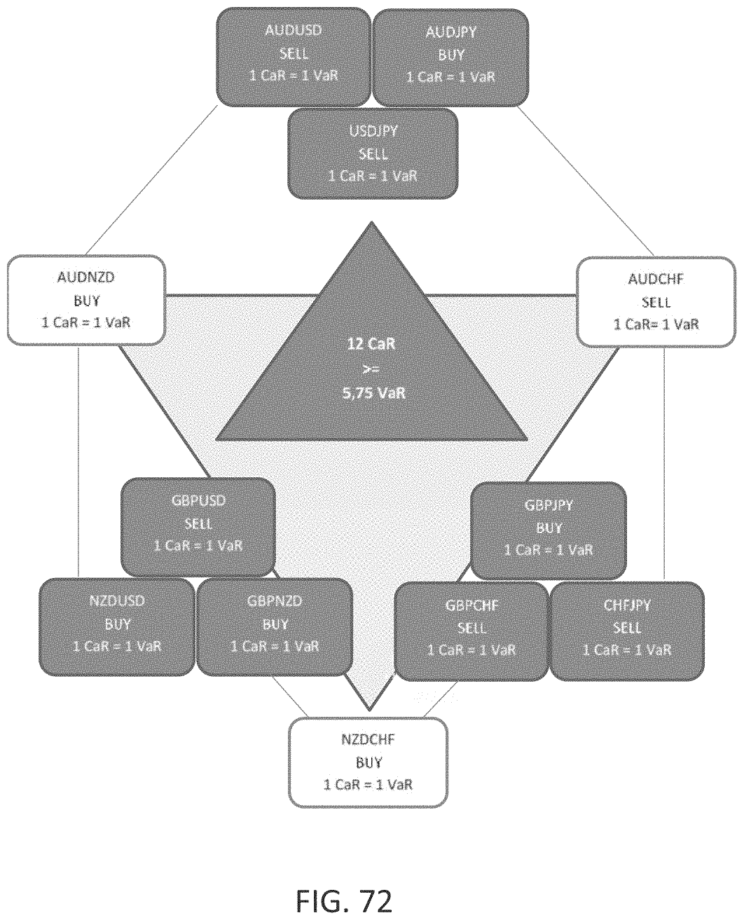

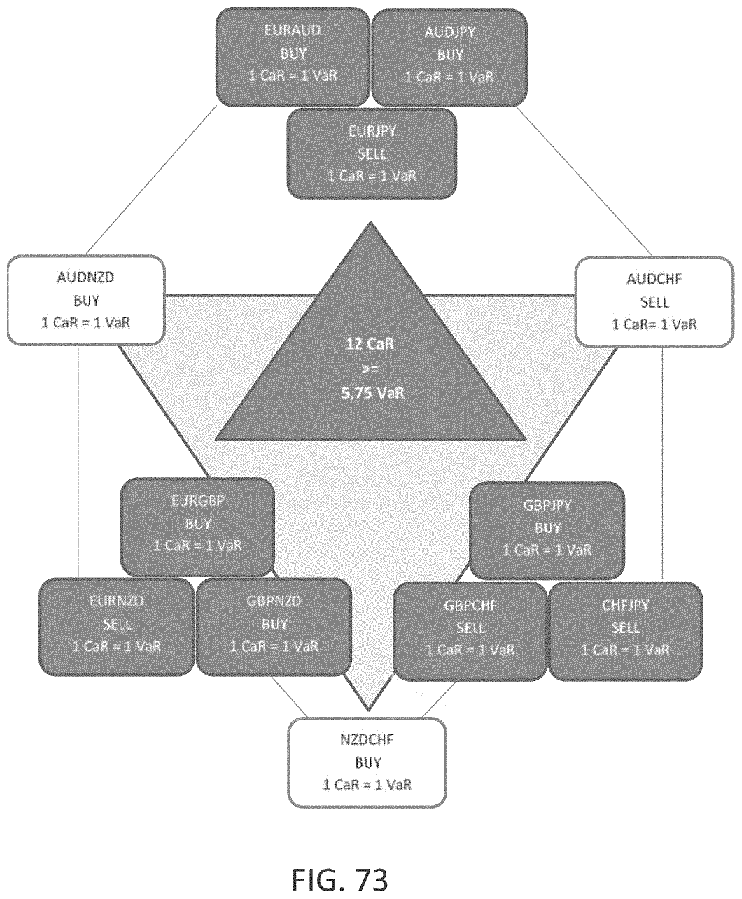

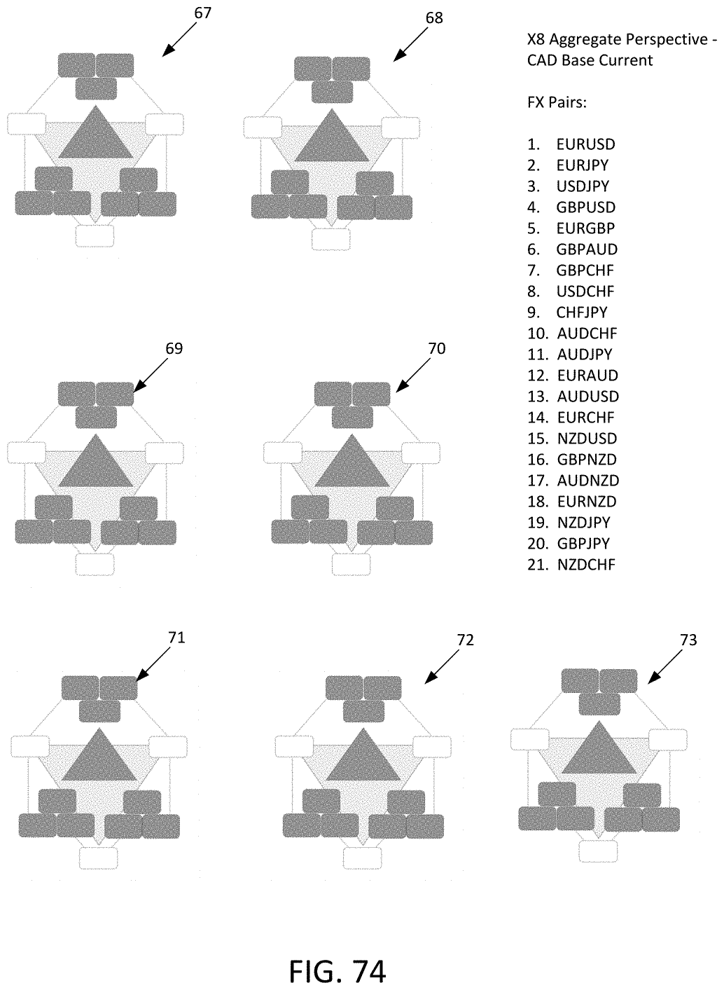

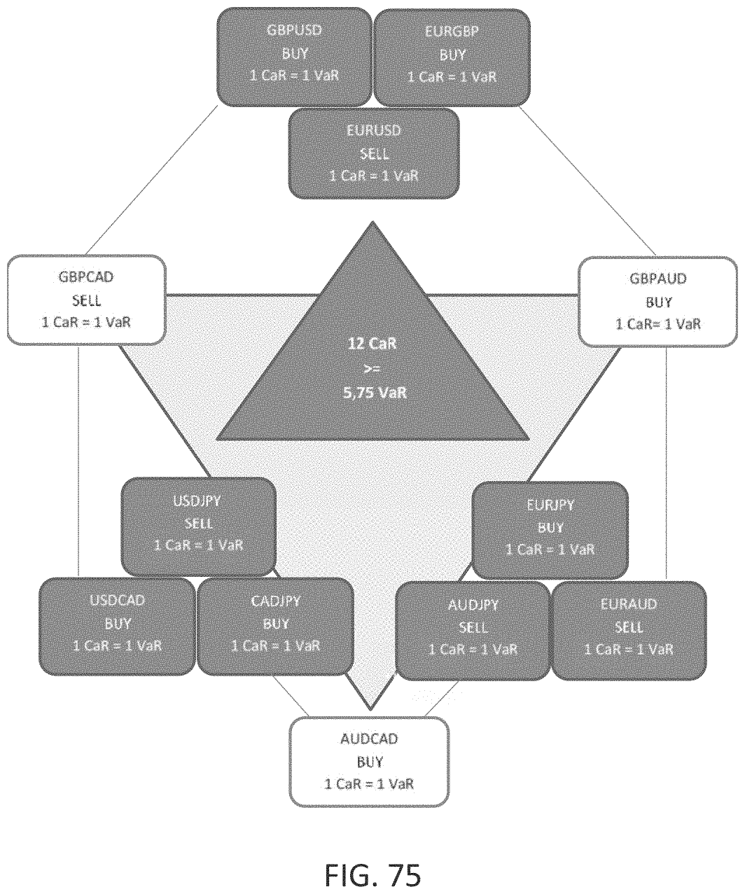

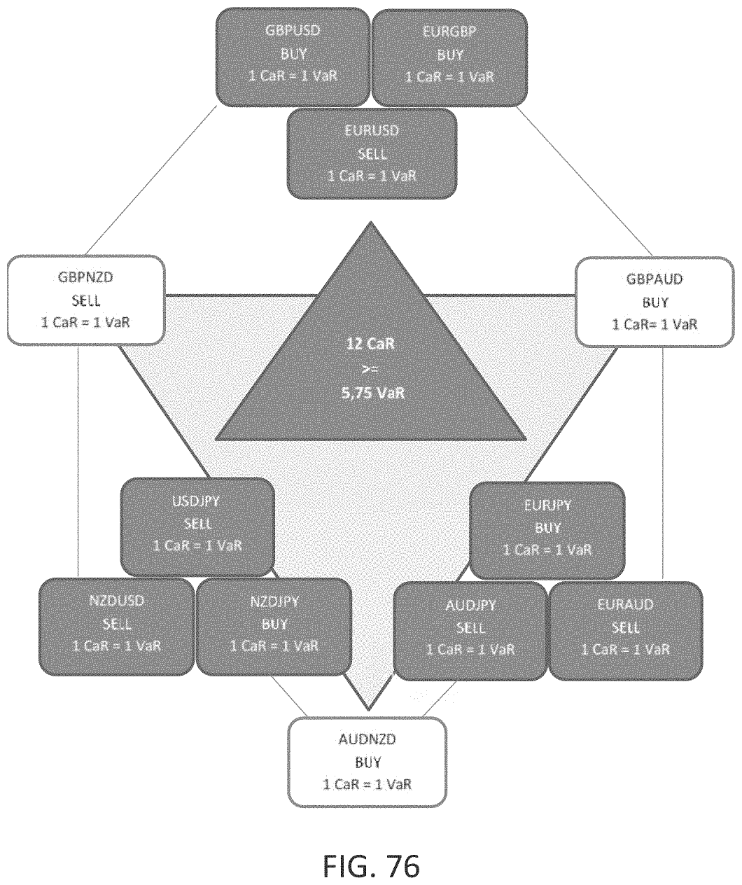

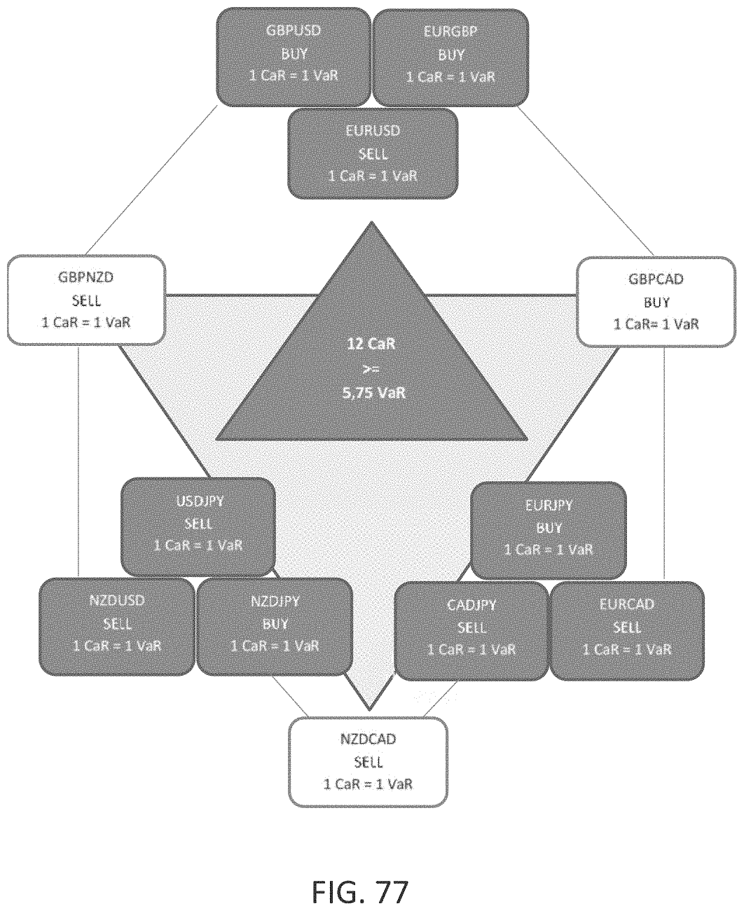

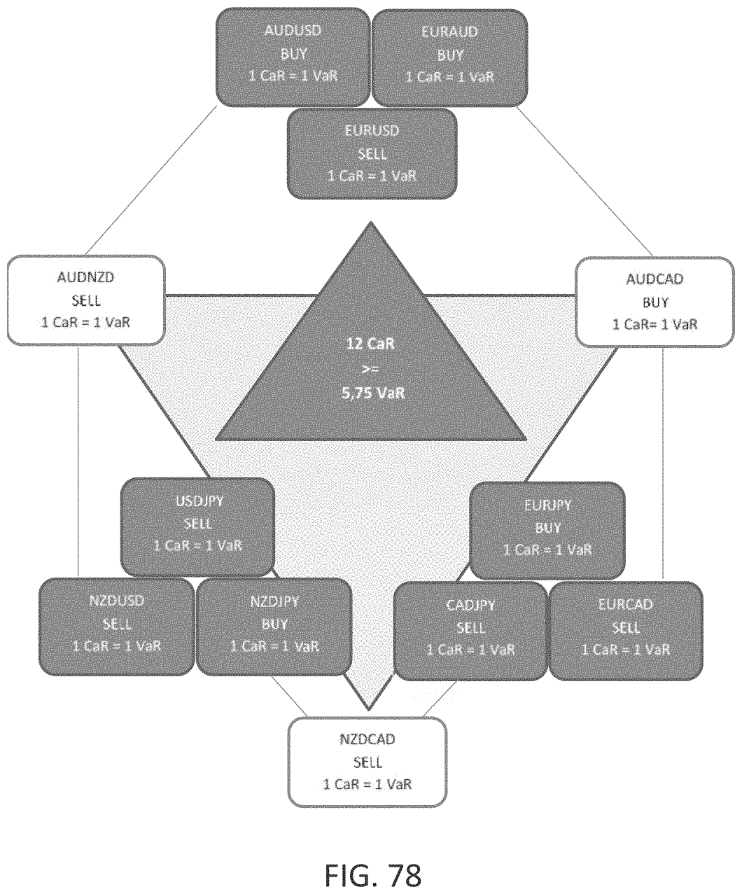

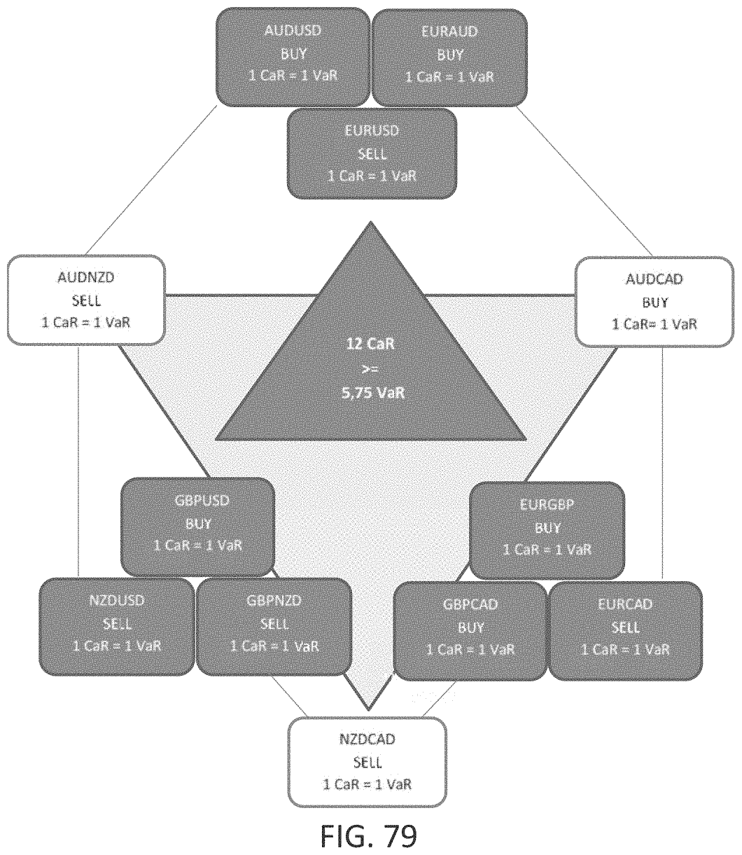

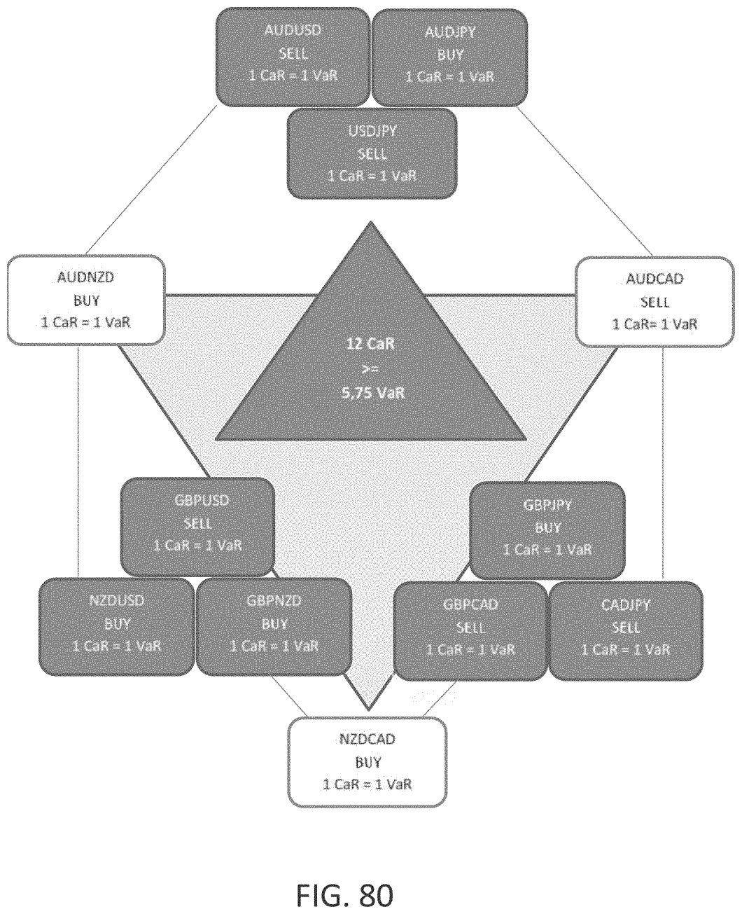

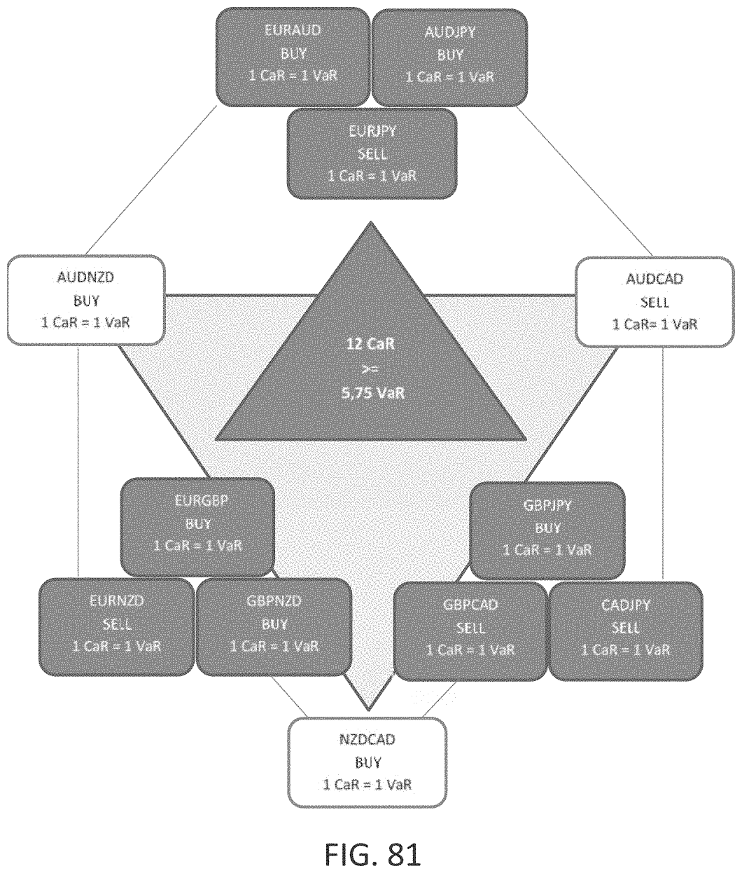

This is shown in FIG. 17.

Radical FX Pairs: EURAUD; GBPJPY; USDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Example: “G” type assembly (G8-8 CCYs: USD, EUR, JPY, GBP, AUD, CAD, CHF, NZD)

1st Horizon G type Perspective by CCY (G8): EUR; USD; JPY; AUD; GBP; CAD; CHF; NZD

This is shown in FIG. 18.

*This G8 Perspective structure of 27 FX pairs is shaped by intra-diagonal EURAUD, USDCAD and GBPJPY hedges for integrally locking structure of 27 for a complete G8 structure assembly. The value of the structure is 27 CaR. HardVaR cannot be approximated for this structure without additional spread risk assumptions outside of VaR/CaR model. NZDCHF is the radical pair in this G8 Perspective.

“G” Type Structures vs. “X” Type Structures

The need for the distinction between “G” type designation and “X” type designation for structures available within the System arose when configurations for various number of currencies showed that 3 currencies are configured differently from 4 currencies and 5 currencies in geometric terms.

Furthermore, configurations with 6 currencies were a more natural progression from configurations with 3 currencies, yet the existence of the “radical FX pair” phenomenon made it obvious that one cannot calculate 6 geometrically just by multiplying 2*3=6.

Even if for 6 currencies the missing parts of the full integrity can be described and explained by the existence of a “radical FX pair” phenomenon, the challenge becomes even greater when attempting to describe a structure of 8 currencies solely by triangles.

The G8 Perspective structure exists; however, it involves two additional assumptions with implications for risk portfolio management. The liquidity risk profile is greatly impacted by the need to be able to give and take liquidity from the market and secondly, due to dependence on this, the spread risk poses an uncontrollable threat to the consistent objective approximations of Price Risk Profile of a portfolio from the point of view of a G type structure.

It is concluded in this document that G type structures and X type structures are similar in many ways, but not identical. Nevertheless, the closest that G and X structures are able to come together is in the example of G3 and X3 structure. One could view these structures as identical, meaning G3=X3, from the geometric point of view and from the point of view of the method of interactive connection between 3 currencies by using 3 Algorithms and 3 Price Risk Profiles respectively.

The relationships between G type and X type structures are further discussed in detail in the following paragraphs and sections where reasons for the need for X type structures are also further explained.

What is a G Structure?

In the System many different multangular structures can be configured.

A Strategy in the System consists of Algorithms of 3 FX pairs assembled in a specific way as exemplified on page 22.

Another way to name such a Strategy would be a G3 system, as it consists of pairs between 3 currencies. Between three currencies there can only be a single triangular structure that describes the relationships between the conversion rates between any such three fiat currencies.

When Strategies, as demonstrated in this document, are assembled for accounting of the range of FX pairs of 6 currencies, such a structure is called a Perspective. This document postulates that a Perspective is assembled and made out of Strategies. A perspective of 6 currencies can also be called a G6 structure or a G6 Perspective, implying that it involves links between 6 currencies.

In a G6 Perspective there are some elements (FX pairs), which are called radical FX pairs. They are called “radical pairs” because they are not bound to any other FX pair in such a structure, at least from objective Pythagorean perspective of risk portfolio management, in which risk adjusted return effect is one of the main aims. These FX pairs are also called radical, because the system does not predict any market exposure on the radical FX pairs simply because the Algorithm position on such pairs could, from the risk portfolio management point of view of the portfolio (Perspective), only be taken on the liquidity-taking side.

Such exclusively liquidity-taking bias in an Algorithmic risk profile would introduce an unknown element to the total portfolio equation. This is because, when an Algorithm would be taking liquidity in the market, the execution price can be subject to uncontrollable slippage on the far end of the market price spread for a particular radical FX pair. If this uncontrollable slippage is the case, then a radical FX pair cannot contribute objectively in a Pythagorean sense to any risk mitigation within the portfolio (G Perspective) without making further risk assumptions.

In a progression of Algorithms being assembled into Strategies and Strategies being assembled into Perspectives, this process can in various ways create an objective description of the market price domain for 3 currencies (G3), or 6 currencies (G6) respectively. Attainment of the geometric positions of G4 and G5 is limited because of a requirement of a radical FX pair to be implemented as a carrier of price risk information, something that was established in the previous paragraph, cannot be objectively attained from a Pythagorean perspective, at least not without making further risk assumptions.

The phenomenon of a radical FX pair cannot be opted out from by the System if the System is set up for a portfolio of 8 currencies and is using only one single Perspective, also called G8 Perspective, for the description of price risk relations between 8 currencies.

In a G8 Perspective the radical FX pairs need to be neutralized by a set of price risk diversification Algorithms, which simply creates a price risk swap, yet with such profile, which it is objectively anchored by a radical FX pair, due to uncontrollable liquidity-taking potential capacity at the far end of the market price spread. A G8 structure is therefore possible, yet from a point of view of VaR/CaR ratio, such a G8 Perspective cannot be assigned a hard VaR variable type. A G8 Perspective in turn cannot produce a hard VaR/CaR ratio and estimates of it can vary uncontrollably.

What is an X Structure?

As postulated, X structures and G structures have many things in common. X structures are essentially made out of a specific assembly of multiple G structures. This in most cases implies that several G structures make an X structure. From this point and in terms of the Perspective, an X structure can be seen as an Aggregate Perspective. Not every bundle of G Perspectives necessarily makes an Aggregate X Perspective though.

The definition of an X Perspective, as per this document, is (X−1)^{th} order of factorial assembly of G Perspectives, where the factorial space domain consists of combinations of (X−1)^{th} order of X number of currencies in each of the individual G Perspectives in the X assembly. These combinations of currencies in the individual G Perspectives, which are making an X Perspective, are fixed in the factorial order by the most volatile currency, which is the currency with the most executive impact on the performance curve of a given individual G Perspective.

The factorial space domain of combinations of (X−1)^{th} order of X number of currencies, which are in the factorial order of the most volatile currency, does not in itself cover the entire probabilistic full combination range of FX currency pairs of all of the consistent G Perspectives, but it is consistent within Pythagorean principle of a Strategy, and it is consistent in terms of how many Strategies can be making up a Perspective.

Which kind of Strategies are in an order of the factorial space, which is consistent with a G Perspective, cannot be described by a single consistent order of the factorial space with the population of G Perspective in that order of the factorial space. One order of the factorial space inhabits only a part of the total factorial space.

In simple terms, a factorial of 8 currencies, which for Aggregate X Perspective starts with an order of (X−1)=7, cannot be only described with 7 sets of Perspectives or Strategy Packs. 7* and what then? A factorial calculation should continue like 7*6 and go toward 1, but for this we already need 42 Perspectives or Strategy Packs, while this would not even be enough to go through half of the entire Factorial Space of the G Perspectives. The total number of all Perspectives as Strategy Packs of G structures amounts to multiple times of the first order of the factorial space of such possible states of combinations of Strategy Packs or Perspectives. This represents a challenge and a dilemma in terms of required capacity to make the factorial geometric calculation for X number of currencies.

ARM AI's Solution to Factorial Space Capacity Dilemma

ARM AI solves this dilemma by adding an extension to the basic factorial range capacity through integration of an associative factor, which is a fractal of the number of combinations of Strategy Packs in a factorial space.

In simple terms, 7 portfolios, each consisting 1 (one) G Perspective, which itself (one G Perspective) is a Pack of Strategies=1 Strategy Pack, can together (7 G Perspectives) account for a part of the factorial space, and can account for the largest optimal space (not the absolute largest space) in informational terms, if they (7 portfolios or 7 G Perspectives) are factored by 2 (two) separate orders of the (The) entire probabilistic combination range of FX currency pairs that can make the consistent G Perspectives.

The two orders are:

The order of the first route, which is the (X−1)^{th} order, or 7^{th} factorial assembly of G Perspectives.

The first factorial order of the first route of the factorial assembly of G Perspectives, which is the ((X−1)^{th}−1)^{th} or the 6^{th} order of the factorial space void of the route currency member.

As stated, and described, in the environment of 8 currencies, this order of the first route of factorial assembly of 7 G Perspectives only partially accounts for the entire factorial space of G Perspectives or Strategy Packs, where Risk Portfolio Management principles can be applied as Algorithms and Strategies, which combine into one Perspective integrally or in an integral way.

1 Perspective is 1 Perspective, but a Perspective can be described differently and still have the same effect from a Risk Portfolio Management point of view. Two different Perspectives are two different Strategy Packs. Nevertheless, from the point of view of the cumulative risk profile of the entire single Strategy Pack, two different Strategy Packs can yield the same cumulative risk profile compared to each other, but not always.

Just adding Strategy Packs, or just adding all of them (all possible Strategy Packs within the factorial space of 8 currencies), does not necessarily add that much more information as one would expect from the simple linear point of view as there is a great deal of overlapping of the price risk profiles between the Strategy Packs.

Axioms and Assumptions in a Set of 8 Currencies

In a general view, out of 8 currencies, one is going to move, at least, and one shall so be moving the most at any point, generally speaking.

It is unknown which currency is going to move or which currency is going to move the most. The only probability which exists is that it is going to be one of the 8 currencies.

From the point of view of a definite currency, which is a particular currency out of 8 currencies, there is a similar probability or chance, that such a particular currency may be moving the most or moving the least. This view is a probabilistic one. Each currency cannot move the most and also simultaneously move the least out of all 8 currencies, unless the market of all of the 8 currencies inhabits one of the market's pole functions.

The choice between the biggest most active currency and the least active currency is not a certainty. Any currency could be ranking first or last, but also any currency could be ranking anywhere in between the first and the last slot, when observed from the point of view of the biggest market mover element, probabilistically speaking.

Further to this, if a particular currency is not the biggest market mover, then probabilistically it is possible to assign a probability to the scenario that this particular currency is somewhere in the remaining part of the possibility spectrum between the second biggest mover and the least active or least moving currency by market price.

The paradox of the choice leads to the conclusion that it is increasingly less important if a particular currency is moving the least. In simple terms, from the calculation of probabilities point of view, it does not make that much difference if a particular currency is in the last or before the last rank by largest market movers after it has been established that it is not the biggest market mover.

On the other hand, the probability, which describes the ranks from biggest to smallest movers of all of the currencies best, is the probability of a particular currency being the second biggest mover, and if it is not, then it could be the least moving currency. This approach produces a higher significant probability value, than contemplating whether a particular currency might be 3^{rd} or 4^{th} or 5^{th} in the rankings of 8 currencies by biggest price moves. This is true, because of the existence of the overlapping of the price risk profiles of all possible Strategy Packs within the factorial space of 8 currencies, where the document has mentioned that certain pairs of two different Strategy Packs may produce the same cumulative informational value or reading of the aggregate price risk profile.

The important dilemma from the risk portfolio management point of view is that if a particular currency is not ranking first, then it could be ranking last. However, if it is not ranking second, then it could be ranking anywhere on the spectrum with an increasing chance that the lack of the ability to determine the exact rank of the currency will have less impact on the risk equations than the correct identification of the second ranking currency by biggest market movers, all the while it is assumed that there is the least moving currency, which exists from the perspective of the biggest mover. Second biggest mover still influences the risks of portfolio fluctuations more and to a greater extent than other lesser movers.

How Well do 7 G Perspectives Describe an X Perspective?

In summarized explanation, each Strategy Pack, representing 1 G Perspective, can include two complementary Units of information, which are factors, where alternatively and in an alternating manner someone looks at the portfolio of Algorithms, Strategies and the Perspective from the point of view of the most volatile currency, and the same person looks at the same time and at the same set of Algorithms, Strategies and the Perspective from the point of view of the least volatile currency.

It is a building block of the axiom in fractal space combinatorics that out of X currencies one currency is moving the most. The axiom does not hold true if no movement is involved, yet without any movement the Market Price Spread as Minimum System Step Threshold Variable in the ARM AI System does not change, and without movement of the spread and no change in the input to the System it is hence concluded that there is no change in the System reaction, at least not in the fractal sense.

A specific G Perspective, which uses a cross-section of the factorial space from the point of view of the most volatile currency and simultaneous point of view of the least volatile currency, is an element of assembly of one X perspective, by which 1+1+1+1+1+1+1=7 G type Perspectives are added to begin forming an Aggregate X Perspective, which evaluates Risk Portfolio Management properties of one currency in relation to other currencies. If such G Perspectives with probabilistic value of 1 G Perspective x (times) 7=7 G Perspectives are sequenced in a probabilistic order of cross-section by 2 (two) factorial orders by most and least volatile currency respectively, they will amount into an X Perspective, and would complete the result of the mathematical function of addition of 7 ones (1) equals 7 geometrically.

A G Perspective with radical FX pairs exists definitely. Any G Perspective is a definite Perspective. An X Perspective exists within the probability of one of the currencies moving faster than others in terms of the Market Price Spread changes. If the total market of 8 currencies inhabits one of the market's pole functions, then the 7 G Perspectives only describe a fraction of all the possible scenarios.

However, in the context of the most and the least volatile currency, the consistent sum of 7 G Perspective makes an Aggregate X Perspective in the ARM AI System.

Aggregate X Perspective by Base Currency

Several different Aggregate Perspectives exist in the entire factorial space of 8 different fully convertible currencies. Main root Aggregate Perspectives are the Perspectives assembled from the point of view of each Base Currency.

When aiming for stability, which is denominated in each of the individual currencies, while accounting for the possibilities that any other currency might be ranking in different places when observed from a volatility point of view, the result of the Aggregate X Perspective should be independent of the movement or the volatility of the Base Currency itself.

An Aggregate X Perspective in the System is constructed from the point of view that a user of an individual currency backed stable coin wouldn't select avoiding the currency price risk of the individual currency. If a hypothetical user would choose a US Dollar backed stable coin, then it is pre-assumed that the volatility of the conversion rate of the US Dollar versus other currencies is not the fixed consideration of such a user.

In practical terms, if the US Dollar depreciates by 30% or appreciates by 30% compared to other currencies, the user of the US Dollar backed stable coin (individual currency backed stable coin) still wishes to keep the exposure to the US Dollar as his main preference despite, and regardless of, the volatility in the US Dollar. In this case and generally speaking, such a user would want to undertake the risks of the US Dollar's volatility and decide himself or herself about when to take such risk, for how long and in what amounts.

The concept of the Aggregate X Perspective in the System therefore aims for the construction of the Aggregate X Perspective to be Base Currency agnostic and offers several possibilities or choices of different Base Currencies to be selected from point of view of the user of a single currency backed stable coin.

Example: “X” type assembly (8 CCYs: USD, EUR, JPY, GBP, AUD, CAD, CHF, NZD)

1^{st} Horizon Aggregate X8 USD Base Currency Perspective

X=8 Factorial Rules: In an Aggregate Perspective (of any currency) the Base currency of the Aggregate Perspective is always omitted in each of the individual Perspectives. In addition to the Base currency of the Aggregate Perspective of the particular currency, which is omitted by default in any G Perspective, also one (1) probable most volatile currency is omitted—shown below in ( ). For each G Perspective there are 2 omitted currencies, which are not involved in the assembly of a G Perspective. In the case of X8 structure this means that these rules apply to 7 G6 Perspectives.

1^{st} G6 Perspective, CCY's: USD—Base, omitted, EUR, JPY, GBP, AUD, CAD, CHF, (NZD).

2^{nd} G6 Perspective, CCY's: USD—Base, omitted, EUR, JPY, GBP, AUD, CAD, (CHF), NZD.

3^{rd} G6 Perspective, CCY's: USD—Base, omitted, EUR, JPY, GBP, AUD, (CAD), CHF, NZD.

4^{th} G6 Perspective, CCY's: USD—Base, omitted, EUR, JPY, GBP, (AUD), CAD, CHF, NZD.

5^{th} G6 Perspective, CCY's: USD—Base, omitted, EUR, JPY, (GBP), AUD, CAD, CHF, NZD.

6^{th} G6 Perspective, CCY's: USD—Base, omitted, EUR, (JPY), GBP, AUD, CAD, CHF, NZD.

7^{th} G6 Perspective, CCY's: USD—Base, omitted, (EUR), JPY, GBP, AUD, CAD, CHF, NZD.

1^{st} Horizon 1^{st} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 19.

Radical FX Pairs: EURCAD; CHFJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 20.

Radical FX Pairs: EURJPY; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 21.

Radical FX Pairs: GBPNZD; EURAUD; CHFJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 22.

Radical FX Pairs: CADJPY; GBPCHF; EURNZD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 23.

Radical FX Pairs: EURCHF; NZDJPY; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in P^{t} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 24.

Radical FX Pairs: AUDNZD; EURCAD; GBPCHF

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for USD Base Currency: EURUSD; USDJPY; EURJPY; GBPUSD; EURGBP; GBPJPY; EURCAD; CADJPY; AUDJPY; AUDUSD; GBPCAD; GBPAUD

This is shown in FIG. 25.

Radical FX Pairs: AUDCHF; GBPCAD; NZDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 USD Base Currency Aggregate Perspective:

This is shown in FIG. 26.

*This structure of 7×12=84 FX Pair Algorithms does not have any radical FX pairs and is factorially bringing individual 12 FX Pair 12 CaR (5,75 VaR) G structures (with a 48% HardVaR/CaR ratio) into an interlocking 21 FX Pair Aggregate Perspective X structure—called an X8 Base Currency Aggregate Perspective structure with a Base Currency of USD.

Why is Aggregate Perspective still a Perspective?

The Aggregate Perspective, despite being a composite, is still a Perspective, because it looks from the point of view of the base currency. The base currency is always omitted in the open position FX currency pair exposures for a G or for an X Perspective, which are both Perspectives. Superficially put, Aggregate X8 Base Currency Perspective=7 times G6 Perspective.

Therefore, if or when a base currency is the most volatile currency of 8 currencies, then the Price Risk Field of any such G6 (Base Currency) Perspective gravitates toward 0 with the highest probability compared to any other non-Base Currency Aggregate X Perspectives and is—its Price Risk Field—an incremental order less than that of a Full Price Risk Field, where the most volatile currency would be included, and would in that case not be omitted.

Because the most volatile currency of the Aggregate X Perspective structure is omitted with probability=100%/7 Perspectives=14,285% per Perspective (G6 Perspective by Base Currency), there is 1 in 7 chance that a particular Perspective will submit to the Price Risk Field, which is relatively smaller because of the lack of the most volatile instrument in FX market exposures of such Perspective.

When compounding 7 Perspectives under a particular Strategy Pack regime dedicated for each Perspective consistent with the (X−1)^{th} order of Base Currency Aggregate Perspective, and segregated between each other (segregated between the G6 Perspectives themselves) with mathematical principle of addition, the total sum of probability=100%/7 Perspectives=14,285% per Aggregate Perspective is achieved in real domain, and can be as such described with mathematical rationalities and mathematical irrationalities.

This only holds true, because in the factorial space of viewpoints from most and least volatile currency simultaneously by a cross-section of the factorial orders by most and least volatile currency, both probabilities are accounted for in the Strategy Pack, which itself is defined by objective Pythagorean principles.

How Does the Mechanism for Stabilization Benefit From This?

The mechanism for stabilization is a part of ARM AI. The AI is seeking to find possibilities of risk mitigation and target achievement. The basic principle in the context of an AI, is garbage in garbage out, but also quality in quality out. A coherent Pythagorean structure being the input allows the AI to see pathways to the target destination through 2 Price Risk Field lenses simultaneously. One being nominal exposure reading within the Price Risk Field by Perspective segregated from other Perspectives, and the other being the Aggregate Perspective Price Risk Field assembled from the X Factorial order structure of 7*G6 Base Currency Perspective structures. The Aggregate X8 Perspective is also therefore the X8 Aggregate Perspective by mathematical association.

Pointedly, X8 Aggregate Perspective equals 7*G6 Base Currency Perspective's Net Cumulative Differential, where Net Cumulative Differential is a measurement—Price Risk Field reading—for the FX currency pairs active market exposure within the Aggregate X8 Perspective at any given time.

Risk Mitigation Effect Within the Aggregate X Perspective

This contributes to the mitigation of risk, of which 14,285% is mitigated by a mechanism of specific allocation of FX pairs nominal open market position exposure, where the liquidity downside risk profile is on the liquidity-providing side. This means that in lack of market absorption capability for liquidity, downside risk manifests, which a contrasting difference compared to the G8 Perspective structure type, where liquidity-taking ability is the risk of the G8 Perspective or a Strategy Pack of it.

The Perspectives, G8 Perspective and X8 Perspective, can therefore be clearly differentiated. The G8 Perspective has an inherent need for liquidity-taking to account for Pythagorean principle requirements, which the X8 Perspective on the contrary isn't bound to (bound to liquidity-taking position).

The X8 Perspective is inherently incrementally more probable to provide accurate approximations of risks due to probable improvements in the VaR measurement quality, which account for the Price Risk Field of the X8 Perspective by Accumulating Segregated 7 G6 Perspectives, which themselves (every Perspective) are Triangles of different orders where all of them abide to the Pythagorean principles.

The X8 Perspective is the conservative look at the Price Risk Field, where the risk on the recuperation failure is less than the risk of deposition failure. The G8 Perspective does not hold the quality to be certain and definitive in terms of measuring Price Risk Field from a perspective of a liquidity risk profile gravitating toward the liquidity risk for a liquidity provider, which is gravitating toward adding liquidity into the market. The X8 Perspective and G8 Perspective are both approximations of the Total Price Risk Field, where the G8 Perspective provides less accurate approximations for the Total Price Risk Field, yet it is 6 Perspectives less resource intensive in the production of the Price Risk Field view than the Aggregate X8 Perspective.

The X8 Perspective holding the supremacy over the G8 Perspective from the perspective of certainty of the approximated value of the Price Risk Field, is also a minimum 7 G6 Perspectives long.

Additional precision makes the risk mitigation of 14,285% of total Price Risk downside exposure open through open positions on FX currency pairs more definitive and applicable on Aggregate X Perspective. This in turn makes the cumulative Strategy Pack inherently more prone to stability when accumulating 7 Strategy Packs in the explained factorial manner

X8 Aggregate Perspective vs. X8Currency Aggregate Perspective

The X8 Aggregate Perspective applies to Base Currencies. Each Base Currency Aggregate Perspective incorporates a coherent factorial range of G6 Perspectives. The X8 Aggregate Perspective is therefore applicable to individual fiat currency stable coins as one of the basic elements for the construction of the mechanism for stability. Examples of individual fiat currency backed stable coins are X8USD, X8EUR, X8JPY, X8GBP, X8AUD, X8CAD, X8CHF and X8NZD, for which such a described coherent factorial range of G6 Perspectives constitute an Aggregate X8 Base Currency Perspective.

On the other hand, the X8currency Aggregate Perspective is a factorial assembly of 8 (eight) Aggregate X8 Base Currency Perspectives simultaneously by probabilistic cross-section of most and least volatile currency respectively. In terms of production of the X8currency Aggregate Perspective a cumulative

result is achieved by the mathematical function of addition applied to individual Aggregate Base Currency Perspectives, which add up to the X8currency Aggregate Perspective when accumulating all 8 individual Base Currency Aggregate X8 Perspectives.

This step fortifies the probability function of a Perspective describing the scenario within X8currency, where a Perspective has 2 omitted currencies, and both omitted currencies prove to be the first most volatile currency, and the first runner up to the most volatile currency. For such a variant of a Perspective the Reduction of the Price Risk Field Volume is another incremental order greater than in the case of the Single Base Currency X8 Aggregate Perspective.

Risk Mitigation in Numbers

In the X8currency Aggregate Perspective the probability for one out of eight currencies to be the biggest mover is estimated at:

1/8=12.5%

The reserves of the basket backed stable coin are diversified across all of the world's top 8 fiat currencies. For each currency the System applies 7 G6 Perspectives, which means that for the X8currency there are 8*7=56 Perspective structures, or 56 Strategy Packs. At any moment one eighth of these Strategy Packs aren't suffering from the movements of the most volatile currency and hence the volume of their corresponding Price Risk Fields is reduced with a very high certainty.

Furthermore, from the one eighth (⅛) of all of the 56 Perspectives, where the most volatile currency is correctly identified and omitted, at least one Perspective will also correctly identify the second most volatile currency as described for the example on page 28 and page 29 in this document.

This means that at least 1 Perspective or Strategy Pack out of 56 Perspectives or Strategy Packs in the X8currency Aggregate Perspective will have close to 100% probability for 2 simultaneous levels of risk mitigation to successfully reduce its volume of the Price Risk Field.

In such an Optimum G6 Perspective value of probability for risk mitigation effect equals:

$$“ \\ = 1 ( {( 1 / X )}^{*} ( 1 / ( X - 1 ) ) ) = \\ = 1 - ( {( 1 / 8 )}^{*} ( 1 / 7 ) ) = \\ = 1 - ( {( 1 - 12.5 \% )}^{*} ( 1 - 14.285 \% ) ) = \\ = 1 - ( 0 . {875}^{*} 0.85714 ) = \\ = 1 - ( 0.75 ) \\ = 25.00 \% . \\ ”$$

The structure of different levels of risk mitigation effect by number of Perspectives within the total range of 56 G6 Perspectives of X8currency Aggregate Perspective is as follows:

((X−1)*(X−2)) number of G6 Perspectives without reduction in Price Risk Field Volume

(2*(X−1)) number of G6 Perspectives with basic reduction in Price Risk Field Volume due to identification of the most volatile currency

(X−(X−1)) number of G6 Perspectives with optimal reduction in Price Risk Field Volume due to identification of the most volatile currency and the second most volatile currency

Risk mitigation % expressed in (1−VaR/CaR) ratio terms and probabilities of reductions in Price Risk Field Volume:

((X−1)*(X−2)) number of G6 Perspectives show

(1−VaR/CaR)*=52,083%

((2*(X−1))−1) number of G6 Perspectives show

(1−VaR/CaR)*=52,083%, and

(1/(X−1))=14,2857% probability for further reduction of Price Risk Field Volume

(X−(X−1)) number of G6 Perspectives show

(1−VaR/CaR)*=52,083%

1−((1/X)*(1/(X−1)))=25% probability for reduction of Price Risk Field Volume

*(1−VaR/CaR) expression represents the % reduction in Price Risk measured by VaR method compared to CaR allocated Absolute Risk Volume. For example, 50% means that in risk adjusted terms the price risk will show 2 times less movement than nominally expressed in Capital at Risk terms, provided that Spread Risk will not change and Market Spreads will stay at the level where they have been at the beginning of the Risk allocation.

Probabilistic calculation method for average risk adjustment effect per average G6 Perspective:

$${( ( {( X 1 )}^{*} ( X - 2 ) ) / ( {X}^{*} ( X 1 ) ) )}^{*} ( 1 - ( VaR / CaR ) ) + {( ( {2}^{*} ( X - 1 ) ) / ( {X}^{*} ( X - 1 ) ) )}^{*} ( ( ( 1 - ( VaR / CaR ) ) + ( 1 / ( X - 1 ) ) ) + {( ( X - ( X - 1 ) ) / ( {X}^{*} ( X - 1 ) ) )}^{*} ( ( ( 1 - ( VaR / CaR ) ) + ( 1 - ( {( 1 / X )}^{*} ( 1 / ( X - 1 ) ) ) ) \\ Or \\ 0.390625 \\ + 0.1540709 \\ + 0.0137648 \\ -- -- -- -- -- -- -- -- - \\ = 0.5584608 \\ = 55.84608 \% \\ 0.5584608511904762 Risk Adjustment Effect \\ Potential Reward to Risk rati \text{o:} 2.26480$$

The concept of integrating Algorithms into Strategies and the further integration of Strategies into Perspectives and Aggregate Perspectives is the concept of ARM. Aggregate X Perspective is seen as ARM without the AI quality to it, also true for the 1^{st} Horizon X8currency Aggregate Perspective.

ARM vs. ARM AI

Risk is inherently challenging to measure. Mainly because it can always only be so approximately accurate.

More precision requires additional calculation. Sometimes adding a small amount of additional precision adds significant costs to achieve such an incrementally improved result. This means that additional costs to add some precision can be disproportionally larger than the achieved effect. Optimally, a tradeoff between quality of estimation of the approximated risk value versus the resources needed to process the quality information ultimately narrows the range of choices or ways of how to perform a calculation in the real environment.

In the application of the Model there needs to be a point where the Model completes the structure that can be considered or evaluated for potential use or potential application in risk mitigation. In the case of the System this is a consideration or evaluation for potential use in measurements of market price risk and possibly market spread risk or risk more broadly, plus the applications for mitigations of such risks.

The point of direction of this document is the evaluation of the described approach as a risk mitigation mathematical concept and applicability and uses for financial applications, which are oriented at risk limitation, risk control and risk measurement. In the greater extent this perhaps may open the possibility for a certain applicability of the Model for investment policies.

If AI has relevance in the mentioned tradeoff, then the question is, how much can AI help in the tradeoff and in the production of more accurate risk measurements and can it spend less resources to achieve it?

Artificial Intelligence—Economical and Technical View—Part 1

In reality, AI still abides to GIGO, or as in slang it is referred to as the “garbage in garbage out” principle. AI cannot make good decisions consistently from incoherent input data or from data, which is no more probable than purely random. Question, if AI can improve good data, is an open question. A more pertinent question is whether AI can help in achieving the result of the target mission in fewer steps.

The X8currency Aggregate Perspective as described in the mapping of the Aggregate Perspectives (this is specified in detail in the document from page 58 to page 121) is, in this segment, presented from a bird's eye point of view.

Mathematically, combinatorics would declare the compiling of specific seven G6 Perspectives as one of several possible ways of how to assemble from such and similar Perspectives a coherent X8 Base Currency Aggregate Perspective. The benefit of such a structure is that different mathematical geometric variants of it (set of the seven G6 Perspectives) will carry approximately the same Risk Value Potential or at least may not be very different from one another in these terms. This is a benefit when attempting to measure Price Risk or getting a reading on a value of this specific measure. Therefore, such method or model could possibly apply simply because the measuring stick for risk calculation does not constantly and uncontrollably change or, if it changes, then it can fluctuate only by a lesser degree compared to the main result range.

The fact that a specific view of the seven G6 Perspectives making one Aggregate X Perspective can change, while the end result of VaR and CaR may not give a much different Risk Value reading, and furthermore, the fact that in many of the cases the Risk Value reading could or may not vary much or can be the same if Aggregate Perspective is assembled with a different set of seven G6 Perspectives, is helpful in using this as an input for the AI part of the System.

The factor of risk mitigation as calculated helps to make risk management more effective without over-compromising performance as well. Value of probabilistic risk mitigation was described through a methodology outlined on pages 41 and 42 of this document. Despite the described method being probabilistic in nature on the final ultimate level, it is structured out of integrally assembled Pythagorean elements, which are specific, deterministic, and themselves do not rely on probabilistic concepts.

Under the assumption that AI could only make as good decisions as the quality of input data, and under the assumption that AI itself cannot improve the quality of the data, the effectiveness of the AI is observed and evaluated more in terms of whether it can make probability of better precision Risk Value readings higher and more stable. In other words, the question is whether the AI can help with the result of the measurement of the Risk Value being more pinpointed and with less deviance.

AI can have usable value in the real environment if, somehow, the AI is able to achieve less deviance in measurements of risks.

3 Main Qualities of an AI in the ARM AI System

The first quality of the AI is that the Integral Perspective is accumulated through time.

The second quality is that the Integral Perspective is a vector.

The third main quality is that the Integral Perspective has its own market spread (bid/ask).

The first means that we can see the value of the market and consequently the Integral Perspective changing integrally and understand how much the value has fluctuated in terms of amplitude and in terms of frequency.

The second represents the building block for measuring effectiveness of the AI from the point of view of its purpose of achieving the result in fewer steps and improve the probability of an accurate approximation of Risk Value in the process.

The third represents an interface to the Superposition Perspective to engage into risk exposure allocations through a precisely defined aggregate entry/exit cost profile and through vectorized pre-assembly of FX pair's nominal open market exposure of the final portfolio.

An Integral Perspective is probabilistically not much, if at all any different from an Aggregate Perspective in general. The potential for the difference between the two of them is in the possibility that the FX pair's position skew (across all of the FX pairs) of the Aggregate Perspective can in one part of the curve fall below the minimum System Reaction Threshold. This is where the skew curve itself, for a particular FX pair or certain FX pairs, falls below the minimum trade size threshold, which is from the point of view of the System a parameter, which is set by 3^{rd} parties, like banks and brokers for example. However, otherwise there is no probabilistic difference between the two mentioned Perspective types of the System.

The mathematical integral function of a completely random variable cannot be defined, even if it can be observed. If the input variable is random, then the value of the Integral Perspective can be just as much random without any reduction in uncertainty and without any increase in future predictability.

The role of the Integral Perspective is to account, at least to an achievable extent, for the changes of velocities and for the distances from the target, at least in relative terms of ratios. These are the ratios between the weight or the mass of the spread in the weighted average equation and the arithmetical distance from the current point of travel of the market price spread from the target point of stability and consequently the calculation of the bid/ask spread of the Integral Perspective. The stated is a necessary input to the AI, if it is to be expected that the AI will be able to estimate relative and relevant distances from the target as a result.

The probabilistic point of view is that nobody knows what is the optimal particular X8 Integral Perspective's structure of FX pairs' open nominal market position exposure map, but certain chances or possible definitive options of the exposure map can be measured more precisely and more consistently than others.

Artificial Intelligence—Economical and Technical View

As previously stated in this document, it is highly probable that one of the currencies will be the biggest mover. For scenarios, where this is not the case, the document uses the description of the Market Pole function (as described on page 48 and page 49 of this document). However, for the scenarios, where there is some movement in the FX market prices, the distances from the target are measured in multiples of market price spread widths. In addition to this, the assistance of the Integral Perspective reveals the element of speed or velocity relative to what the speed or velocity has been before in absolute and in relative terms of the price and in terms of the market spread.

Speed of price movements in the market therefore becomes relative and this puts emphasis on the number of steps that separate the states between the current measurement reading and the target objective of the Mechanism for Stability. The mass of the spread of the Integral Perspective also puts a viewpoint on the speed of the spread in relative terms compared to the target, just as it does the same for the Aggregate Perspective and the G6 Perspectives themselves. This represents a viewpoint of a single (one) step and how big the step can be. This is because the mass of the Integral Perspective spread will be greater when the market will be further away from the target and vice-versa.

Due to this input, which Integral Perspective provides to the Superposition, the Superposition is able to determine the mass volume of the spread, which is the space where the spread moves, and also where the mass of the spread can change when the spread moves to different locations.

The Superposition can estimate differences in velocities of the spread between scenarios where a higher mass spread of the Integral Perspective is observed near the target versus a scenario where medium mass spread travels at the bigger distances from the target or, last but not least, versus a probabilistic scenario level where a low mass spread of the Integral Perspective is traveling a very far distance away from the target. Since it is a part of the ARM AI assembly that the Superposition takes the width of the spread as the input for the distance measurement unit and the mass of the spreads as its potential velocity, the Superposition can therefore calculate how many steps of a certain mass (number of steps) differentiates the current position of the FX market from the target position of the Mechanism for Stability.

Artificial Intelligence—Economical and Technical View—Part 3

The decision cost for the Superposition, which is the mass volume of the Integral Perspective's spread, is not arbitrarily set, except that it cannot be described for the market pole function, which is the inexistence of consistent market price sets in lackluster market price discovery environment, where market spread width may most probably vary beyond predictability or even to infinity in mathematical terms.

Therefore, for all non-polar market function scenarios, the Superposition can recognize in the Integral Aggregate Perspective its nature of the pulsation, or at least is able to account for Integral Perspectives relative risk factor by mass of the spread at relative distance velocity from target.

If the solution to the Mechanism for Stability of this document is within the range of a smaller number of prevalent distance units from the target, meaning not many times far from the target in view of own spread width, then such a solution seems to populate a value closer to or less distant from the target from the view of the Superposition Perspective if the spread is wider at the same nearby distance from the target. Wider market spread of the Integral Perspective means bigger steps for Superposition Perspective and bigger steps, when something is close to the target, means a relatively smaller distance.

A bigger and more massive Integral Perspective spread close to the target seems almost on target to the Superposition simply because the Superposition sees this situation as being only a step or a few steps away from the actual target with a great potential velocity, or even approximately on target itself basically. Traveling a thousand miles an hour and being 10 meters away from the target almost seems as being on target itself by a very high degree of precision. This conclusion is possible thanks to the heritage provided to the Superposition by the Integral Perspective in the System.

Oscillations of a massive spread of the Integral Position above and over the target will cause the Superposition to adjust the open risk exposure toward the Integral Perspective in a very strict way, where the oscillations appear as steps around the target from the Superposition's viewpoint. Instead of being very gradual and highly incremental, the open risk exposure of the Superposition toward the Integral Perspective may be more closely resembling an on/off scenario, or for example step 1, step 2, step 3 scenario, where the Superposition is highly focused on the target itself.

On/off risk exposure of the Superposition toward the Integral Perspective causes the Superposition to make decisions of exposure, which may geometrically be changing because of the underlying Integral

Perspective change in geometry. One traversal of the spread over and above the target may not be geometrically equal to another identical occurrence. The Superposition's job is to adjust the relative velocities in terms of the proximity to the target, not the geometric shape of the exposure map which, as a geometric input vector, remains the same. Even if geometric shapes are volatile and different from one another as oscillations appear throughout time, the steps taken by the Superposition are measured from the point of view of risk-reward of one step that it can make.

Another example of an analogy for stability targeting is an airplane, which would be 100 meters away from the target and traveling toward the target at Mach 1. The airplane is not on target, but will probably reach the position of the target very quickly, and will highly probably also overshoot the target. If the Superposition can reduce the vector velocity while being agnostic to the geometric shape vector, the target will be attained for a longer period and exposure to different geometric shapes will depend on how many steps they are distant from the target, not how quickly in how many seconds it can reach the target from nominal velocity point of view.

By AI principles, if the portfolio position is closer to the target then the relative velocity should act in view of the nearby target or in view of being on top of the target at idling. Great speeds or rates of changes of distance relative to target in scenarios where and when fluctuations over and above the target itself in combination with the FX pairs' nominal exposure target of the System, are the input dilemmas resolved by the Superposition Perspective or the ARM and then the ARM AI.

The Integral Perspective, which pulsates in view of the relative velocities of the market spread travel at the distance of the target, also through the pulsation in a geometrically agnostic sense leaves to the Superposition the possibility to morph gradually or step sequentially between probabilistic values of geometries of the triangularly assembled FX pair Price Risk Profile Algorithms depending on the input of geometries and velocities respectively.

To a Superposition Perspective a nominal target pass-over of the Integral Perspective is always a mathematical real number, which the Superposition uses as input, but from the Integral Perspective and from the Aggregate Perspective—ARM—the same (identical) mathematical real number can appear on or near the target on a separate pass or different separate passes with an underlying change in an FX pairs' nominal position mapping and hence representing a different dominance in the geometric skews, but the same nominal velocity reading. Two occurrences of target pass-over with the same mathematical real value represents two ways of how to ultimately achieve the target. The Superposition Perspective's morphing ability through such changing skews from the viewpoint of the decision cost—the spread width—gives the Superposition Perspective the quality to look toward the solution and the target in terms of number of steps, and therefore integrates the preference to resolve the aim in fewer steps.

ARM AI will not always resolve the dilemma about how to achieve a stable target in fewer steps than ARM. This is especially true if the ARM itself already is close to the target and carries only a low level or medium level of volatility respectively. Nevertheless, the larger the volatilities inherent in the ARM (volatility in all of the System's Perspectives up to the Aggregate Perspective and the Integral Perspective), the higher the probability will be that the Superposition Perspective (ARM AI) will resolve the dilemma with fewer steps than ARM. In such cases, the Superposition's AI may be on target already when the ARM is still resolving and working toward the stability target.

Mathematically, the probabilities for this occurrence are the same as described on page 41 and page 42 of this document—the Risk Mitigation Factor in Numbers. This is because the output can only be as good as the input. Nonetheless, the deviation from the target in mathematical real terms will be less due to the fact that the Superposition Perspective is an Algorithm, which is processing the Integral Perspective's market price spread through the lenses of the Price Risk Profile and therefore processes the already geometrically balanced risks through additional and independent risk lenses. The reduction in deviance will abide to the mathematical probabilities of the Algorithm Price Risk function with factor of ((1/(((Strike−(Strike×TRR/2))−(Strike−(Strike×TRR)))/(Strike−(Strike×TRR/2))))×(1/TRR)), where TRR is tolerated trend risk expressed in relative price travel, a positive value between 0 and 1.

Market Pole Function

The chapter about the market pole function concludes the bigger set of chapters that focus on the described Mechanism for Stability. The market pole function chapter itself isn't a part of the Mechanism for Stability chapter anymore. It is a separate chapter, which explains the market scenarios which cannot necessarily be explained completely or definitely within mathematical real terms and sometimes also not within mathematical complex terms.

Market pole function sits at the border of what is within reach of the Mechanism for Stability. The Mechanism for Stability can take the System only so far, which is near or close to the levels bordering on the market poles.

What is a pole of a mathematical function? In the simplest terms the pole can be most well understood by an example of a y=1/x formula, where x has a value of 0. We cannot divide 1 or any other number by 0 as it produces an infinitely large result value. In the case of the well-known y=1/x function the pole of the function spans from minus infinity to plus infinity for an x value of 0. Trivially speaking, the formula is incalculable for x=0.

In contrast to the presented mathematical function example, some mathematical functions have more than one pole. Market Function is one such example, where several different poles exist, where mathematical descriptions provide only a limited or sometimes symbolic definition of the exact value of the function.

Importance of Market Pole Function

In certain cases, the Mechanism for Stability cannot produce the aimed for result if the market is positioned in one of its poles. It can also be that when the market may be in one of its poles, the Mechanism for Stability does not receive any input which the mechanism could process. Not in all of the cases is this bad. If there is no input for example, it may just mean that there will be no reaction from the System.

In other cases, the market reaching a pole of its own function may mean that the allocated risk amount has been fully utilized and may become subject to liquidation or a subject to having to be written-off. In these cases, the limits of risk portfolio allocations are reached and need to be terminated, revalued or restructured. The most common example is a market stop loss scenario, where the positions, which have reached their maximum risk tolerance, are liquidated or squared at the prevailing market price during such a stop loss.

In the System, the stop loss is defined as the Capital-at-Risk limit. Providing that the market is not inhabiting a pole function, the stop loss may also equal to Value-at-Risk limit. If the market spread risk does not change (ceteris paribus market spread), then the probability is the highest that the stop loss value will equal to Value-at-Risk. On the other hand, If the spread risk will increase, the probability increases that the stop loss value will equal to Capital-at-Risk.

Market Pole Function Examples

The market has several theoretical examples which it can demonstrate, and which represent the pole of its function. The market function is seen as a price discovery function at a given liquidity value. When this function ceases to produce a result, which can happen in several ways, it is considered that the market function value is residing in one of its functions poles.

Examples of poles:

Price moves straight up toward infinity without corrective market price action.

Price moves straight down toward negative infinity without corrective market price action.

Market price spread widens to beyond 100% of starting price value on both spread sides.

Market is oscillating in a narrow price range outside of the initial spread, but with not enough price fluctuation or volatility to be able to calculate a reliable positive VaR value. Only negative VaR exists from a certain vantage point of historic market price.

Market is oscillating within the initial market price spread and never produces any prices outside of this price range.

Market absorbs all of the available liquidity as per non-locality variable through P&L volatility differentials between at least two non-local accounts.

Market price volatility vector continuously expands with market price moving in both directions.

Market price volatility vector continuously contracts with prices moving toward mathematical limit function value 0.

None of these poles can be resolved within mathematical fractal space terms or at least none of these poles can be resolved within less restrictive mathematical real numbers' terms. Mathematical fractal terms can represent mathematical real terms if fractals are defined in Pythagorean triangular space. All mathematical non-triangular real terms represent standard mathematical real terms, where the poles examples also cannot mathematically be resolved and do not produce definite approximations of VaR and CaR outputs.

Some of the examples of the poles of the market function can be resolved within mathematical scalar domain space. Pole example number 4 and pole example number 8 can be resolved with a high degree of probability within 1^{st} to 5^{th} order of market price risk scalars.

Pole example number 6 and 7 leave an open possibility for a definitive resolving of the mathematically real VaR or CaR approximation output within 1^{st} to 5^{th} order of market price risk scalars, however the probability for such a positive resolution is conditionally depending on the positive movement of the transitory volatility or consistently positive integrals of 1^{st} to 4th derivative orders of market price volatility. As such they are seen as inconsistent and semi-probable or temporary in nature.

The Mechanism for Stability in the System was not designed to cope with market conditions as they were described in the examples of the market pole function. The System does have the capabilities to calculate approximations of VaR and CaR in the mathematical scalar space, yet the scalar space calculations are seen as experimental, untested and unconfirmed in real environment practical applications. ARM and ARM AI do not in any way constitute scalar mathematical mechanisms neither in risk mitigation methodology nor in VaR and CaR measurements and approximations.

Mathematical Real Numbers Domain and the ARM AI

ARM and ARM AI were designed to operate and produce outputs in the mathematical real numbers' domain and also from it. Mathematical real numbers consist of rational and irrational numbers. Sometimes even if the market price exists in the mathematical real domain it can represent an irrationality from the System's point of view. These irrationalities include: fast movement of very big market spreads, negative market prices and semi-negative market prices.

An example of the first type of irrationality is a big volatile CCY1/CCY2 currency pair spread with the random width reading of 0,000001 BID and 99 ASK and with simultaneous relative distance movement of 10 such respective spread values per minute for example. A distance of 10 spread values measured over a minute's timespan is common with smaller spread widths, like BID 99,9 and ASK 100,00, in which example this would not be an irrationality to the System. However, in terms of a big important market, which moves with big spread velocity of 10 spreads per minute like that shown in the example at the beginning of this paragraph and if simultaneously a market bid price shows a reading of close to 0 limit, while it is liquid and does not touch 0, and while simultaneously this spread width represents 50% or more of the total historic true range of the market from past to present, together this ultimately represents a maximum capability or applicability limit for the System's calculus in definite mathematical real terms. Big market spreads are dangerous, but more dangerous are big market spreads that stay big and move wildly.

Continuing in the mathematical view and the negative price phenomenon, the FX pairs market negative price states would imply the high probability of existence of a continuous or sustained complex multi-choice position. Negative prices create the same absolute distances as positive prices, but the ratios of the proportion between the market spread width and the position distance crosses a Maximum of the Price Risk Field Value function in cases like BID −10 and ASK +20 market price spread with nearly infinite mathematical real result possibilities during such transitions. Such cases with high velocity of movement of such spreads within short time periods over and across the market price mean value of 0 are seen as potential irrationalities from the point of view of the System.

Irrationalities are only approximal by design and can have a symbolic description, but then also complex solutions. The Price Risk Field Value calculation method was not designed or tested for application in the mathematical complex numbers space. The Price Risk Field Value calculation method results, as nominally stated in this document, are presumed under a consistent mathematical real numbers domain space input.

This limitation, that the domain space cannot be complex, is the role of the Superposition. The Integral Perspective must mandatorily ensure input, which the System's Superposition receives, which consistently and repeatedly show positive real numbers, yet probabilistically can be indirectly estimated by a Price Risk Function of first horizon order, where the allocated risk tolerance, or CaR, extends into the territory of negative nominal market price points, for as long as they remain in the domain of mathematical real values integrally and within the CaR limitation. Market price points are the input of the System.

ARM AI's input are market prices, but also are the X8 Base Currency Aggregate Perspective Unit and X8 Base Currency Integral Aggregate Perspective Unit. The Integral Aggregate Perspective Unit does not extend to domains of other mathematical dimensions. Protection for enforcement of this limitation is technically achieved through a stop loss function and through eclipsing of the range of output possibilities on top of value 0 (market spread input with bid price in the negative territory and an offer price in the positive territory is eclipsed out of the ARM and ARM AI's circuit).

The Integral Perspective maintains consistency with accumulated measurements through passing of the time and through relative velocity lenses, provided that the output value of the Aggregate Perspective is a mathematical real number. If this number starts in a positive territory of the real mathematical numbers' domain, the Algorithm's Price Risk Profile will at least be limited to a scenario of a positive number with a tendency to go toward 0, but from a positive starting point. A scenario where the movement happens vice-versa, which means that the market price starts from negative and moves toward 0, is not supported in the System.

The case scenario of a fall in the market price from a positive price toward zero is not in observation here from the VaR or CaR measurement point of view, but from the point of view of the range of mathematical real numbers, that exist between the momentarily prevailing market price and number value 0. These are limited to be mathematical real numbers to comply with input possibilities and requirements for the System's Superposition.

Therefore, the number values of the Integral Aggregate Perspective need to be the set of positive mathematical real numbers and, if they are not positive, they still and also constitute a part of CaR measurement. The Superposition predicts that the value number of the Integral Perspective can be negative, but not in a sense that this would imply any abandonment of positive mathematical real number limitation for input values to the System nor in a sense where this would imply an existence of complex multi-choice solution or a mathematically complex dilemma request to the Superposition. All positions and outputs enacted by the Superposition reside within mathematical real numbers.

Transaction Costs and the ARM AI

Inputs to systems constitute costs as well, as transactions generate costs in the execution of the FX X8 ARM AI assembly. Costs are the cost of a trade brokerage, the cost of an exchange conversion, the transaction fee costs and other costs connected to the portfolio activity in the market.

The structure of costs consists of input elements that are usually dictated by more than one 3^{rd} Party, something which the System does not have an influence over. These costs may vary in different ways and they are in a sense unpredictable.

The System observes costs as costs of decision as described on Page XYZ, where the possibility of incremental costs exists and can be accounted for by the cost of the decision element—the spread—this includes but is not limited, neither even in entirety nor in parts, to cost of initiation and the cost of reinitiating initiations of currency positions and FX currency pairs' nominal open market position exposure of the ARM AI.

Risks

Measurements of VaR risks (VaR defined as per this document) tend to cause a higher VaR result in the theoretical Model. In the theoretical Model the VaR is measured together with an assumption of unchanged spreads (ceteris paribus spread risk) across a price range between the currencies.

VaR behaves as a risk adjusted concept, where triangularly at unchanged spreads the travel of the spread causes various FX pair prices to adjust. Under the assumption of unchanged spreads the VaR result shows travel of cumulative price risks in the described terms.

Particular point of measurement of VaR in the operating environment results in readings being lower than VaR of the theoretical Model most of the time.

Aggregate movement of VaR of the Strategy and the Strategy Pack, as described in the Model, depends on risk adjustment coincidence, which happens when one of the price ratios between the currencies actually risk adjust and produce a corrective (or partially corrective) motion within the price range.

In the case of no corrective motion of the market price spread, and at an assumption of unchanging spreads, the VaR measurement result starts approximating VaR of the theoretical Model.

A non-corrective incremental movement of the price across the entire price range results in a price risk profile curve, which describes the VaR element, provided that the broker or an intermediary through the market is able to execute a CaR limit stop loss order on each FX pair's CaR risk exposure.

Aggregate Capital-at-Risk of an individual G6 Perspective is 12 units of Risk. In Price Risk terms the risk adjusted VaR will be lower than CaR for as long as the market price spread between bid and ask prices do not extend over the price range of the measurement. The Model is not focusing on the movement of the price within the market price spread.

Capital-at-Risk (CaR) is the result of the aggregate spread extending to aggregate sum of CaR allocations for each of the FX pairs. CaR profile curve follows the spread increase of the spread width from the center spread starting point.

This way the Model describes Price Risk and Spread Risk.

Price Risk represents the movement of the price across a price range. Spread Risk describes the movement of one side of the market price spread.

Values of VaR and CaR as open market measurements of the Model are only approximations, where the possibilities for the execution of stop loss orders fluctuate. The execution of the stop loss is therefore a changing parameter and an additional input to the final measurement results.

Risk Model

Specification: “X” type assemblies (8 CCYs: USD, EUR, JPY, GBP, AUD, CAD, CHF, NZD)

X=8 Factorial Rules: In an Aggregate Perspective (of any currency) the Base currency of the Aggregate Perspective is always omitted in each of the individual Perspectives. In addition to the Base currency of the Aggregate Perspective of the particular currency, which is omitted by default in any G Perspective, also one (1) additional probable most volatile currency is omitted—shown below in (CCY). Therefore, for each G Perspective there are 2 omitted currencies, which are not involved in the assembly of a G Perspective. In the case of X8 structure this means that these rules apply to all 7 of G6 Perspectives for each Base Currency Aggregate X Perspective.

Coins are described with VaR and CaR Model. For the purpose of these measures the following specifications describe the worse type of the VaR and CaR scenario This simply means that the model would not ever prodeuce an accurate second most volatile currency result. Predisctive result.

“X” structures:

X8 USD, X8 EUR, X8 JPY, X8 GBP, X8 AUD, X8 CAD, X8 CHF, X8 NZD

X8currency

1^{st} Horizon Aggregate X8 USD Base Currency Perspective—X8USD stable coin ARM structure

1^{st} G6 Perspective, CCY's: USD—Base (omitted), EUR, JPY, GBP, AUD, CAD, CHF, (NZD).

2^{nd} G6 Perspective, CCY's: USD—Base (omitted), EUR, JPY, GBP, AUD, CAD, (CHF), NZD.

3^{rd} G6 Perspective, CCY's: USD—Base (omitted), EUR, JPY, GBP, AUD, (CAD), CHF, NZD.

4^{th} G6 Perspective, CCY's: USD—Base (omitted), EUR, JPY, GBP, (AUD), CAD, CHF, NZD.

5^{th} G6 Perspective, CCY's: USD—Base (omitted), EUR, JPY, (GBP), AUD, CAD, CHF, NZD.

6^{th} G6 Perspective, CCY's: USD—Base (omitted), EUR, (JPY), GBP, AUD, CAD, CHF, NZD.

7^{th} G6 Perspective, CCY's: USD—Base (omitted), (EUR), JPY, GBP, AUD, CAD, CHF, NZD.

1^{st} Horizon Aggregate X8 EUR Base Currency Perspective—X8EUR stable coin ARM structure

1^{st} G6 Perspective, CCY's: EUR—Base (omitted), USD, JPY, GBP, AUD, CAD, CHF, (NZD).

2^{nd} G6 Perspective, CCY's: EUR—Base (omitted), USD, JPY, GBP, AUD, CAD, (CHF), NZD.

3^{rd} G6 Perspective, CCY's: EUR—Base (omitted), USD, JPY, GBP, AUD, (CAD), CHF, NZD.

4^{th} G6 Perspective, CCY's: EUR—Base (omitted), USD, JPY, GBP, (AUD), CAD, CHF, NZD.

5^{th} G6 Perspective, CCY's: EUR—Base (omitted), USD, JPY, (GBP), AUD, CAD, CHF, NZD.

6^{th} G6 Perspective, CCY's: EUR—Base (omitted), USD, (JPY), GBP, AUD, CAD, CHF, NZD.

7^{th} G6 Perspective, CCY's: EUR—Base (omitted), (USD), JPY, GBP, AUD, CAD, CHF, NZD.

1^{st} Horizon Aggregate X8 YEN Base Currency Perspective—X8JPY stable coin ARM structure

1^{st} G6 Perspective, CCY's: JPY—Base (omitted), USD, EUR, GBP, AUD, CAD, CHF, (NZD).

2^{nd} G6 Perspective, CCY's: JPY—Base (omitted), USD, EUR, GBP, AUD, CAD, (CHF), NZD.

3^{rd} G6 Perspective, CCY's: JPY—Base (omitted), USD, EUR, GBP, AUD, (CAD), CHF, NZD.

4^{th} G6 Perspective, CCY's: JPY—Base (omitted), USD, EUR, GBP, (AUD), CAD, CHF, NZD.

5^{th} G6 Perspective, CCY's: JPY—Base (omitted), USD, EUR, (GBP), AUD, CAD, CHF, NZD.

6^{th} G6 Perspective, CCY's: JPY—Base (omitted), USD, (EUR), GBP, AUD, CAD, CHF, NZD.

7^{th} G6 Perspective, CCY's: JPY—Base (omitted), (USD), EUR, GBP, AUD, CAD, CHF, NZD.

1^{st} Horizon Aggregate X8 GBP Base Currency Perspective—X8GBP stable coin ARM structure

1^{st} G6 Perspective, CCY's: GBP—Base (omitted), USD, EUR, JPY, AUD, CAD, CHF, (NZD).

2^{nd} G6 Perspective, CCY's: GBP—Base (omitted), USD, EUR, JPY, AUD, CAD, (CHF), NZD.

3^{rd} G6 Perspective, CCY's: GBP—Base (omitted), USD, EUR, JPY, AUD, (CAD), CHF, NZD.

4^{th} G6 Perspective, CCY's: GBP—Base (omitted), USD, EUR, JPY, (AUD), CAD, CHF, NZD.

5^{th} G6 Perspective, CCY's: GBP—Base (omitted), USD, EUR, (JPY), AUD, CAD, CHF, NZD.

6^{th} G6 Perspective, CCY's: GBP—Base (omitted), USD, (EUR), JPY, AUD, CAD, CHF, NZD.

7^{th} G6 Perspective, CCY's: GBP—Base (omitted), (USD), EUR, JPY, AUD, CAD, CHF, NZD.

1^{st} Horizon Aggregate X8 AUD Base Currency Perspective—X8AUD stable coin ARM structure

1^{st} G6 Perspective, CCY's: AUD—Base (omitted), USD, EUR, JPY, GBP, CAD, CHF, (NZD).

2^{nd} G6 Perspective, CCY's: AUD—Base (omitted), USD, EUR, JPY, GBP, CAD, (CHF), NZD.

3^{rd} G6 Perspective, CCY's: AUD—Base (omitted), USD, EUR, JPY, GBP, (CAD), CHF, NZD.

4^{th} G6 Perspective, CCY's: AUD—Base (omitted), USD, EUR, JPY, (GBP), CAD, CHF, NZD.

5^{th} G6 Perspective, CCY's: AUD—Base (omitted), USD, EUR, (JPY), GBP, CAD, CHF, NZD.

6^{th} G6 Perspective, CCY's: AUD—Base (omitted), USD, (EUR), JPY, GBP, CAD, CHF, NZD.

7^{th} G6 Perspective, CCY's: AUD—Base (omitted), (USD), EUR, JPY, GBP, CAD, CHF, NZD.

1^{st} Horizon Aggregate X8 CAD Base Currency Perspective—X8CAD stable coin ARM structure

1^{st} G6 Perspective, CCY's: CAD—Base (omitted), USD, EUR, JPY, GBP, AUD, CHF, (NZD).

2^{nd} G6 Perspective, CCY's: CAD—Base (omitted), USD, EUR, JPY, GBP, AUD, (CHF), NZD.

3^{rd} G6 Perspective, CCY's: CAD—Base (omitted), USD, EUR, JPY, GBP, (AUD), CHF, NZD.

4^{th} G6 Perspective, CCY's: CAD—Base (omitted), USD, EUR, JPY, (GBP), AUD, CHF, NZD.

5^{th} G6 Perspective, CCY's: CAD—Base (omitted), USD, EUR, (JPY), GBP, AUD, CHF, NZD.

6^{th} G6 Perspective, CCY's: CAD—Base (omitted), USD, (EUR), JPY, GBP, AUD, CHF, NZD.

7^{th} G6 Perspective, CCY's: CAD—Base (omitted), (USD), EUR, JPY, GBP, AUD, CHF, NZD.

1^{st} Horizon Aggregate X8 CHF Base Currency Perspective—X8CHF stable coin ARM structure

1^{st} G6 Perspective, CCY's: CHF—Base (omitted), USD, EUR, JPY, GBP, AUD, CAD, (NZD).

2^{nd} G6 Perspective, CCY's: CHF—Base (omitted), USD, EUR, JPY, GBP, AUD, (CAD), NZD.

3^{rd} G6 Perspective, CCY's: CHF—Base (omitted), USD, EUR, JPY, GBP, (AUD), CAD, NZD.

4^{th} G6 Perspective, CCY's: CHF—Base (omitted), USD, EUR, JPY, (GBP), AUD, CAD, NZD.

5^{th} G6 Perspective, CCY's: CHF—Base (omitted), USD, EUR, (JPY), GBP, AUD, CAD, NZD.

6^{th} G6 Perspective, CCY's: CHF—Base (omitted), USD, (EUR), JPY, GBP, AUD, CAD, NZD.

7^{th} G6 Perspective, CCY's: CHF—Base (omitted), (USD), EUR, JPY, GBP, AUD, CAD, NZD.

1^{st} Horizon Aggregate X8 NZD Base Currency Perspective—X8NZD stable coin ARM structure

1^{st} G6 Perspective, CCY's: NZD—Base (omitted), USD, EUR, JPY, GBP, AUD, CAD, (CHF).

2^{nd} G6 Perspective, CCY's: NZD—Base (omitted), USD, EUR, JPY, GBP, AUD, (CAD), CHF.

3^{rd} G6 Perspective, CCY's: NZD—Base (omitted), USD, EUR, JPY, GBP, (AUD), CAD, CHF.

4^{th} G6 Perspective, CCY's: NZD—Base (omitted), USD, EUR, JPY, (GBP), AUD, CAD, CHF.

5^{th} G6 Perspective, CCY's: NZD—Base (omitted), USD, EUR, (JPY), GBP, AUD, CAD, CHF.

6^{th} G6 Perspective, CCY's: NZD—Base (omitted), USD, (EUR), JPY, GBP, AUD, CAD, CHF.

7^{th} G6 Perspective, CCY's: NZD—Base (omitted), (USD), EUR, JPY, GBP, AUD, CAD, CHF.

Aggregate X8currency Perspective—X8Currency stable coin ARM structure specifications:

X8 USD—ARM AI

X8 EUR—ARM AI

X8 JPY—ARM AI

X8 GBP—ARM AI

X8 AUD—ARM AI

X8 CAD—ARM AI

X8 CHF—ARM AI

X8 NZD—ARM AI

X8 XAU—ARM AI (open slot)

X8 Dollar stable coin specifications—ARM AI structure

1^{st} Base—G6 Perspective: EUR, JPY, GBP, AUD, CAD, CHF, (NZD), (USD)

2^{nd} Base—G6 Perspective: EUR, JPY, GBP, AUD, CAD, (CHF), NZD, (USD)

3^{rd} Base—G6 Perspective: EUR, JPY, GBP, AUD, (CAD), CHF, NZD, (USD)

4^{th} Base—G6 Perspective: EUR, JPY, GBP, (AUD), CAD, CHF, NZD, (USD)

5^{th} Base—G6 Perspective: EUR, JPY, (GBP), AUD, CAD, CHF, NZD, (USD)

6^{th} Base—G6 Perspective: EUR, (JPY), GBP, AUD, CAD, CHF, NZD, (USD)

7^{th} Base—G6 Perspective: (EUR), JPY, GBP, AUD, CAD, CHF, NZD, (USD)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 Euro Stable Coin Specifications—ARM AI Structure

1^{st} Base—G6 Perspective: USD, JPY, GBP, AUD, CAD, CHF, (NZD), (EUR)

2^{nd} Base—G6 Perspective: USD, JPY, GBP, AUD, CAD, (CHF), NZD, (EUR)

3^{rd} Base—G6 Perspective: USD, JPY, GBP, AUD, (CAD), CHF, NZD, (EUR)

4^{th} Base—G6 Perspective: USD, JPY, GBP, (AUD), CAD, CHF, NZD, (EUR)

5^{th} Base—G6 Perspective: USD, JPY, (GBP), AUD, CAD, CHF, NZD, (EUR)

6^{th} Base—G6 Perspective: USD, (JPY), GBP, AUD, CAD, CHF, NZD, (EUR)

7^{th} Base—G6 Perspective: (USD), JPY, GBP, AUD, CAD, CHF, NZD, (EUR)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 Japanese Yen Stable Coin Specifications—ARM AI Structure

1^{st} Base—G6 Perspective: USD, EUR, GBP, AUD, CAD, CHF, (NZD), (JPY)

2^{nd} Base—G6 Perspective: USD, EUR, GBP, AUD, CAD, (CHF), NZD, (JPY)

3^{rd} Base—G6 Perspective: USD, EUR, GBP, AUD, (CAD), CHF, NZD, (JPY)

4^{th} Base—G6 Perspective: USD, EUR, GBP, (AUD), CAD, CHF, NZD, (JPY)

5^{th} Base—G6 Perspective: USD, EUR, (GBP), AUD, CAD, CHF, NZD, (JPY)

6^{th} Base—G6 Perspective: USD, (EUR), GBP, AUD, CAD, CHF, NZD, (JPY)

7^{th} Base—G6 Perspective: (USD), EUR, GBP, AUD, CAD, CHF, NZD, (JPY)

Virtual Base Summary—Aggregate X8 Perspective

1^{st} Vector—Integral Perspective, Algorithm with input from Aggregate X8 Perspective

2^{nd} Vector—Superposition Perspective, Algorithm with input from Integral Perspective

Virtual Summary

X8 British Pound stable coin specifications—ARM AI structure

1^{st} Base—G6 Perspective: USD, EUR, JPY, AUD, CAD, CHF, (NZD), (GBP)

2^{nd} Base—G6 Perspective: USD, EUR, JPY, AUD, CAD, (CHF), NZD, (GBP)

3^{rd} Base—G6 Perspective: USD, EUR, JPY, AUD, (CAD), CHF, NZD, (GBP)

4^{th} Base—G6 Perspective: USD, EUR, JPY, (AUD), CAD, CHF, NZD, (GBP)

5^{th} Base—G6 Perspective: USD, EUR, (JPY), AUD, CAD, CHF, NZD, (GBP)

6^{th} Base—G6 Perspective: USD, (EUR), JPY, AUD, CAD, CHF, NZD, (GBP)

7^{th} Base—G6 Perspective: (USD), EUR, JPY, AUD, CAD, CHF, NZD, (GBP)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 Australian Dollar stable coin specifications—ARM AI structure—ARM AI structure

1^{st} Base—G6 Perspective: USD, EUR, JPY, GBP, CAD, CHF, (NZD), (AUD)

2^{nd} Base—G6 Perspective: USD, EUR, JPY, GBP, CAD, (CHF), NZD, (AUD)

3r^{d} Base—G6 Perspective: USD, EUR, JPY, GBP, (CAD), CHF, NZD, (AUD)

4^{th} Base—G6 Perspective: USD, EUR, JPY, (GBP), CAD, CHF, NZD, (AUD)

5^{th} Base—G6 Perspective: USD, EUR, (JPY), GBP, CAD, CHF, NZD, (AUD)

6^{th} Base—G6 Perspective: USD, (EUR), JPY, GBP, CAD, CHF, NZD, (AUD)

7^{th} Base—G6 Perspective: (USD), EUR, JPY, GBP, CAD, CHF, NZD, (AUD)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 Canadian Dollar stable coin specifications—ARM AI structure

1^{st} Base—G6 Perspective: USD, EUR, JPY, GBP, AUD, CHF, (NZD), (CAD)

2^{nd} Base—G6 Perspective: USD, EUR, JPY, GBP, AUD, (CHF), NZD, (CAD)

3^{rd} Base—G6 Perspective: USD, EUR, JPY, GBP, (AUD), CHF, NZD, (CAD)

4^{th} Base—G6 Perspective: USD, EUR, JPY, (GBP), AUD, CHF, NZD, (CAD)

5^{th} Base—G6 Perspective: USD, EUR, (JPY), GBP, AUD, CHF, NZD, (CAD)

6^{th} Base—G6 Perspective: USD, (EUR), JPY, GBP, AUD, CHF, NZD, (CAD)

7^{th} Base—G6 Perspective: (USD), EUR, JPY, GBP, AUD, CHF, NZD, (CAD)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 Swiss Franc stable coin specifications—ARM AI structure

1^{st} Base—G6 Perspective: USD, EUR, JPY, GBP, AUD, CAD, (NZD), (CHF)

2^{nd} Base—G6 Perspective: USD, EUR, JPY, GBP, AUD, (CAD), NZD, (CHF)

3^{rd} Base—G6 Perspective: USD, EUR, JPY, GBP, (AUD), CAD, NZD, (CHF)

4^{th} Base—G6 Perspective: USD, EUR, JPY, (GBP), AUD, CAD, NZD, (CHF)

5^{th} Base—G6 Perspective: USD, EUR, (JPY), GBP, AUD, CAD, NZD, (CHF)

6^{th} Base—G6 Perspective: USD, (EUR), JPY, GBP, AUD, CAD, NZD, (CHF)

7^{th} Base—G6 Perspective: (USD), EUR, JPY, GBP, AUD, CAD, NZD, (CHF)

Virtual Base Summary—Aggregate X8 Perspective

1^{st} Vector—Integral Perspective—Algorithm with input from Aggregate X8 Perspective

2^{nd} Vector—Superposition Perspective—Algorithm with input from Integral Perspective

Virtual Summary

X8 New Zealand Dollar stable coin specifications—ARM AI structure

1^{st} Base—G6 Perspective: USD, EUR, JPY, GBP, AUD, CAD, (CHF), (NZD)

2^{nd} Base—G6 Perspective: USD, EUR, JPY, GBP, AUD, (CAD), CHF, (NZD)

3^{rd} Base—G6 Perspective: USD, EUR, JPY, GBP, (AUD), CAD, CHF, (NZD)

4^{th} Base—G6 Perspective: USD, EUR, JPY, (GBP), AUD, CAD, CHF, (NZD)

5^{th} Base—G6 Perspective: USD, EUR, (JPY), GBP, AUD, CAD, CHF, (NZD)

6^{th} Base—G6 Perspective: USD, (EUR), JPY, GBP, AUD, CAD, CHF, (NZD)

7^{th} Base—G6 Perspective: (USD), EUR, JPY, GBP, AUD, CAD, CHF, (NZD)

Virtual Base Summary—Aggregate X 8Perspective

1^{st} Vector—Integral Perspective—Algorithm with input from Aggregate X8 Perspective

2^{nd} Vector—Superposition Perspective—Algorithm with input from Integral Perspective

Virtual Summary

Risk Model Legend

X8USD stable coin Aggregate X Perspective: Page 58 to page 65

X8EUR stable coin Aggregate X Perspective: Page 66 to page 73

X8JPY stable coin Aggregate X Perspective: Page 74 to page 81

X8GBP stable coin Aggregate X Perspective: Page 82 to page 89

X8AUD stable coin Aggregate X Perspective: Page 90 to page 97

X8CAD stable coin Aggregate X Perspective: Page 98 to page 105

X8CHF stable coin Aggregate X Perspective: Page 106 to page 113

X8NZD stable coin Aggregate X Perspective: Page 114 to page 121

X8currency stable coin Aggregate X Perspective: Page 122 to page 123

1^{st} Horizon 1^{st} G6 Perspective in 1^{st} Horizon Aggregate X8 Perspective for USD Base currency: EURJPY; EURAUD; AUDJPY; GBPJPY; GBPCAD; CADJPY; EURGBP; EURCHF; GBPCHF; AUDCHF; AUDCAD; CADCHF

This is shown in FIG. 27.

Radical FX Pairs: EURCAD; CHFJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for USD Base currency: GBPJPY; CADJPY; GBPCAD; GBPAUD; EURAUD; EURGBP; AUDJPY; NZDJPY; AUDNZD; NZDCAD; EURCAD; EURNZD

This is shown in FIG. 28.

Radical FX Pairs: EURJPY; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for USD Base currency: EURGBP; GBPCHF; EURCHF; EURJPY; NZDJPY; EURNZD; GBPJPY; GBPAUD; AUDJPY; AUDCHF; NZDCHF; AUDNZD

This is shown in FIG. 29.

Radical FX Pairs: GBPNZD; EURAUD; CHFJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for USD Base currency: CADCHF; EURCAD; EURCHF; NZDCHF; NZDJPY; CHFJPY; NZDCAD; GBPCAD; GBPNZD; EURGBP; EURJPY; GBPJPY;

This is shown in FIG. 30.

Radical FX Pairs: CADJPY; GBPCHF; EURNZD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for USD Base currency: NZDCHF; AUDCHF; AUDNZD; NZDCAD; EURCAD; EURNZD; CADCHF; CHFJPY; CADJPY; AUDJPY; EURAUD; EURJPY

This is shown in FIG. 31.

Radical FX Pairs: EURCHF; NZDJPY; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6th G6 Perspective in 1^{st} Horizon Aggregate X8 Perspective for USD Base currency: NZDCAD; GBPNZD; GBPCAD; CADCHF; AUDCHF; AUDCAD; NZDCHF; EURNZD; EURCHF; EURGBP; GBPAUD; EURAUD

This is shown in FIG. 32.

Radical FX Pairs: AUDNZD; EURCAD; GBPCHF

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for USD Base currency: GBPAUD; AUDJPY; GBPJPY; GBPNZD; NZDCHF; GBPCHF; AUDNZD; AUDCAD; NZDCAD; CADJPY; CHFJPY; CADCHF

This is shown in FIG. 33.

Radical FX Pairs: AUDCHF; GBPCAD; NZDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 USD Base Currency Aggregate Perspective:

This is shown in FIG. 34.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of USD.

1^{st} Horizon 1^{st} G6 Perspective in 1^{st} Horizon Aggregate X8 Perspective for EUR Base currency: USDJPY; AUDUSD; AUDJPY; GBPJPY; GBPCAD; CADJPY; GBPUSD; USDCHF; GBPCHF; AUDCHF; AUDCAD; CADCHF

This is shown in FIG. 35.

Radical FX Pairs: USDCAD; CHFJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for EUR Base currency: USDJPY; AUDUSD; AUDJPY; GBPJPY; GBPCAD; CADJPY; GBPUSD; NZDUSD; GBPNZD; AUDNZD; AUDCAD; NZDCAD

This is shown in FIG. 36.

Radical FX Pairs: USDCAD; NZDJPY; GBPAUD;

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for EUR Base currency: USDJPY; AUDUSD; AUDJPY; GBPJPY; GBPCHF; CHFJPY; GBPUSD; NZDUSD; GBPNZD; AUDNZD; AUDCHF; NZDCHF

This is shown in FIG. 37.

Radical FX Pairs: USDCHF; NZDJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for EUR Base currency: USDJPY; USDCAD; CADJPY; GBPJPY; GBPCHF; CHFJPY; GBPUSD; NZDUSD; GBPNZD; NZDCAD; CADCHF; NZDCHF

This is shown in FIG. 38.

Radical FX Pairs: USDCHF; NZDJPY; GBPCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for EUR Base currency: USDJPY; USDCAD; CADJPY; AUDJPY; AUDCHF; CHFJPY; AUDUSD; NZDUSD; AUDNZD; NZDCAD; CADCHF; NZDCHF

This is shown in FIG. 39.

Radical FX Pairs: USDCHF; NZDJPY; AUDCAD;

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for EUR Base currency: GBPUSD; USDCAD; GBPCAD; GBPAUD; AUDCHF; GBPCHF; AUDUSD; NZDUSD; AUDNZD; NZDCAD; CADCHF; NZDCHF

This is shown in FIG. 40.

Radical FX Pairs: USDCHF; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for EUR Base currency: GBPJPY; CADJPY; GBPCAD; GBPAUD; AUDCHF; GBPCHF; AUDJPY; NZDJPY; AUDNZD; NZDCAD; CADCHF; NZDCHF

This is shown in FIG. 41.

Radical FX Pairs: CHFJPY; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 EUR Base CurrencyAggregate Perspective:

This is shown in FIG. 42.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of EUR.

1^{st} Horizon 1^{st} G6 Perspective in 1^{st} Horizon Aggregate X8 Perspective for JPY Base currency: EURUSD; AUDUSD; EURAUD; EURGBP; GBPCAD; EURCAD; GBPUSD; USDCHF; GBPCHF; AUDCHF; AUDCAD; CADCHF

This is shown in FIG. 43.

Radical FX Pairs:

USDCAD

EURCHF

GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for JPY Base currency: EURUSD; AUDUSD; EURAUD; EURGBP; GBPCAD; EURCAD; GBPUSD; NZDUSD; GBPNZD; AUDNZD; AUDCAD; NZDCAD

This is shown in FIG. 44.

Radical FX Pairs: USDCAD; EURNZD; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for JPY Base currency: EURUSD; AUDUSD; EURAUD; EURGBP; GBPCHF; EURCHF; GBPUSD; NZDUSD; GBPNZD; AUDNZD; AUDCHF; NZDCHF

This is shown in FIG. 45.

Radical FX Pairs: USDCHF; EURNZD; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for JPY Base currency: EURUSD; USDCAD; EURCAD; EURGBP; GBPCHF; EURCHF; GBPUSD; NZDUSD; GBPNZD; NZDCAD; CADCHF; NZDCHF

This is shown in FIG. 46.

Radical FX Pairs: USDCHF; EURNZD; GBPCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for JPY Base currency: EURUSD; USDCAD; EURCAD; EURAUD; AUDCHF; EURCHF; AUDUSD; NZDUSD; AUDNZD; NZDCAD; CADCHF; NZDCHF

This is shown in FIG. 47.

Radical FX Pairs: USDCHF; EURNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for JPY Base currency: GBPUSD; USDCAD; GBPCAD; GBPAUD; AUDCHF; GBPCHF; AUDUSD; NZDUSD; AUDNZD; NZDCAD; CADCHF; NZDCHF

This is shown in FIG. 48.

Radical FX Pairs: USDCHF; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for JPY Base currency: EURGBP; EURCAD; GBPCAD; GBPAUD; AUDCHF; GBPCHF; EURAUD; EURNZD; AUDNZD; NZDCAD; CADCHF; NZDCHF

This is shown in FIG. 49.

Radical FX Pairs: EURCHF; GBPNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 JPY Base CurrencyAggregate Perspective:

This is shown in FIG. 50.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of JPY.

1^{st} Horizon 1^{st} G6 Perspective in 1^{st} Horizon Aggregate X8 Perspective for GBP Base currency: EURUSD; AUDUSD; EURAUD; EURJPY; CADJPY; EURCAD; USDJPY; USDCHF; CHFJPY; AUDCHF; AUDCAD; CADCHF;

This is shown in FIG. 51.

Radical FX Pairs: USDCAD; EURCHF; AUDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for GBP Base currency: EURUSD; AUDUSD; EURAUD; EURJPY; CADJPY; EURCAD; USDJPY; NZDUSD; NZDJPY; AUDNZD; AUDCAD; NZDCAD

This is shown in FIG. 52.

Radical FX Pairs: USDCAD; EURNZD; AUDJPY;

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for GBP Base currency: EURUSD; AUDUSD; EURAUD; EURJPY; CHFJPY; EURCHF; USDJPY; NZDUSD; NZDJPY; AUDNZD; AUDCHF; NZDCHF

This is shown in FIG. 53.

Radical FX Pairs: USDCHF; EURNZD; AUDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for GBP Base currency: EURUSD; USDCAD; EURCAD; EURJPY; CHFJPY; EURCHF; USDJPY; NZDUSD; NZDJPY; NZDCAD; CADCHF; NZDCHF;

This is shown in FIG. 54.

Radical FX Pairs: USDCHF; EURNZD; CADJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for GBP Base currency: EURUSD; USDCAD; EURCAD; EURAUD; AUDCHF; EURCHF; AUDUSD; NZDUSD; AUDNZD; NZDCAD; CADCHF; NZDCHF

This is shown in FIG. 55.

Radical FX Pairs: USDCHF; EURNZD; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for GBP Base currency: USDJPY; USDCAD; CADJPY; AUDJPY; AUDCHF; CHFJPY; AUDUSD; NZDUSD; AUDNZD; NZDCAD; CADCHF; NZDCHF

This is shown in FIG. 56.

Radical FX Pairs: USDCHF; NZDJPY; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for GBP Base currency: EURJPY; EURCAD; CADJPY; AUDJPY; AUDCHF; CHFJPY; EURAUD; EURNZD; AUDNZD; NZDCAD; CADCHF; NZDCHF

This is shown in FIG. 57.

Radical FX Pairs: EURCHF; NZDJPY; AUDCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 GBP Base CurrencyAggregate Perspective:

This is shown in FIG. 58.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of GBP.

1^{st} Horizon 1^{st} G6 Perspective in 1^{st} Horizon Aggregate X8 Perspective for AUD Base currency: EURUSD; GBPUSD; EURGBP; EURJPY; CADJPY; EURCAD; USDJPY; USDCHF; CHFJPY; GBPCHF; GBPCAD; CADCHF

This is shown in FIG. 59.

Radical FX Pairs: USDCAD; EURCHF; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for AUD Base currency: EURUSD; GBPUSD; EURGBP; EURJPY; CADJPY; EURCAD; USDJPY; NZDUSD; NZDJPY; GBPNZD; GBPCAD; NZDCAD

This is shown in FIG. 60.

Radical FX Pairs: USDCAD; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for AUD Base currency: EURUSD; GBPUSD; EURGBP; EURJPY; CHFJPY; EURCHF; USDJPY; NZDUSD; NZDJPY; GBPNZD; GBPCHF; NZDCHF

This is shown in FIG. 61.

Radical FX Pairs: USDCHF; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for AUD Base currency: EURUSD; USDCAD; EURCAD; EURJPY; CHFJPY; EURCHF; USDJPY; NZDUSD; NZDJPY; NZDCAD; CADCHF; NZDCHF

This is shown in FIG. 62.

Radical FX Pairs: USDCHF; EURNZD; CADJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for AUD Base currency: EURUSD; USDCAD; EURCAD; EURGBP; GBPCHF; EURCHF; GBPUSD; NZDUSD; GBPNZD; NZDCAD; CADCHF; NZDCHF

This is shown in FIG. 63.

Radical FX Pairs: USDCHF; EURNZD; GBPCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for AUD Base currency: USDJPY; USDCAD; CADJPY; GBPJPY; GBPCHF; CHFJPY; GBPUSD; NZDUSD; GBPNZD; NZDCAD; CADCHF; NZDCHF

This is shown in FIG. 64.

Radical FX Pairs: USDCHF; NZDJPY; GBPCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for AUD Base currency: EURJPY; EURCAD; CADJPY; GBPJPY; GBPCHF; CHFJPY; EURGBP; EURNZD; GBPNZD; NZDCAD; CADCHF; NZDCHF

This is shown in FIG. 65.

Radical FX Pairs: EURCHF; NZDJPY; GBPCAD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 AUD Base CurrencyAggregate Perspective:

This is shown in FIG. 66.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of AUD.

1^{st} Horizon 2^{nd} G6 Perspective in 1^{st} Horizon Aggregate X8 Perspective for CAD Base currency: EURUSD; GBPUSD; EURGBP; EURJPY; AUDJPY; EURAUD; USDJPY; USDCHF; CHFJPY; GBPCHF; GBPAUD; AUDCHF

This is shown in FIG. 67.

Radical FX Pairs: AUDUSD; EURCHF; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for CAD Base currency: EURUSD; GBPUSD; EURGBP; EURJPY; AUDJPY; EURAUD; USDJPY; NZDUSD; NZDJPY; GBPNZD; GBPAUD; AUDNZD

This is shown in FIG. 68.

Radical FX Pairs: AUDUSD; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for CAD Base currency: EURUSD; GBPUSD; EURGBP; EURJPY; CHFJPY; EURCHF; USDJPY; NZDUSD; NZDJPY; GBPNZD; GBPCHF; NZDCHF

This is shown in FIG. 69.

Radical FX Pairs: USDCHF; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for CAD Base currency: EURUSD; AUDUSD; EURAUD; EURJPY; CHFJPY; EURCHF; USDJPY; NZDUSD; NZDJPY; AUDNZD; AUDCHF; NZDCHF

This is shown in FIG. 70.

Radical FX Pairs: USDCHF; EURNZD; AUDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for CAD Base currency: EURUSD; AUDUSD; EURAUD; EURGBP; GBPCHF; EURCHF; GBPUSD; NZDUSD; GBPNZD; AUDNZD; AUDCHF; NZDCHF

This is shown in FIG. 71.

Radical FX Pairs: USDCHF; EURNZD; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for CAD Base currency: USDJPY; AUDUSD; AUDJPY; GBPJPY; GBPCHF; CHFJPY GBPUSD; NZDUSD; GBPNZD; AUDNZD; AUDCHF; NZDCHF;

This is shown in FIG. 72.

Radical FX Pairs: USDCHF; NZDJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for CAD Base currency: EURJPY; EURAUD; AUDJPY; GBPJPY; GBPCHF; CHFJPY; EURGBP; EURNZD; GBPNZD; AUDNZD; AUDCHF; NZDCHF

This is shown in FIG. 73.

Radical FX Pairs: EURCHF; NZDJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial assembly of seven (7) specific G6 Perspectives into an X8 CAD Base CurrencyAggregate Perspective:

This is shown in FIG. 75.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of CAD.

1^{st} Horizon 1^{st} G6 Perspective in 1^{st} Horizon Aggregate X8 Perspective for CHF Base currency: EURUSD; GBPUSD; EURGBP; EURJPY; AUDJPY; EURAUD; USDJPY; USDCAD; CADJPY; GBPCAD; GBPAUD; AUDCAD;

This is shown in FIG. 76.

Radical FX Pairs: AUDUSD; EURCAD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for CHF Base currency: EURUSD; GBPUSD; EURGBP; EURJPY; AUDJPY; EURAUD; USDJPY; NZDUSD; NZDJPY; GBPNZD; GBPAUD; AUDNZD

This is shown in FIG. 77.

Radical FX Pairs: AUDUSD; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for CHF Base currency: EURUSD; GBPUSD; EURGBP; EURJPY; CADJPY; EURCAD; USDJPY; NZDUSD; NZDJPY; GBPNZD; GBPCAD; NZDCAD

This is shown in FIG. 78.

Radical FX Pairs: USDCAD; EURNZD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for CHF Base currency: EURUSD; AUDUSD; EURAUD; EURJPY; CADJPY; EURCAD; USDJPY; NZDUSD; NZDJPY; AUDNZD; AUDCAD; NZDCAD

This is shown in FIG. 79.

Radical FX Pairs: USDCAD; EURNZD; AUDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for CHF Base currency: EURUSD; AUDUSD; EURAUD; EURGBP; GBPCAD; EURCAD; GBPUSD; NZDUSD; GBPNZD; AUDNZD; AUDCAD; NZDCAD

This is shown in FIG. 80.

Radical FX Pairs: USDCAD; EURNZD; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for CHF Base currency: USDJPY; AUDUSD; AUDJPY; GBPJPY; GBPCAD; CADJPY; GBPUSD; NZDUSD; GBPNZD; AUDNZD; AUDCAD; NZDCAD

This is shown in FIG. 81.

Radical FX Pairs: USDCAD; NZDJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for CHF Base currency: EURJPY; EURAUD; AUDJPY; GBPJPY; GBPCAD; CADJPY; EURGBP; EURNZD; GBPNZD; AUDNZD; AUDCAD; NZDCAD

This is shown in FIG. 82.

Radical FX Pairs: EURCHF; NZDJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 CHF Base CurrencyAggregate Perspective:

This is shown in FIG. 83.

*This structure of 7×12=84 FX Pair Algorithms does not have any radical FX pairs and is factorially bringing individual 12 FX Pair 12 CaR (5,75VaR) G structures (with a 48% HardVaR/CaR ratio) into an interlocking 21 FX Pair Aggregate Perspective X structure—called an X8 Base Currency Aggregate Perspective structure with a Base Currency of CHF.

1^{st} Horizon 1^{st} G6 Perspective in 1^{st} Horizon Aggregate X8 Perspective for NZD Base currency: EURUSD; GBPUSD; EURGBP; EURJPY; AUDJPY; EURAUD; USDJPY; USDCAD; CADJPY; GBPCAD; GBPAUD; AUDCAD;

This is shown in FIG. 84.

Radical FX Pairs: AUDUSD; EURCAD; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 2^{nd} G6 Perspective in 1^{st} Horizon Aggregate X8 Perspective for NZD Base currency: EURUSD; GBPUSD; EURGBP; EURJPY; AUDJPY; EURAUD; USDJPY; USDCHF; CHFJPY; GBPCHF; GBPAUD; AUDCHF

This is shown in FIG. 85.

Radical FX Pairs: AUDUSD; EURCHF; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 3^{rd} G6 Perspective in 1^{st} Horizon Aggregate X8 Perspective for NZD Base currency: EURUSD; GBPUSD; EURGBP; EURJPY; CADJPY; EURCAD; USDJPY; USDCHF; CHFJPY; GBPCHF; GBPCAD; CADCHF

This is shown in FIG. 86.

Radical FX Pairs: USDCAD; EURCHF; GBPJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 4^{th} G6 Perspective in 1^{st} Horizon Aggregate X8 Perspective for NZD Base currency: EURUSD; AUDUSD; EURAUD; EURJPY; CADJPY; EURCAD; USDJPY; USDCHF; CHFJPY; AUDCHF; AUDCAD; CADCHF

This is shown in FIG. 87.

Radical FX Pairs: USDCAD; EURCHF; AUDJPY

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 5^{th} G6 Perspective in 1^{st} Horizon Aggregate X8 Perspective for NZD Base currency: EURUSD; AUDUSD; EURAUD; EURGBP; GBPCAD; EURCAD; GBPUSD; USDCHF; GBPCHF; AUDCHF; AUDCAD; CADCHF

This is shown in FIG. 88.

Radical FX Pairs: USDCAD; EURCHF; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 6^{th} G6 Perspective in 1^{st} Horizon Aggregate X8 Perspective for NZD Base currency: USDJPY; AUDUSD; AUDJPY; GBPJPY; GBPCAD; CADJPY; GBPUSD; USDCHF; GBPCHF; AUDCHF; AUDCAD; CADCHF;

This is shown in FIG. 89.

Radical FX Pairs: USDCAD; CHFJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

1^{st} Horizon 7^{th} G6 Perspective in 1^{st} Horizon Aggregate X8 Perspective for NZD Base currency: EURJPY; EURAUD; AUDJPY; GBPJPY; GBPCAD; CADJPY; EURGBP; EURCHF; GBPCHF; AUDCHF; AUDCAD; CADCHF

This is shown in FIG. 90.

Radical FX Pairs: EURCAD; CHFJPY; GBPAUD

*G6 Perspective structure of 12 FX currency pairs is representing 12 CaR units. The structure is selected to form an Aggregate X8 Perspective. VaR/CaR ratio results in values of less than 1 when market price spread's variance shows tendency to stabilize. VaR Model equals or is below the value of CaR Model. VaR/CaR value travels between 0 and 0.5 when selected FX pairs have strong stability tendencies.

Factorial Assembly of Seven (7) Specific G6 Perspectives into an X8 NZD Base CurrencyAggregate Perspective:

This is shown in FIG. 91.

*This structure of 7×12=84 FX Pair Algorithms does not have any radical FX pairs and is factorially bringing individual 12 FX Pair 12 CaR (5,75VaR) G6 structures (with a 48% HardVaR/CaR ratio) into an interlocking 21 FX Pair Aggregate Perspective X8 structure—called an X8 Base Currency Aggregate Perspective structure with a Base Currency of NZD.

X8currency Aggregate Perspective—Example—CCYs: USD, EUR, JPY, GBP, AUD, CAD, CHF, NZD

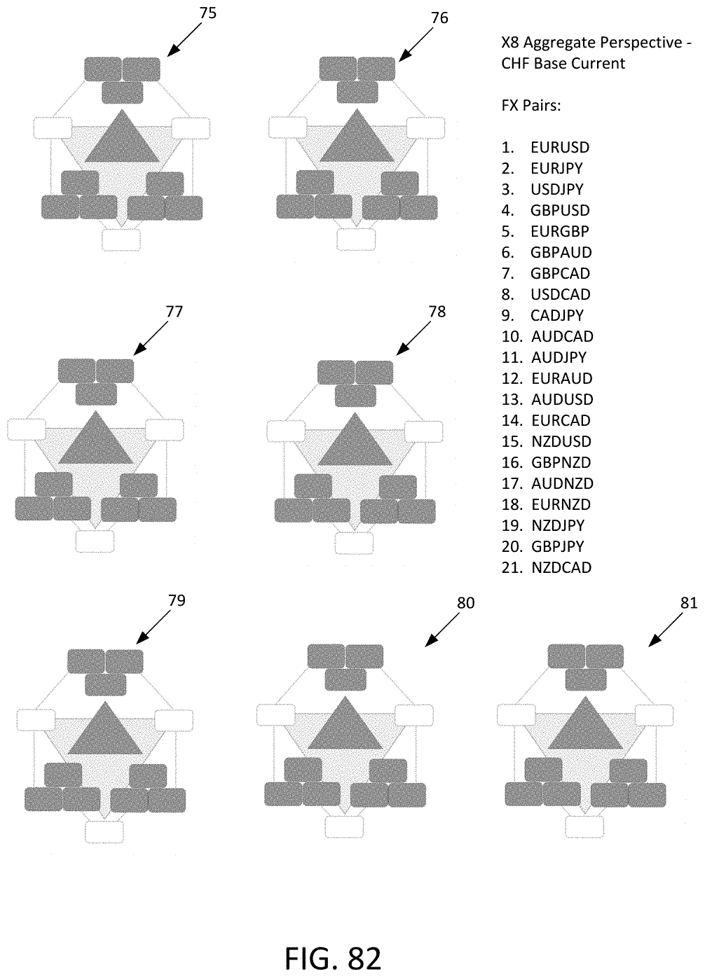

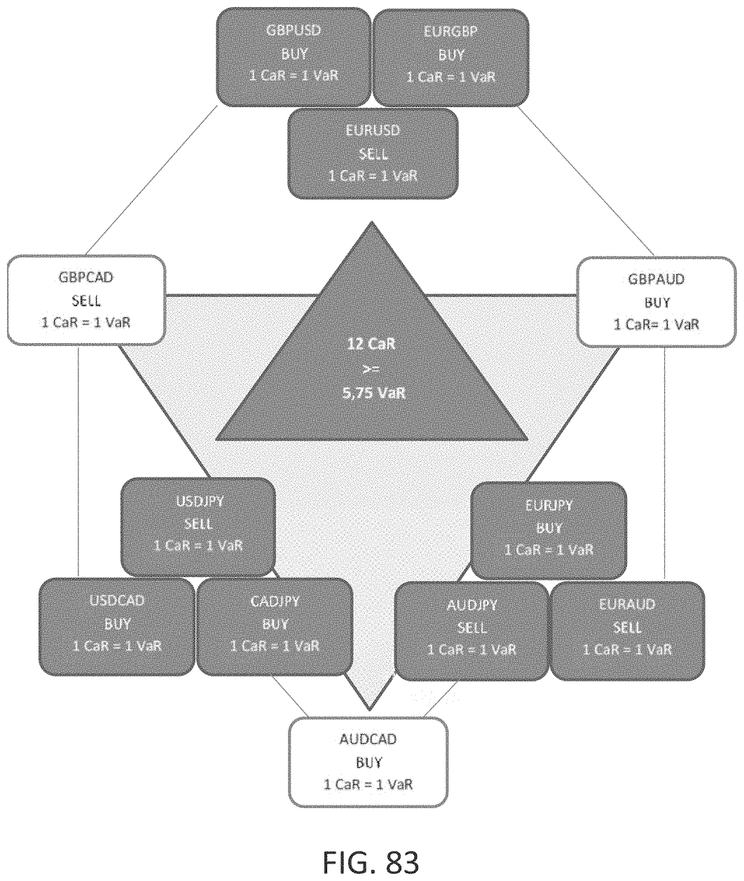

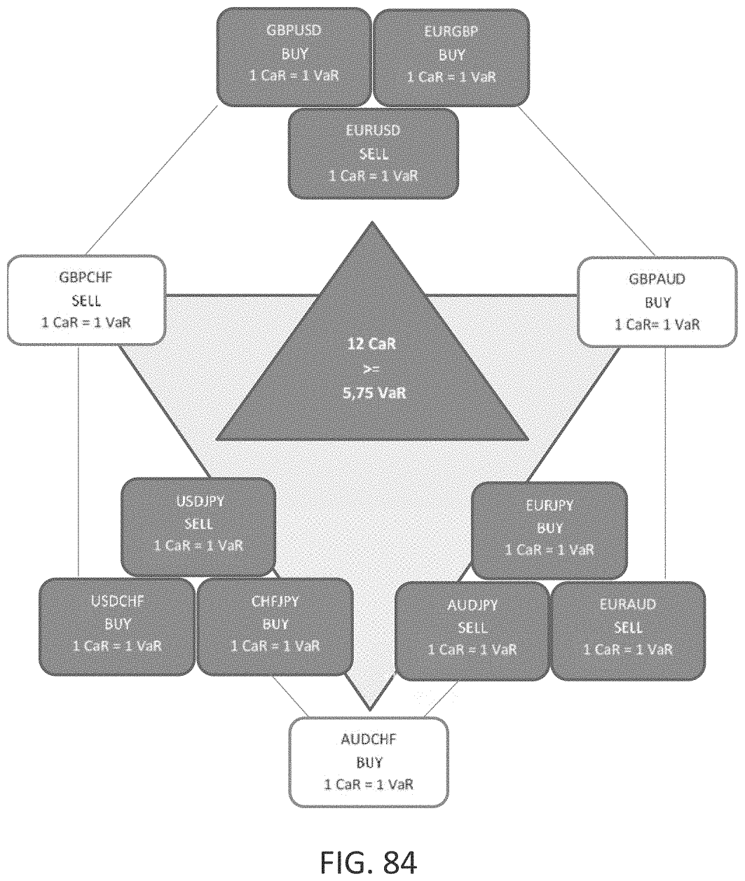

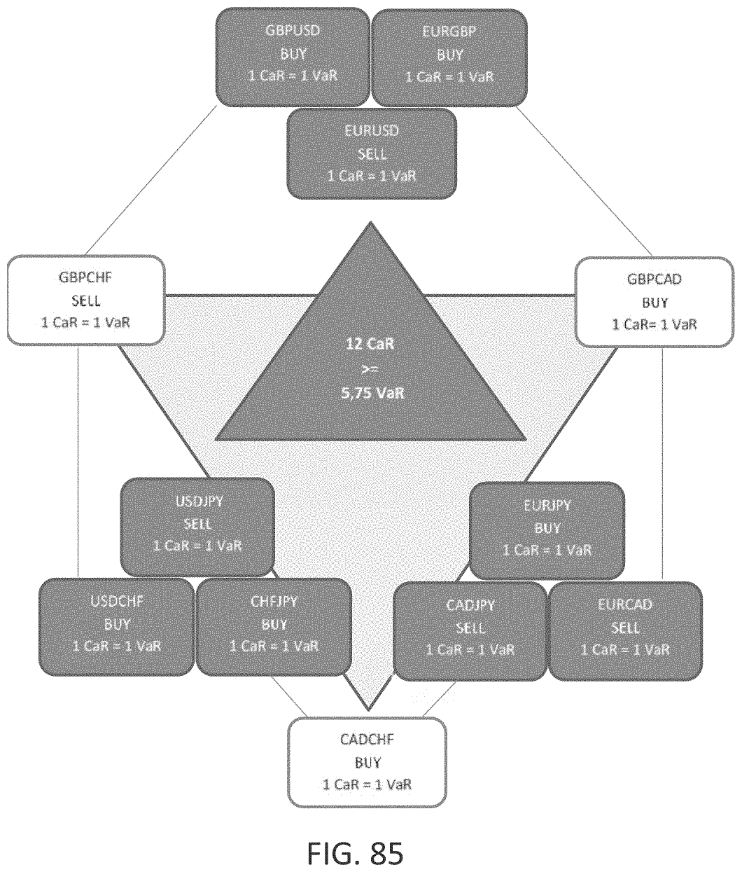

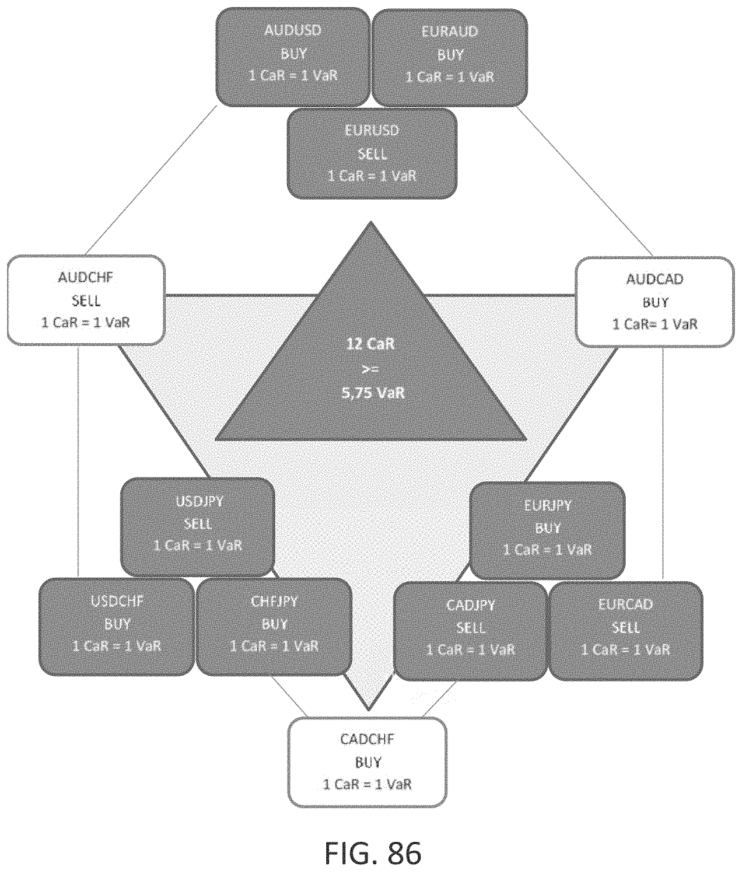

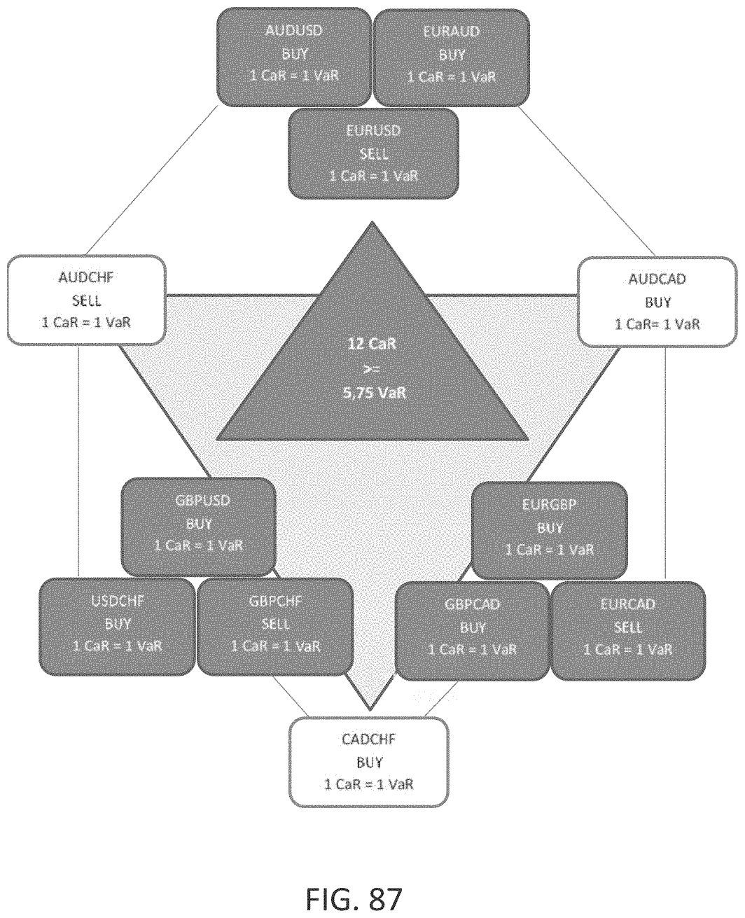

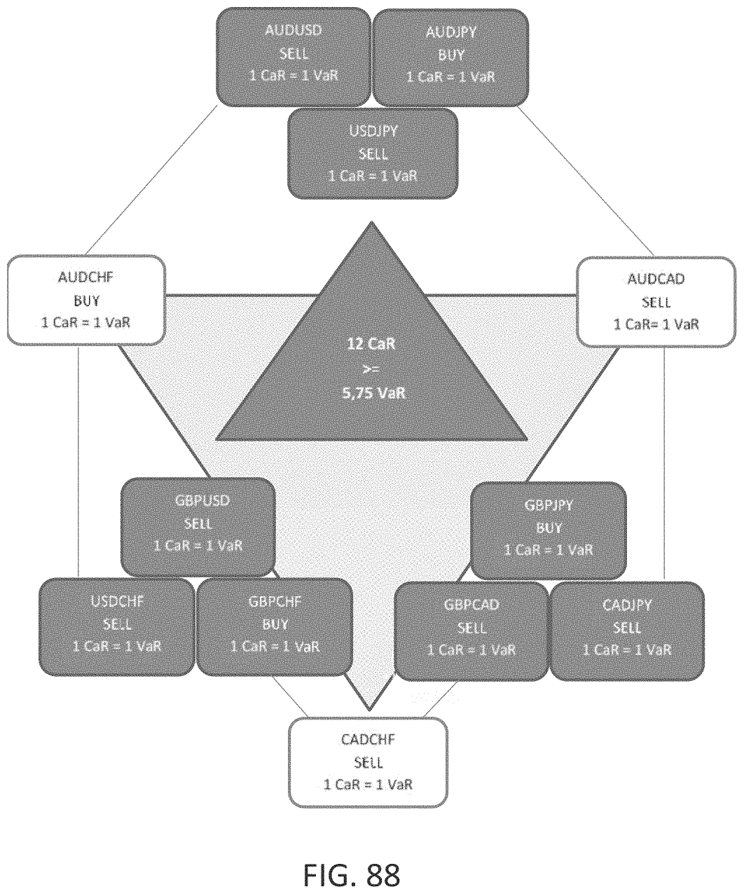

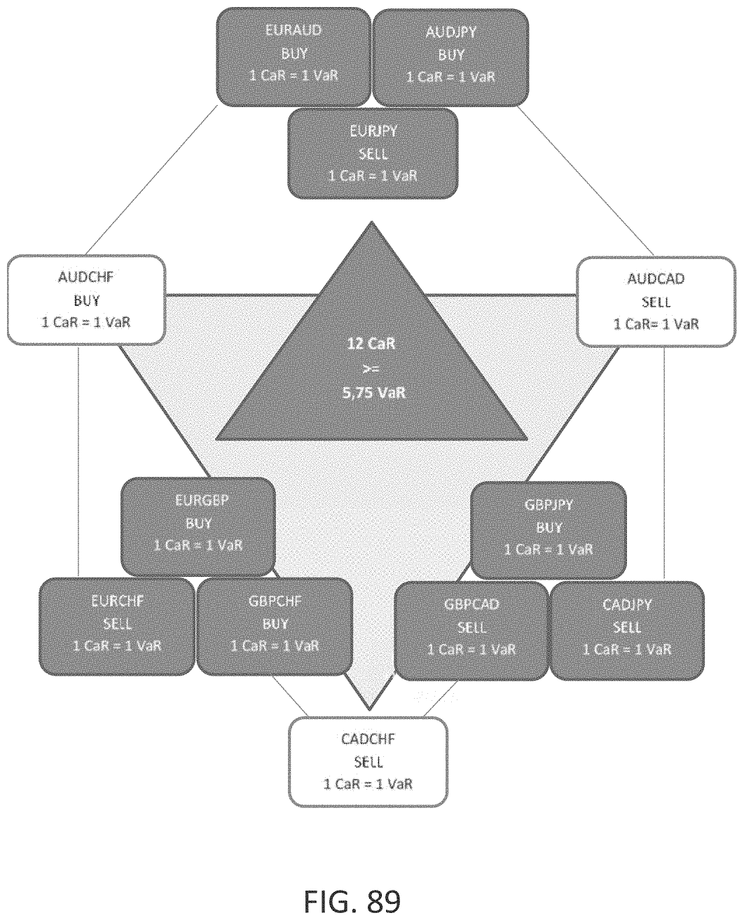

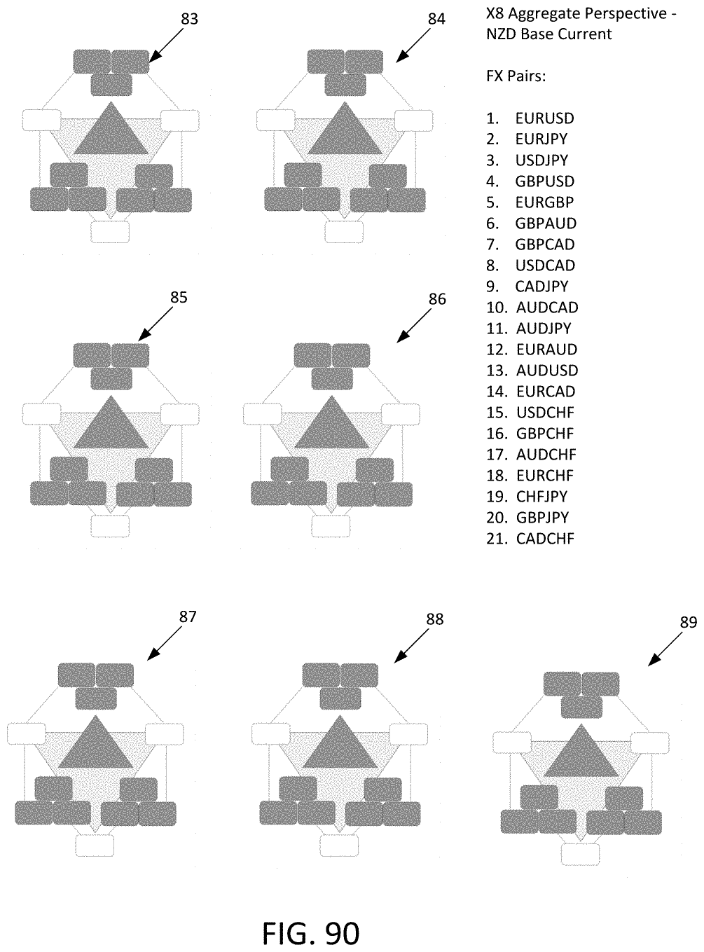

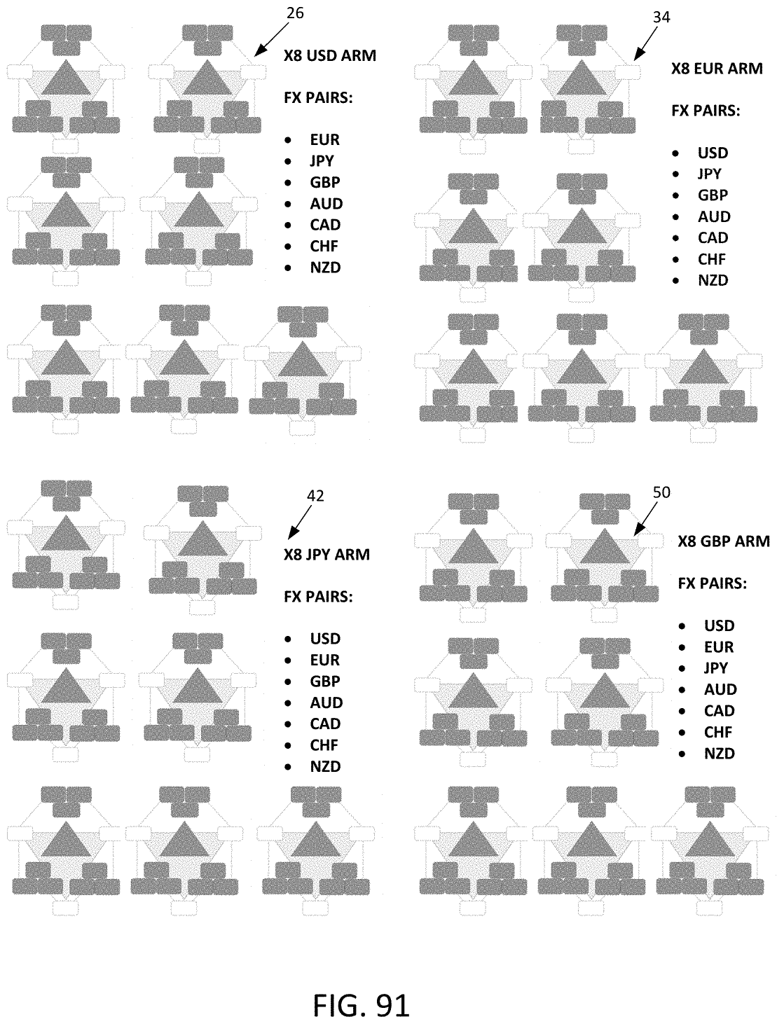

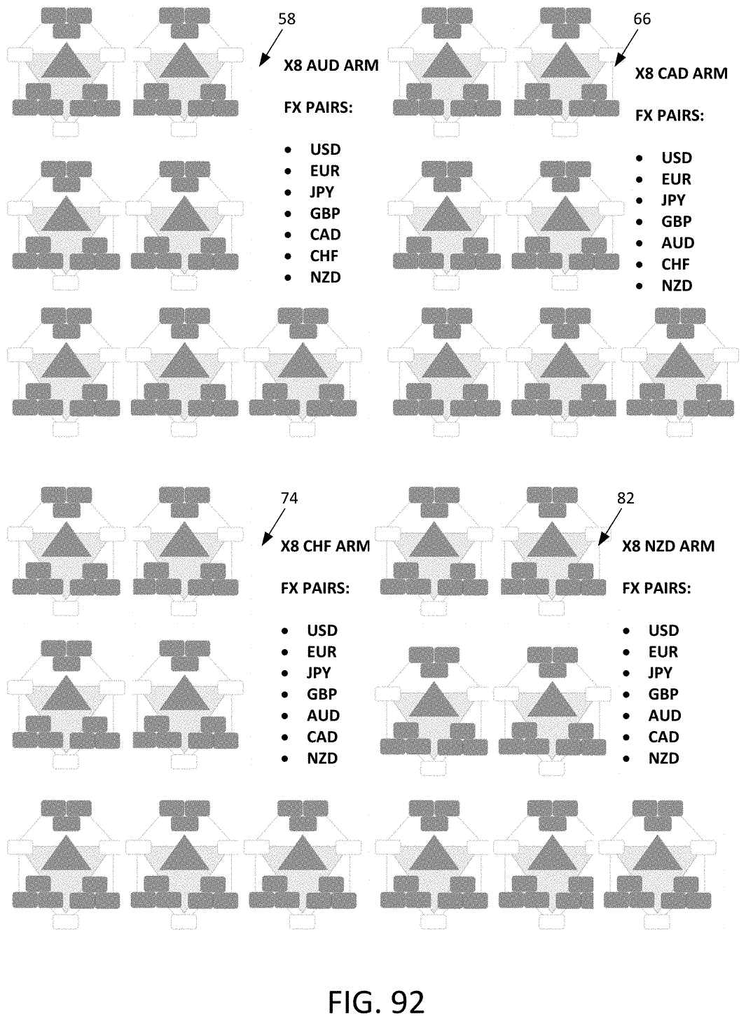

This is shown in FIG. 92.

X8currency Aggregate Perspective—Example—½

*56 G6 Perspectives, each with 12 FX Pair elements and 12 CaR units, form an 1^{st} Horizon X8currency Aggregate Perspective. Total FX Pair elements and CaR units is 12*56=672 CaR units.

X8currency Aggregate Perspective—Example—CCYs: USD, EUR, JPY, GBP, AUD, CAD, CHF, NZD

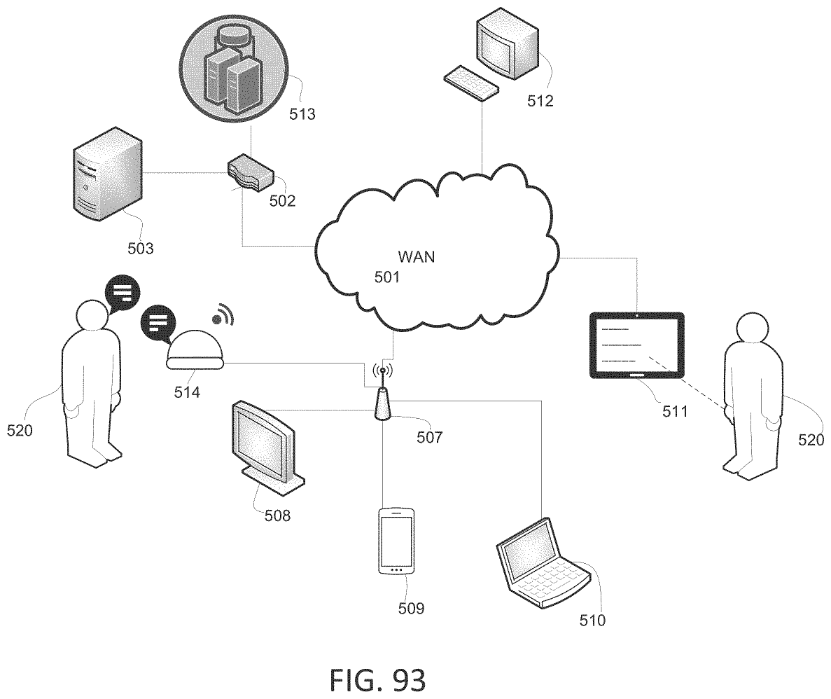

This is shown in FIG. 93.

X8currency Aggregate Perspective—Example— 2/2

| X8 JPY 19 | X8 GBP |
|---|---|
| 93.3 (1 ARM | ARM |
| FX PAIRS: | FX PAIRS: |
| USD | USD |
| [symbol] | [symbol] |

[symbol]

indicates data missing or illegible when filed

*56 G6 Perspectives, each with 12 FX Pair elements and 12 CaR units, form an 1^{st} Horizon X8currency Aggregate Perspective. Total FX Pair elements and CaR units is 12*56=672 CaR units.

Predictive Capability Level of the Model

Assemblies of G6 Perspectives in the specific examples reflect VaR measurements of the Model when only the most volatile currency is identified in one of the X8 Aggregate Perspectives' example.

The scenario that only the most volatile currency is identified is seen as a worse scenario than correctly identifying and predicting more precise status than this. The predictive capability level of the approach where there must be the most volatile currency is more narrowed down and more exposed to failed assumption than that of the scenario where 7 out of 8 currencies in the scenario would not be the most volatile currencies and where ranks by currency would be sought after.

Probabilities that after a miss of the first assumption that a particular currency is the most volatile currency, the chances increase for this currency to be the second most volatile currency from 1 in 8 to 1 in 7, where the broader view is that any other 6 out of 7 currencies also would not be the most volatile currency.

From a simple view, either currency could be the most volatile or the least volatile out of all 8 currencies in the X8 Base Currency Model and in the x8currency Model. Despite this, the predictive capability level of the Model as shown in VaR and CaR measurements limit itself to being able to predict only the most volatile currency at a specific probability level, but not the order of currencies by the measurement of their individual volatilities. The Model assumes to know the most volatile currency, but cannot identify the position of each other currency in the volatility ranks from 2 to 8.

The geometric method of the Aggregate X8 Perspectives, explained in the specific examples from pages 58 to 121, does not extrapolate that there could be different second most volatile currencies. This would increase the predictability level and would be calculated as an increase of:

(( 1/7−⅛)= 1/7=14,2857%

compared to the base-line predictive capability level of the most volatile currency.

Assumption is omitted from the predictability capability level explained in the specific examples for the purposes of stricter and more conservative VaR and CaR theoretical Model values presented in this document.

This approach of the definition of the VaR and CaR model of the Aggregate Perspectives produces a more restrictive approach to allocation of CaR and its worst potential result (results of the action of the allocation of CaR) measurement.

An improvement of the predictive capability level of the method, which happens when orders of the volatility rank of each currency are reflected in the geometry of Perspectives more specifically and more precisely for each currency, is not assumed in the explained specific examples of the X8 Base Currency Perspectives. The result of the VaR and CaR measurement is therefore oriented at showing worse case scenarios, where there might not be a diverse scenario of ranks between 2^{nd} and the 8^{th} most volatile currency. Therefore, the specific examples do not include the predictability to be able to avoid the influence on aggregate risks, which the second most volatile currency has or would have.

Second most volatile currency cannot be predicted for the Market Pole Function scenario nr. 5 either (as explained on the page 49).

Additional Risk Mitigation

It is unknown when a particular level of Risk will manifest and whether the next period might be more or less volatile market period. It is unknown whether this might influence the fluctuations of prices in the currency market to a greater or to a lesser extent.

The Model of Aggregate Perspectives is not capable of assigning a better probability to any of the next market price moves. The role and job of the Aggregate Perspective Model is to establish a risk adjustment effect, which is predefined within a price range for FX pairs.

In reality, the risks of next future moves cannot be predicted in advance at any length. As far as risks are concerned, a rational investor in the economic theory would preferably select risks, which have the potential to produce marginally higher rewards relative to the absolute risk allocation amount of such an investor.

An example of such preferential behavior of a rational investor is that the investor would rather buy at lower prices, which promise a better relative potential reward. Although true, that waiting for lower prices cannot be any more probable than upticks in the prevailing market price, the preference of the investor is to allocate risk proportionally to CaR where CaR is a unit of Risk from the point of view of such investor.

Risk unit CaR has its own lifecycle. At the beginning of the CaR cycle the Risk prevails to the downside in disproportionally large ratios over the potential reward. This is most pronounced from the point of view of the beginning of the CaR cycle. VaR and CaR measurements expose this view of the Risk over a lifetime of a portfolio made out of units of Risk, which is a view of individual risk elements from birth of the cycle and to the downside toward the point of depletion of CaR allocation amount of each of the CaR units in such a portfolio.

Risk mitigation in its basic principle, as so far explained in this document, happens from a level of CaR to a level of VaR of the assembly of the Model. This includes the benefit to the investor, if the market spreads do not perversely increase. The travel of the market, which does market action of variable but stable spreads, is a benefit to the investor, when observing Var/CaR ratios of the Model.

From the most trivial perspective, the VaR/CaR ratio could be a number ranging from 1 toward 0 optimally, but no more predictive than random, but with an overlay that risks are most disproportionally high from the beginning of the lifecycle of the CaR allocation amount.

This represents an element of the risk mitigation process. Any decrease of the VaR/CaR ratio below the value 1 is seen from the point of view of this document as a benefit element of a particular X8 VaR/CaR assembly. This benefit element is channeled through the benefit which investors generally in the world receive from more stable spreads in the market.

Taking into account the unpredictability of the VaR/CaR ratio plus the view that the lifecycle of CaR puts more emphasis on the risks being more dominant when the cycle is young, the approach to taking risk adjusted decisions is one of spreading the risk over different positions of the value of the VaR/CaR ratio, which is between 1 and 0. The actual resulting VaR/CaR ratio may be any number, but more probably than not, a value between 1 and 0. This approach of the Model and the Mechanism for Stability.

This character enables the Model to apply an Algorithm to the Aggregate X Perspective with such VaR/CaR characteristics. Integral Perspective and Superposition Perspective therefore together amount to an additional risk mitigation mechanism, focused on most stressful scenarios, where VaR/CaR might stay around 1, or fluctuate in big swings below 1 and less capital is exposed to risk at the beginning of the CaR cycle.

Specifically, this means that the Integral Perspective and Superposition Perspective shield the portfolio exposure from spread widening with massively high rates.

In case the spread width of the Aggregate Perspective widens, but central price movement does not occur, then the Integral Perspective and Superposition Perspective see this as increase in costs of decision making on such a risk portfolio, and will demand price adjustment before a reaction threshold is reached. New VaR allocations are withheld and CaR risk in ARM AI remains inactive.

Worst Case Scenario

This document established that the Model is designed with the purpose of Price Risk mitigation and also Spread Risk mitigation.

Price Risk model will evaluate the movement of prices with normal spreads.

Worst case scenario for the Price Risk Model is:

uninterrupted one-way movement of all components in the portfolio simultaneously.

This amounts to the worst-case scenario of an Aggregate Perspective measured with VaR.

VaR represents a risk adjustment mechanism due to its geometric origins, which exposes the price risk, but does not entirely describe the spread risk of the market.

Terminal case scenario for the Aggregate Perspective is:

maximum cumulative spread widening of the entire Aggregate Perspective structure from a neutral point after initiation.

If the spread width equals the width of the entire price range, then VaR will approximately equal CaR.

The Integral Perspective and Superposition Perspective are under most stress:

When VaR incrementally and uninterruptedly expands.

The worst case to the AI part of the ARM structure is the scenario of a sequence of an VaR expansion to maxVaR of the VaR function when there is no spread widening, and then after such a scenario would have been fully manifested, the spread widening would manifest itself with large spreads, terminating CaR.

Practically, the worst-case scenario for the ARM AI Model is an example of all currencies moving in a straight line without any spread widening over the entire price range, and after this, widen the spread to the width of the entire price range for all of the currencies simultaneously. Such a worst-case

scenario is the scenario, which exposes VaR of Aggregate Perspective and CaR allocated to Integral Perspective and the Superposition Perspective.

Maximum loss rankings:

Maximum loss of the system is 1 aggregate CaR.

Next maximum loss of the system is where VaR equals CaR.

Further worst-case scenarios are governed by performance of VaR relatively to CaR.

VaR can be negative, which does not hurt the portfolio in any way. Negative VaR does not worsen the input quality of to the final Superposition Perspective level due to Integral Perspective's adjustment of relative speeds close to the target, as described in this document on page 13, 15, 44, 45, 46, and 47.

CaR cannot be negative. CaR is a positive real number. Aggregate CaR for X8currency Aggregate Risk reflects the exposure to the market risk where the widening of the all of the market spreads in a specific way disfunction price discovery mechanism of the market. If such disfunction happens randomly, the VaR and CaR Model is designed to look for the value VaR being a lower value than CaR.

Mechanism for Stability—Gateway

The System looks for best opportunities to diversify risk.

Each Perspective slot can be assigned to an account. Accounts are not limited to be held with one broker or a bank.

7 G6 Perspectives can be assigned to 7 different accounts in the same Base currency. A Stable coin, backed by an individual currency, can be backed by deposits on 7 or more different account in the same base currency and directly governed by ARM. Integral Perspective and Superposition can be assigned to different accounts too.

A stable coin in this document is a tokenized form of a portfolio of a basket of currencies and/or a tokenized form of a portfolio of an individual currency. Stable coin of the document uses the Mechanism for Stability of the System and is through a gateway connected to the market.

Gateways include: broker gateways, bank gateways, exchange gateways, system gateways.

Gateways happen to different institutions and enable the electronic execution of a service. Gateways also enable the user to exchange the stable coin with another currency instrument.

X8currency specifications with gateways—Innovative Step—Stable tokenized instrument construction

X8 USD (ARM AI); X8 EUR (ARM AI); X8 JPY (ARM AI); X8 GBP (ARM AI); X8 AUD (ARM AI); X8 CAD (ARM AI); X8 CHF (ARM AI); X8 NZD (ARM AI); X8 XAU (ARM AI); X8 HEDGE; X8 BANKS; X8 TOKEN (System gateway); X8 FIAT (Fiat Cryptocurrency exchange gateway); X8 CRYPTO (Token Cryptocurrency exchange gateway); X8 MINT (Mint System gateway)

Mint represents the total history of coins minted or burned.

Crypto represents the offer of stable coins in stock in the cryptocurrency market through the orderbook of an exchange. At the offer price and amount entered into the orderbook of an exchange the stable coin connects to the market through a gateway.

Fiat gateway includes the processes and the location of processes of the conversion from crypto to fiat.

The X8currency structure together with the gateway structure produces a price list of the stable coin versus the main 8 currencies including versus the currencies that are in the cross-section of currencies of the fiat gateways, crypto gateways and the main 8 currencies.

The purpose of the structure is the maintenance of balance between the number of stable coins and the assets backing the stable coins, and also to facilitate the entry/exit orderbook gateway and processing of end-to-end market order sequences.

The System receives information about the market activity with the stable coin through FIX Protocol gateways. Order fills from the market, exchanges or other platforms are an input for processing of the System when executing individual gateways sequentially.

A successfully filled order entering through a X8 CRYPTO gateway will trigger X8 FIAT gateway and will continue further with X8 HEDGE gateway, before it is completed with MINT and TOKEN system gateways.

The filled order process can start also from a X8 BANKS gateway and follow through with X8 HEDGE gateway if the deposit currency has not been converted yet. Process is completed with MINT and TOKEN gateway processes.

Innovative Steps

This document describes several points, where the innovative step occurs.

The first innovative step is the “Horizons” control. This control is a new type of trading control, which can also be used as a control in signal processing. This is because the control allows the user to select between all modes of the signal in a way, which has so far not been made available worldwide. The “Horizons” control is applicable in market price data processing, but also more generally in signal processing, where signals are in the form of waves. The control represents an innovative step also because it allows a transparent selection of the filtering and the polarization of the incoming signal. For example, a signal phase inverter function can be easily invoked by the user arbitrarily from this graphical user interface, as well as amplitude selector. Moreover, the control does not force on the user the limitations of selections of how the signal can be processed and leaves all choices open due to the design of the control itself. The control allows the selection between the non-phase inverted signal, phase inserted signal with both polarizations, non-phase inversion signal with auto adjustment of the starting input point, phase inverted signals with auto adjustment of the starting input point, fractal signal processing, scalar signal processing, derivative signal processing, integral signal processing, vectorized signal processing. Furthermore, as market price is also a signal, the VaR and CaR Model of this document can be set in various ways, which allows to shape Price Risk Profiles and Spread Risk Profiles of almost any shape. This includes another innovative step within this capability, which is the capability of the formation of the client custom instruments and client custom tokenized instruments with linear, derivative or integral characteristics without the use of any OTC derivative instruments like FX options for example, yet with the complete flexibility to describe such instruments' profiles and effects.

Another innovative step described in this document is the innovative step of the Superposition Perspective. The Superposition consists of Algorithms assembled in a specific way in order to invoke the Artificial Intelligence character of the System. In the particular case of the X8currency as described in this document the Artificial Intelligence makes the difference between the view of the X8currency being just a basked of 8 currencies versus the view of the X8currency being a basket of 8 different AI components or AI currency components.

X8currency ARM AI constitutes the Mechanism for Stability, which is the next innovative step capable of real-time adjustment of complex geometric structures with the purpose of overall value preservation and maintenance of stability of portfolios in the investment markets. It uses an objective and dynamic model, which is also deterministic in nature. Factorial assembly of the X8currency Aggregate Perspective is part of this innovative step, which results in the reduction of the required resources to process risks with higher accuracy and also removes the dependency on radical components—keeping all structures harmonized and consistent within the Pythagorean space.

The System is innovative, because it produces outputs, which are not comparable with any existing mechanisms or systems currently in the world. The System introduces into the financial realm a common denominator, which is the vectorized risk profile expressed in Units of Risk. Through this common denominator financial market participants in the future will be able to communicate, interact and also transact between each other using a common expression or language describing their risk tolerances and target performance expectations. Geometric nature of vectorized Units of Risk will in the future also enable Multilateral Clearing Facilities in the realm of the Decentralized Finance.

### SUMMARY

Mechanism for Stability in this document has the primary function of price risk mitigation and then also spread risk mitigation.

Mechanism for Stability in the construction of a stable coin element has a functional gateway connection to processes of the tokenized mechanism.

Tokenized mechanism is a part of the stable coin. The coin needs to be backed by assets. Tokenization of assets represents the tokenization of a stable portfolio into an X8 stable coin.

The System provides the entry/exit for end-to-end stable coin conversion and executes this in a market orderbook format.

The purpose of the Mechanism for Stability in combination with X8 stable coin, is to tokenize an asset, to include the tokenization of value preservation, and connect to users for them to be able to obtain this benefit in the market.

ARM AI, which includes the Mechanism for Stability, gives objective interface for the business capabilities of the X8 stable coins. This interface is connected through gateways and to the tokenization mechanism to give stable coin units the placement in the market.

The System's objective is the tokenization of the unit of value preservation.

The System's objective is the maintenance of equal balance between the assets backing the tokenized units and the number of tokenized units.

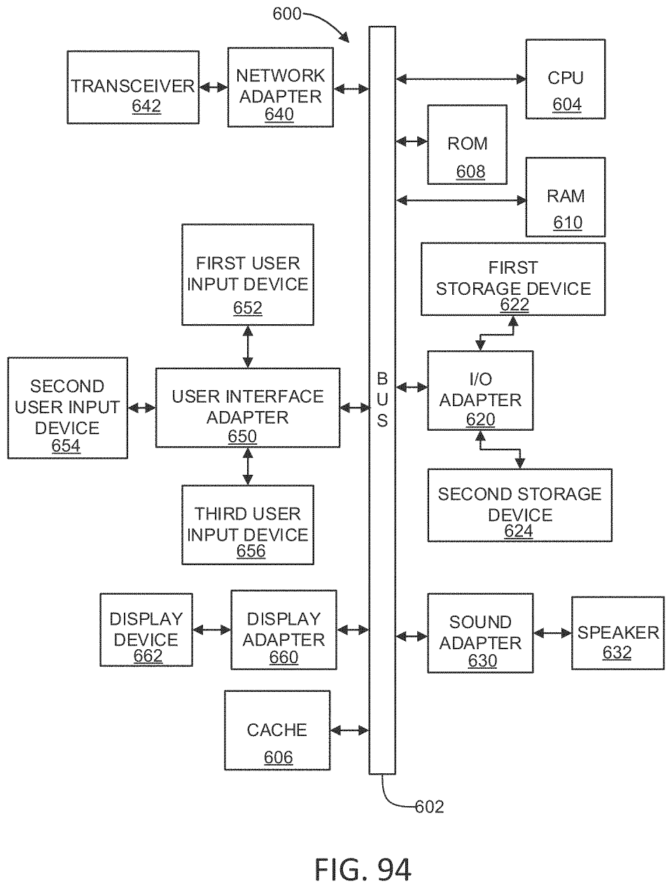

Referring to FIG. 94, a schematic overview of a system in accordance with an embodiment of the invention is shown. The system can be comprised of one or more application servers 503 for electronically storing information used by the system and/or server clusters 513 for processing and outputting the information used by the system. Applications in the server 503 or server clusters 513 may retrieve and manipulate information in storage devices and exchange information through a WAN 501 (e.g., the Internet). Applications in server 503 or server clusters 513 may also be used to manipulate information stored remotely and process and analyze data stored remotely across a WAN 501 (e.g., the Internet).

According to an exemplary embodiment, exchange of information through the WAN 501 or other network may occur through one or more high speed connections. In some cases, high speed connections may be over-the-air (OTA), passed through networked systems, directly connected to one or more WANs 501 or directed through one or more routers 502. One of ordinary skill in the art would appreciate that there are numerous ways server 503 may connect to WAN 501 for the exchange of information, and various embodiments of the invention are contemplated for use with any method for connecting to networks for the purpose of exchanging information.

Components, elements, or modules of the system may connect to server 503 or cluster 513 via WAN 501 or other network in various ways. For instance, a component or module may connect to the system (i) through a computing device 512 directly connected to the WAN 501, (ii) through a computing device connected to the WAN 501 through a routing device 502, (iii) through a computing device 508, 509, 510, 514 connected to a wireless access point 507, or (iv) through a computing device 511 via a wireless connection (e.g., WiFi, CDMA, GMS, 3G, 4G, 5G, other suitable means, and means not yet invented) to the WAN 501. One of ordinary skill in the art will appreciate that there are numerous ways that a component or module may connect to server 503 via WAN 501 or other network, and embodiments of the invention are contemplated for use with any method for connecting to server 503 via WAN 501 or other network. Furthermore, server 503 could be comprised of a personal computing device, such as a smartphone or tablet, acting as a host for other computing devices to connect to.

Users 520 of the system in accordance with embodiments of the invention can interact with the system via computing devices such as a laptop 510, personal computers 508, cell phones/smart phones 509, tablets 511, smart speakers 514, smart TVs, smart hubs, smart kiosks, and the like. Each of the abovementioned steps and aspects can be performed via the input and output means of these respective devices including presentation of software user interface elements, presentation of prompts/questions to the user, collection of user input, presentation of options, suggestions, and recommendations, as well as the subsequent presentation of recommended courses of action, products, or services aimed at achieving the user's emotional goal. For example, a user 520 can operate a tablet 511 to navigate to a browser interface presenting a web-based version of the software interface of the invention and be presented with interactive elements on the screen of the laptop or the user can provide inputs to the system via the touchscreen of the tablet.

Consequently, the tablet 511 can provide controls and interfaces that send user input to processed on a remote device such as a server. It should be understood that the user 520 can interact with the software interface of the invention by engaging user interface elements and entering input through a touch-screen of the tablet 511.

Alternatively, in an embodiment of the invention incorporating an audio device such as a smart speaker 514, a user can initialize an audio software interface to receive audio output and provide audio input to interact with the interface elements.

It should be understood by a person skilled in the art that the aforementioned collection of facial or gesture information can be realized through the use of image capture devices (e.g., camera(s) on a smart phone 209, laptop 210, tablet 211, computer 205 configured with a webcam, smart hubs, smart kiosks etc.) included in a system or device in accordance with an embodiment of the invention. Analogously, the collection of voice information in accordance with the various embodiments can be performed through the use of a microphone or other suitable sound capture and recording device that may be included on a variety of devices such as a smart phone 509, laptop 510, tablet 511, computer 512, a smart speaker 514, and the like.

The communications means of the system, according to embodiments of the present invention, may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the invention, and embodiments of the invention are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect. It should be understood that a programmable apparatus or computing device can include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this specification and elsewhere, a computing device can include any and all suitable combinations of at least one general purpose computer, special-purpose computer, programmable data processing apparatus, processor, processor architecture, and so on.

Any combination of one or more computer readable medium(s) may be utilized with the various embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a static random access memory (SRAM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computing device or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The flowchart and block diagrams in the Figures illustrate the architecture, functionality, and operation of possible implementations of systems, methods, and computer program products according to the various embodiments hereof. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As noted earlier, the methods described above as well as the exemplary web-interface based system may be implemented on a variety of computing devices or. An illustrative representation of an exemplary computing device/processing system in accordance with an embodiment of the present invention is shown in FIG. 95. The computing device 600 can generally be comprised of a Central Processing Unit (CPU) 604 operatively coupled to other components via a system bus 602, optional further processing units including a graphics processing unit (GPU), a cache, a Read Only Memory (ROM) 608, and a Random Access Memory (RAM) 610. The computing device 600 can also include an input/output (I/O) adapter 620, a sound adapter 630, a network adapter 640, a user interface adapter 650, and a display adapter 660, all of which may be operatively coupled to the system bus 602.

Additionally, a first storage device 622 and a second storage device 624 can be operatively coupled to system bus 602 by the I/O adapter 620. The storage devices 622 and 624 can be any of a disk storage device (e.g., a magnetic or optical disk storage device), a solid state magnetic device, and so forth. It should be appreciated that the storage devices 622 and 624 can be the same type of storage device or different types of storage devices. In instances where the device 600 is embodied by a smart speaker 214 or the like, it can incorporate a speaker 632 which may be operatively coupled to system bus 602 by the sound adapter 630. A transceiver 642 may be operatively coupled to system bus 602 by network adapter 640. In instances where the device 600 is embodied by a tablet 511 or a smart phone 509, it can include a display device 662 which may be operatively coupled to system bus 602 by display adapter 660.

In some embodiments, the device 600 may include a mother board, alternatively/additionally a different storage medium (e.g., hard disk drive, solid state drive, flash memory, cloud storage), an operating system, one or more application software and one or more input/output devices/means, including one or more communication interfaces (e.g., RS232, Ethernet, Wifi, Bluetooth, USB). Accordingly, in some embodiments a first user input device 652, a second user input device 654, and a third user input device 656 may be operatively coupled to system bus 602 by user interface adapter 650. The user input devices 652, 654, and 656 can be any of a keyboard, a mouse, a keypad, an image capture device (e.g., a camera), a motion sensing device, a microphone, a touch-sensitive device (e.g., a touch screen or touchpad), a device incorporating the functionality of at least two of the preceding devices, and so forth. Of course, other types of input devices can also be used, while remaining within the scope and spirit of the present invention. The user input devices 652, 654, and 656 can be the same type of user input device or different types of user input devices. The user input devices 652, 654, and 656 may be used to input and output information to and from system 600.

Thus, Interactive interfaces may be presented to the user via the output means of exemplary device 600 in accordance with the embodiments of the present invention. Whether visually via a display device 662, audibly via speaker 632, or through a combination of both, a user can control the operation of system in accordance with an embodiment of the invention. Accordingly, whether through tactile, audio, or video input through input devices 652, 654, and 656 a user can provide the input and selections to interact with the various elements and aspects of the invention.

Of course, the processing system/device 600 may also include other elements (not shown), as readily contemplated by one of skill in the art, as well as omit certain elements. For example, various other input devices and/or output devices can be included in processing system 600, depending upon the particular implementation of the same, as readily understood by one of ordinary skill in the art. For example, various types of wireless and/or wired input and/or output devices can be used and additional processors, controllers, memories, and so forth, in various configurations can also be utilized as readily appreciated by one of ordinary skill in the art. These and other variations of the processing system 600 are readily contemplated by one of ordinary skill in the art given the teachings of the embodiments provided herein.

Mechanism for Stability—Preferred Hardware Configuration and Assembly

This following puts the system into perspective of the hardware configuration and assembly that is a preferred embodiment of the Mechanism for Stability and how it operates in the real environment.

Hardware Configuration Supporting the System

The System itself includes complex methods for risk mitigation and risk management for stable portfolios and tokenized assets. The methods described in the main document may use specific hardware in order for them to be able to produce a functional output that can be used in real-time.

The author has considered factors like latencies to market venues to which the System is connected, latencies of network adapters and internal latencies, which exists during the processing of the signal.

Main aim of hardware configuration was to bring (to reduce) the latencies to a level where the System's output remains relevant in the context of real-time operations and the capability of the Mechanism for Stability within the ARM AI to stabilize investment portfolios during free market action (mainly Foreign Exchange market price action) without rejections from the external market systems.

Hardware System Components

Hardware in this document means a computer server cluster assembled in a particular way. The components of a preferred embodiment of the hardware system can include:

33×Supermicro X9 series, model 5017C-MTRF (application server)
1. SUPERMICRO SuperServer 5017C-MTRF
2. INTEL Xeon E3-1290V2 3.70 GHz 8 MB 4 C/8 T
3. SAMSUNG M393B1G70QH0-CMA 8 GB DDR3
4. RAID 0 array of 2×SAMSUNG 860 EVO SSD 250 GB 2,5 sata3

2×Supermicro X10 series, model 2029U-TN24R4T (database server)
1. SUPERMICRO SuperServer 2029U-TN24R4T
2. 2×INTEL Xeon Gold 6136 3.0 GHz 12 C/24 T
3. 16×SUPERMICRO MEM-DR464L-SL04-LR26 64GB DDR4 loadreduced
4. RAID 0 array of 8×Micron 9200 MAX 6.4 TB NVMe2.5
5. SUPERMICRO AOC-S40G-I2Q 2×40 Gbs LAN QSFP

1×Supermicro X10 series, model 1029TP-DCOR (database cluster master switch)
1. SUPERMICRO SuperServer 1029TP-DCOR
2. INTEL Xeon Bronze 3104 1.7 GHz 6 C/6 T
3. SUPERMICRO MEM-DR480L-SL03-ER24 8 GB 4,00 KOS
4. DDR4, PC4-19200 ECC reg.
   INTEL S4500 480 GB 25/S600 DWPD 1.0
5. SUPERMICRO AOC-MGP-i2M (SIOM) 2×1 Gbs

2×Network Switch

2×Network Gateway

Technical Failure Event and Risk Mitigation

The described hardware system aims at high availability within the TIER4 datacenter configuration. 33 application server components can serve as a redundant field of available CPU, where each CPU is registered by the cluster master application server.

Each application server is connected to the database cluster and can directly interact with the database cluster (servers within the database cluster).

Database cluster can include a dual minor configuration consisting of two full size database servers. Each database server can be a minor configuration of NVMe 2.5 Flash disk array (RAID 0).

When observed from the perspective of a single point of failure, the described computer cluster aims at minimizing the risk of hardware component failure on several levels.

The first level is the hard drive failure level. Each server is set up in RAID 0 configuration of one or several of its hard drive components. Should any of the hard drive components experience a technical malfunction, such a hard drive component can be replaced (hot swappable hard drives).

Within the level of each computer server there can also be redundant power supply components. This serves two purposes. First purpose is that in case of mains power supply technical failure, such individual component can be replaced without turning off the server unit as a whole (hot swappable mains power supply). The second purpose of segregated mains power supply is the ability to feed power to the server unit from two different sources of electricity power supply. In case of TIER4 datacenter this means that each server can be supplied by electric power, which comes from two completely segregated transformer stations. In case when a powerplant or an important transformer in the electric grid is damaged, the individual server in the System can continue to operate based on the power supply coming from the redundant power source (independent transformer line).

The second level is the server failure level. Each server has a role, which can be replaced in case of server level technical malfunction event. Computer server level technical failure event is handled in two different complementary ways, depending on if the failure event happened to the application server or to the database server.

If the server failure event happens to one of the application servers, then the cluster master application server can delegate the workload to a new CPU from the registered cluster CPU list. Each individual application server carries one single CPU on one fully equipped motherboard—registered cluster unit. On the other hand, if the technical failure happens to the database server, the database cluster master switch can switch between the primary and secondary database server unit (within the database cluster), depending on which database server remains available and is in working order.

Failure of network components is handled by the network gateway and network switch configuration, which allows the cluster to continue with its operations in case of a single network switch failure or in case of a single network gateway component technical failure.

Application Server Cluster—Assembly

Individual application server units can have different roles. One role is that of a gateway to an individual market place, exchange, broker or a bank. Another role is that of the Mechanism for Stability computation unit. The third role is that of the cluster master application server.

Different individual application servers can be assembled into a specific application server cluster by a combination of two techniques, multicasting and multiplexing.

Initial multicasting point occurs on individual application servers that have the role of the gateway to individual market places assigned to these individual application servers. This type of individual application servers can use multicasting for the distribution of market price event information to the individual application servers, which have the Mechanism for Stability role assigned to them. Each gateway application server can target individual IP address and port based on the subscription for individual instrument's market prices—multicasting. These subscriptions can be submitted to the individual gateway application server by the individual application servers with a Mechanism for Stability role assigned to them.

As a result, individual application servers with a Mechanism for Stability role assigned to them, receive individual instrument's market price information from various individual gateway application servers.

Consequently, this means that servers with the role of Mechanism for Stability computation receive information from more than one gateway application server. Such Mechanism for Stability servers are thus connected to various market places simultaneously and aggregate the information from different market places on one individual server with the Mechanism for Stability role by using the multiplexing technique. Multiplexing is a complementary process to the process of multicasting. Multiplexing represents the receiving of the information from several different IP and port sources instead of distributing information to such target addresses.

Since the Mechanism for Stability can include different layers, one CPU unit or one server may, in a preferred embodiment, not comprise the entire mechanism.

Due to external maximum latency threshold requirements, an individual CPU on the application server is capable of performing computations of one geometric matrix—Aggregate Perspective, Integral Perspective and Superposition of one Base Currency. Stable portfolio includes a basket of 8 different currencies, therefore it must be aggregated on a dedicated CPU unit, which collects the information from the individual Base currency Superposition Perspectives and receives this information from other individual CPU units. It does this by using the multiplexing technique. In the case of the X8currency stable coin, this means that 8 different CPU's multicast the information about the geometric matrix to the delegated CPU, which is performing the Aggregate X8 Perspective computations and receives the input information by multiplexing.

Mechanism for Stability and ARM AI—System Gateways

ARM AI produces the results of the aggregate X8currency geometric matrix. This geometric matrix serves as the Mechanism for Stability on the level of the individual Base currency for each of the 8 Base currencies. This in turn constitutes the array of elements (portfolios), which back the tokenized digital asset (X8currency stable coin backed by a portfolio of 8 currencies).

System gateways, as they are described in the main document, act as various interfaces to the described foundations that create the pool of assets backing the stable coin. For example, MINT gateway will process the information of new capital inflow into the assets pool and create new stable coin units. In technical terms this means that the CPU where the MINT gateway is being processed is connected to the application server cluster with multicast/multiplex registry. The request for new MINT operation can be triggered from various different markets and at the same time may result in new computations on several different CPU's within the application server cluster.

For each System's gateway type, the multicast/multiplex registry can connect a particular CPU to any other CPU in the system, which happens also recursively and on tick-by-tick basis.

Bottlenecks and Throughput

Obviously, an array of 672 geometric elements with a high-resolution computation coverage can represent a minimum of approximately 16 GB in information space. If this information space was to be expected to be written into the database archive on a tick-by-tick basis, such a process could create a bottleneck at the point of the transmitting of the information from the application servers to the database servers. In practical terms, it would potentially have a complex 16 GB information to be computed and updated in the database archive every 10 milliseconds, rendering the System unscalable.

The System solves this bottleneck by using the mentioned multicast/multiplex registry. This registry works in a factorial way, meaning that each CPU can perform the initiation of the multicast/multiplex operation from its own position relative to the entire application server cluster and to the field of CPU's in this cluster.

The mentioned multicast/multiplex registry includes the information about the position of the user's cursor within the front-end application; the role of each CPU; gateway addresses to the individual markets, brokers, exchanges and banks. The registry also includes the information of the location and coordinates of each account (portfolio) with each broker, exchange or a bank. Last but not least, the registry includes the information about the instruments traded on each venue and the instrument list connected to each of the accounts (portfolios) in 8 different currencies.

As a result, the cluster knows the cursor point of the user at any given point. Each CPU is aware of the current cursor's position in the user interface. The cluster will prioritize database updates for the information fields, which the cursor is pointing to at any given moment and also for the information fields, which are not far away from the current cursor's position. If the user can move with his or her cursor to a new information field, which is not many clicks away from the current point of the cursor, those fields will also have a higher priority of database update entries. Information fields, which are further away from the current position of the cursor of the user, have a lower priority and a lower frequency of updates to the database field.

The method described in the paragraph above produces a high refresh rate for the information, which is directly visible to the user, or can be quickly accessed by the user. The information, which is more than one or two steps away from the user's current position or point of view, is updated or refreshed at a lower frequency. Each movement of the cursor to a new point recalculates the entire multicast/multiplex registry matrix.

The increase of the throughput compared to a non-adjusted multicast/multiplex registry matrix is between 16 and 80-fold. The cluster effectively processes end-to-end computations on per click basis. The cluster also is capable of effectively processing tick-by-tick market price data within externally required latency thresholds. Operations and tasks, which are not called for, may not get processed on a tick-by-tick basis and may only be triggered on a minimum refresh rate threshold basis.

Mechanism for Stability and the CPU

Each CPU should preferably know the status of the entire cluster; however, the awareness of this status should not result in bottlenecks in the System.

The System connects the total overall status of the cluster and the individual task, which an individual CPU within the cluster is working on at any given time, through a ThreadID random access index.

Each process in the cluster has its own dedicated ThreadID. This ThreadID is an integer number. Every CPU within the cluster keeps the record of the ThreadID random access index. This index is assembled by two factors. One is the factor of the multiplicator of an individual ThreadID number and the other is the local rank of the ThreadID process kept within the CPU.

In other words, if the ThreadID number is 123.456.789, then the CPU will compute factors of this number within the Byte numeric system analog to X*Y*Z*Q=ThreadID and store the Z*Q aggregate byte factor and the X*Y aggregate byte factor in the 3-dimensional RAM matrix. At any given time, when the ThreadID gets called, the CPU resolves the local random-access position of the process by identifying the X*Y aggregate byte factor on the local RAM array. This automatically leads to the hardwired connection between the process and the position of the information within the random-access data array local to the CPU.

In this respect, every process of the Mechanism for Stability can be virtualized within the sandbox of the cluster. The cluster itself can predict in advance where individual tasks will be stored. Nevertheless, at any given point after initiation the System resolves the position of the task on-the-fly within the global RAM array and therefore also the global CPU array. The driver for this is the ThreadID and the hard-wired RAM registry, where every dimension of the RAM registry by itself acts as a byte factor, enabling local self-resolution of the point of processing for every task within the ARM AI.

A fast and modern CPU, which is capable of frequencies higher than 3.7 Ghz will be able to process only so much of the information within the dictated latency thresholds, which are imposed externally. The financial system worldwide only accepts real-time participation in the orderbooks of the exchanges and market places if the latency of a system is below 100 milliseconds. Nominally, this is the minimum requirement by the worldwide financial system that prevents any system slower than this to actually make or take prices in or from the market. In reality the requirement for the tolerated latency is usually somewhat lower than 100 milliseconds. Many exchanges will reject a new order if it is older than 80 milliseconds compared to the latest orderbook event entered into the exchange.

Therefore, the CPU within the System's cluster would preferably perform all of the necessary work within a timeframe, which is shorter than half of this globally imposed limit. The question then is, what is the size of random-access memory a CPU is capable of processing within such a timeframe?

Even if today servers allow configurations with terabytes of RAM, this is not useful for the application of the ARM AI and the Mechanism for Stability. Whatever job is performed on the clusthe cluster, it should preferably be completed within less than 50 milliseconds or less, and in many cases, preferably much lower than that.

For this reason, computation tasks of the ARM AI have been segregated over an array of many CPU's within the cluster, where all of them are connected between each other through multicast/multiplex registry matrix. Furthermore, CPU's should preferably not reside on one motherboard as this would not in any way help with overcoming the overall latency problem. The solution for this particular system is to have each CPU connected to the cluster by two dedicated network (LAN) connections. This enables a non-blocking performance of the complex end-to-end computation task, which involves several gateways, accounts, markets, brokers and banks simultaneously. The supporting environment for each such CPU is the application server unit within the cluster.

Mechanism for Stability and RAM

This document has described how the System resolves individual tasks by ThreadID and that RAM constitutes of the self-indexed space, which allows local CPU's resolving of the computation task.

Further to the latency topic, and further to the fact that CPU can only process so much of the information within a certain timeframe, the RAM configuration within the application server cluster of the System has been selected.

The author decided to select DDR3 RAM type over DDR4 RAM type due to the better latency results of DDR3 RAM type when an update of the value of the individual memory cell is in question. While it is true that DDR4 RAM type may perform better when measured by bandwidth criterion, DDR3 RAM type should outperform DDR4 RAM type when an update of only one datapoint in one single memory cell is required.

The latter scenario is a predominant scenario within the Mechanism for Stability and ARM AI, which is a geometric matrix. Changing the value of one cell within one of the RAM's slots on a server will be completed more quickly on a DDR3 RAM type than on a DDR4 RAM type.

Overall, with the combination of the CPU and RAM components the System is capable of performing end-to-end computations within the latency requirements and for RAM sizes of up to 1 GB per CPU core. This is especially true because end-to-end computations consist of point-to-point data assembly structures. The solution for the System was to select a highly capable CPU and combine it with an enterprise grade DDR3 RAM type with additional limitation that one core thread within the CPU does not address more than 1GB of RAM. An Intel Xeon E3 1290 v2 CPU, which is capable of hyperthreading of 8 cores, can address 8 GB of RAM and perform ARM AI tasks within required latency thresholds, leading to the configuration of the application server in the system, which has 1 high-clock CPU with 4 cores and 8 hyper threads connected to 8 GB RAM array on one enterprise grade motherboard.

The System and Network (LAN)

The main challenge for the System to overcome is when it is transmitting small pieces of data over a Local Area Network. That is when many smaller pieces of information take longer time to transmit over LAN than one larger information package. Because the System is point-to-point oriented and because the System reacts to click-by-click activity by the user, the predominant type of activity is that of small packages of data being transmitted within the cluster, which mostly happens on demand.

Transmitting 1 B of data one thousand times will take longer than transmitting 1 kB of data from point a to point b in the computer network realm. This leads to a particular dilemma about how to process market price information, which continuously flows into the computer cluster from several different sources and through several different application servers, which act as gateways.

Market price information usually consists of small data packages. Sometimes they are no bigger than several Bytes in value, plus the frequency of incoming messages can be higher than 10 times per second for one market instrument, while the System processes many hundreds or thousands of instruments. The performance of the LAN is therefore crucial and the assembly of the network process within the cluster is also important.

The System leverages the capability of the application server, which has more than one LAN interface Minimum number of LAN interfaces for the application server can 2, but it can have up to 6 or more depending on the assembly.

The main principle of the assembly is that each individual application server receives incoming data over one LAN interface. This LAN interface, also called the connection 1, in a preferred embodiment, only serves as the receiving gateway for the market prices to the individual application server of the Mechanism for Stability. Any application server, which has a Mechanism for Stability role assigned to it, can receive market prices from several different gateways based on the multiplexing method described earlier. This emphasizes the role of the receiving connection 1, which performs multiplexing relative to the broader cluster environment where many gateway application servers exist, each performing multicasting initially. This operation of the connection 1 is performed by one core within the CPU.

The Mechanism for Stability within the CPU exists on each CPU core separately, and each CPU core can address 1 GB of RAM as explained before. This means that the receiving connection 1 and the CPU core, which processes the multiplexing of the connection 1, would preferably relay the information of the new incoming market price to other CPU cores, where the Mechanism for Stability computations are performed. This is how the Mechanism for Stability on each CPU core receives the input data.

There are several methods for performing the task explained in the previous paragraphs, where each method has its own advantages and disadvantages. The author decided to use the second LAN interface of the application server to act as an internal router within the application server. This means that the CPU core, which performs the multiplexing of the incoming new market prices over the connection 1 then connects to other cores of the same CPU through the connection 2, and does this by multicasting method.

The effect of the technique and method in the example above is that the CPU cores from nr. 2 to nr. 8 will perform in a non-blocking operation completely and totally independent of any application level congestion with the CPU core nr. 1 and other cores. This means that even if the connection 1 is saturated, the multicasting, which is performed between the connection 1 and connection 2 by IP address and port number will not add to the saturation level of the LAN nor will it compromise any application level parallelism between CPU cores from nr. 1 to nr. 8.

### SUMMARY

ARM AI computer cluster consists of 40 computer server components. Different servers have different roles. Redundancy is an important factor in the cluster. High availability is a paramount feature of the cluster. The cluster performs tasks, which are essential for portfolio risk management in the financial domain and therefore must work uninterruptedly at all times. Risk mitigation approaches and techniques for handling different types of technical failures have been implemented.

The cluster puts emphasis on CPU count and CPU clock, together with minimizing latency on RAM level. RAM size is not the predominant factor on the application server cluster level, except on the database cluster level. 33 application server units only carry 0.5 TB of DDR3 RAM. DDR3 RAM is selected over DDR4 RAM because of the preferable latency characteristics of DDR3 RAM. RAM clock is 1833 Mhz. CPU is a 4-core CPU with 8 hyper heads and a 3.7 Ghz to 4.1 Ghz CPU clock.

The System employs LAN with 1 Gbit/s capability in dual 2×per server configuration. LAN connection 1 serves as an incoming multiplexing point, while LAN connection 2 serves as an internal application server routing array to each individual CPU core from core nr. 2 to nr. 8.

The cluster is driven by a concept of factorial multicast/multiplex registry matrix. This allows the cluster to respond to every click of the user individually with full awareness of the position of the cursor of the user. This includes end-to-end processing of stable coin transactions, including all the System's gateways' processes, which are involved in the process and the interaction with the user.

Every CPU core can be an initial multicast/multiplex point. Every CPU core is connected to every other CPU core using the technique described in this document and on a point-to-point basis. In a preferred embodiment, only the critical information is processed and is processed on demand. Secondary information is every information, which is more than a few clicks away from the current point of the user's cursor.

Each click by the user can engage several (anywhere between 5 to 10) application servers in an end-to-end and point-to-point operations. User means any user on an exchange buying and selling stable coins or any user, which is selecting a particular configuration of the Mechanism for Stability and the ARM AI.

The cluster can employ a specific random-access ThreadID index, which allows the cluster to resolve the processes connected to the ThreadID in an environment local to the specific CPU. The cluster can be a virtualized sandbox of processes tagged by ThreadID.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

It will be appreciated that computer program instructions may include computer executable code. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including a functional programming language such as python, an object oriented programming language such as SMALLTALK, C++ pr the like, and conventional procedural programming languages, such as the “C” programming language or similar programming languages. A variety of languages for expressing computer program instructions are possible, including without limitation, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

Throughout this specification and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

1. A computer implemented method for stabilizing automatic reserve management, comprising:
receiving, via a Horizon user interface communicatively coupled to a networked user device comprising a processor device, a plurality of user inputs representative of factors affecting a unit of value;
generating a graph of value;
obtaining a balanced Strategy; and
generating, based on the user inputs and user selection, a Perspective including at least one Strategy.

2. The method of claim 1, wherein obtaining a balanced Strategy depends at least in part on an input of the plurality of inputs.

3. A non-transitory computer readable medium embodying instructions executable by a computing device which when executed cause the computing device to:
prompt a user to input a plurality of user inputs representative of factors affecting a unit of value into a first user interface of the computing device;
generate a graph of value;
obtain a balanced Strategy; and
generate, based on the user inputs and user selection, a Perspective including at least one Strategy.

4. A system for stability within automatic reserve management, comprising:
a first computing device connected to a network, the first computing device comprising:
a first user interface configured to prompt a user to input a plurality of user inputs representative of factors affecting a unit of value;
a second user interface configured to receive user input responsive to a prompt;
a processor device configured to
generate a graph of value;
obtain a balanced Strategy; and
generate, based on the user input, a Perspective including at least one Strategy.
